(19) United States
(12) Patent Application Publication
(10) Pub. No.: US 2013/0256939 A1
(43) Pub. Date: Oct. 3, 2013

(54) METHODS AND SYSTEMS FOR UTILIZING CARBIDE LIME

(71) Applicant: CALERA CORPORATION, Los Gatos, CA (US)

(72) Inventors: Martin Devenney, Mountain View, CA (US); Miguel Fernandez, San Jose, CA (US); Irvin Chen, Santa Clara, CA (US); Guillaume Calas, Mountain View, CA (US)

(73) Assignee: CALERA CORPORATION, Los Gatos, CA (US)

(21) Appl. No.: 13/804,439

(22) Filed: Mar. 14, 2013

Related U.S. Application Data
(60) Provisional application No. 61/617,243, filed on Mar. 29, 2012.

(51) Int. Cl. C04B 7/345; C04B 7/36

(52) U.S. Cl. CPC C04B 7/345; C04B 7/36
USPC 264/115; 423/432; 106/817; 106/672; 423/430

(57) ABSTRACT

Methods and systems are provided for producing a carbonate precipitation material comprising stable or reactive vaterite from carbide lime that provides both a source of divalent cations (Ca²⁺ ions, Mg²⁺ ions, etc.) and a source of proton removing agent.

### CROSS-REFERENCE

This application claims priority to U.S. Provisional Patent Application No. 61/617,243, filed Mar. 29, 2012, which is incorporated herein by reference in its entirety in the present disclosure.

### BACKGROUND

Carbon dioxide (CO₂) emissions have been identified as a major contributor to the phenomenon of global warming. CO₂ is a by-product of combustion and it creates operational, economic, and environmental problems. It may be expected that elevated atmospheric concentrations of CO₂ and other greenhouse gases will facilitate greater storage of heat within the atmosphere leading to enhanced surface temperatures and rapid climate change. In addition, elevated levels of CO₂ in the atmosphere may also further acidify the world's oceans due to the dissolution of CO₂ and formation of carbonic acid. The impact of climate change and ocean acidification may likely be economically expensive and environmentally hazardous if not timely handled. Reducing potential risks of climate change may require sequestration and avoidance of CO₂ from various anthropogenic processes.

### SUMMARY

In first aspect, there is provided a method comprising a) contacting an aqueous solution comprising carbide lime with carbon dioxide from an industrial process; and b) producing a precipitation material comprising reactive vaterite. In second aspect, there is provided a method of forming drywall, comprising a) contacting an aqueous solution comprising carbide lime with carbon dioxide from an industrial process; b) producing a precipitation material comprising reactive vaterite; c) setting and hardening the precipitation material by transforming the reactive vaterite to aragonite, and d) forming the drywall.

In some embodiments, the foregoing method further comprises purifying the carbide lime by treatment with weak base before step a) to make the aqueous solution comprising carbide lime. In some embodiments, the foregoing methods further comprise purifying the carbide lime by treatment with weak base selected from, but not limited to, borate, N-containing salt, N-containing aliphatic compound, N-containing aromatic compound, and combinations thereof, before step a) to make an aqueous solution comprising carbide lime. In some embodiments, in the foregoing methods the weak base is N-containing salt selected from, but not limited to, ammonium chloride, ammonium sulfate, ammonium nitrate, and combinations thereof. In some embodiments, in the foregoing methods a molar ratio of the weak base:carbide lime is between 2:1 to 4:1.

In some embodiments, the foregoing methods further comprise subjecting the aqueous solution at step a) to one or more precipitation conditions that favor formation of the reactive vaterite. In some embodiments, the one or more precipitation conditions are selected from, but not limited to, temperature, pH, pressure, ion ratio, precipitation rate, presence of additive, presence of ionic species, concentration of additive and ionic species, stirring, residence time, mixing rate, forms of agitation, presence of seed crystal, catalyst, membrane, or substrate, dewatering, drying, ball milling, and combinations thereof. In some embodiments, the foregoing methods produce the precipitation material comprising at least 50% w/w reactive vaterite. In some embodiments, the foregoing methods produce the precipitation material comprising reactive vaterite with an average particle size of between 1-25 or 1-20 or 1-10 or 1-5 microns.

In some embodiments, the foregoing methods further comprise a step of transforming the reactive vaterite to aragonite. In some embodiments, the foregoing methods further comprise adding one or more additives to the precipitation material during or after step a), during or after step b), and/or before or during step of transforming the reactive vaterite to aragonite (step c)). In some embodiments, the foregoing methods further comprise adding one or more additives to the precipitation material before the step of transforming the reactive vaterite to aragonite. In some embodiments, in the foregoing methods, the one or more additives are alkaline earth metal ions selected from beryllium, magnesium, strontium, barium, and combinations thereof. In some embodiments, in the foregoing methods, amount of the one or more additives is between 0.5-5% by weight.

In some embodiments, the foregoing methods further comprise adding one or more of admixtures to the precipitation material. In some embodiments, the one or more admixtures are selected from foaming agent, rheology modifying agent, reinforced material, and combinations thereof.

In some embodiments, the foregoing methods further comprise setting and hardening the precipitation material by transforming the reactive vaterite to aragonite and making a building material from the precipitation material.

In some embodiments, the foregoing methods further comprise setting and hardening the precipitation material by transforming the reactive vaterite to aragonite and forming a formed building material. In some embodiments, in the foregoing methods, the formed building material is selected from, but not limited to, masonry unit, construction panel, conduit, basin, beam, column, slab, acoustic barrier, insulation material, and combinations thereof. In some embodiments, in the foregoing methods, the construction panel is selected from, but not limited to, cement board, drywall, and combinations thereof. In some embodiments, in the foregoing methods, the construction panel is used for one or more applications selected from, but not limited to, fiber-cement siding, roofing panel, soffit board, sheathing panel, cladding plank, decking panel, ceiling panel, shaft liner panel, wall board, backer board, underlayment panel, and combinations thereof.

In some embodiments, in the foregoing methods, the reactive vaterite after transformation to aragonite sets and hardens with a compressive strength of at least 3 MPa.

In some embodiments, in the foregoing methods, the methods of forming the drywall comprise forming the drywall using wet process, semi dry process, extrusion process, Wonderboard® process, or combinations thereof.

In some embodiments, in the foregoing second aspect, the method further comprises adding one or more admixtures to the precipitation material at step b) or step c) selected from, but not limited to, foaming agent, rheology modifying agent, reinforced material, and combinations thereof.

In some embodiments, the foregoing methods comprise forming the formed building material or the drywall with a porosity of between 20-90 vol % or between 75-90 vol %.

In some embodiments, the foregoing methods further comprise setting and hardening the precipitation material by transforming the reactive vaterite to aragonite and making an artificial reef from the precipitation material.

In some embodiments, the foregoing methods further comprise setting and hardening the precipitation material by transforming the reactive vaterite to aragonite and making a non-cementitious composition selected from, but not limited to, paper, polymer product, lubricant, adhesive, rubber product, chalk, asphalt product, paint, abrasive for paint removal, personal care product, cosmetic, cleaning product, personal hygiene product, ingestible product, agricultural product, soil amendment product, pesticide, environmental remediation product, and combinations thereof, from the precipitation material.

In some embodiments, in the foregoing methods the carbide lime is obtained from acetylene production process, metallurgical process, calcium cyanamide production process, landfill, or combinations thereof.

In some embodiments, in the foregoing methods the contacting the aqueous solution with the carbide lime occurs at the same time as contacting the aqueous solution with the carbon dioxide. In some embodiments, in the foregoing methods the carbon dioxide from an industrial process is flue gas from a coal-fired power plant. In some embodiments, the coal-fired power plant is a brown coal-fired power plant. In some embodiments, the carbon dioxide from an industrial process is kiln exhaust from a cement plant. In some embodiments, the carbon dioxide from an industrial process further comprises SOx, NOx, mercury, or any combination thereof.

In some embodiments, in the foregoing methods the carbide lime provides divalent cations for producing the precipitation material. In some embodiments, the divalent cations comprises Ca²⁺, Mg²⁺, or a combination thereof. In some embodiments, the carbide lime provides proton-removing agents for producing the precipitation material. In some embodiments, the carbide lime is obtained from acetylene production process, metallurgical process, calcium cyanamide production process, landfill, or combination thereof.

In some embodiments, in the foregoing methods the aqueous solution comprises brine, seawater, or freshwater. In some embodiments, the method further comprises adding a supplemental proton-removing agent. In some embodiments, the proton removing agent is a hydroxide.

In some embodiments, in the foregoing methods the method further comprises separating the precipitation material from the aqueous solution by dewatering and optionally drying.

In some embodiments, in the foregoing methods the precipitation material comprises more than 40% vaterite. In some embodiments, the precipitation material comprises between 40-100 w/w % vaterite. In some embodiments, the precipitation material comprises between 40-99 w/w % vaterite. In some embodiments, the precipitation material comprises between 50-99 w/w % vaterite. In some embodiments, in the foregoing methods the precipitation material has a δ¹³C value of less than −15% or between −15% to −30%.

In some embodiments, in the foregoing methods, the precipitation material after setting and hardening results in compressive strength of more than 10 MPa. In some embodiments, the precipitation material after setting and hardening, results in compressive strength of between 10-60 MPa.

In some embodiments, in the foregoing methods the building material is selected from the group consisting of hydraulic cement, pozzolanic cement, aggregate, and combination thereof.

In another aspect, there is provided a drywall product comprising aragonite, wherein the aragonite has δ¹³C value between −12% to −35%, wherein the density of the drywall product is between 0.4-1.8 g/cm³, wherein the porosity of the drywall product is between 50-90 vol %, and wherein the compressive strength of the drywall product is between 200-2500 psi.

In one aspect, there is provided a product formed by any of the foregoing method aspects and embodiments.

In another aspect, there is provided a system comprising a precipitation reactor configured to contact an aqueous solution comprising carbide lime with carbon dioxide from a source of carbon dioxide and form a carbonate-containing precipitation material comprising vaterite; and a liquid-solid separator operably connected to the precipitation reactor and configured to separate a carbonate-containing precipitation material obtained from the precipitation reactor. In some embodiments, the system further comprises a source of carbon dioxide operably connected to the precipitation reactor. In some embodiments, the source of carbon dioxide is a coal-fired power plant or cement plant. In some embodiments, the system further comprises a building-materials production unit configured to produce a building material from a solid containing carbonate-containing precipitation material obtained from the liquid-solid separator. In some embodiments, the system further comprises a formed building-material production unit (such as, but not limited to, drywall production unit) configured to produce a building material from a solid containing carbonate precipitation material obtained from the liquid-solid separator. In some embodiments, the system is configured to produce carbonate precipitation material in excess of 1 ton per day. In some embodiments, the system is configured to produce carbonate precipitation material in excess of 10 tons per day. In some embodiments, the system is configured to produce carbonate precipitation material in excess of 100 ton per day. In some embodiments, the system is configured to produce carbonate precipitation material in excess of 1000 tons per day. In some embodiments, the system is configured to produce carbonate precipitation material in excess of 10,000 tons per day.

### DRAWINGS

The features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 illustrates an embodiment of the invention.

FIG. 2 illustrates an embodiment of the invention.

FIG. 3 illustrates an embodiment of the invention.

FIG. 4 illustrates an embodiment of the invention.

FIG. 5 illustrates a Gibbs free energy diagram of the transition from vaterite to aragonite.

FIG. 6 illustrates an embodiment of the invention.

FIG. 7 is a scanned electron microscopy (SEM) image of solidified calcium carbonate cement microstructure obtained by adding foaming agent, as described in Example 3.

### DESCRIPTION

Provided herein are methods and systems to produce a vaterite containing product from carbide lime. In some embodiments, the vaterite containing product possesses unique properties, including, but not limited to, cementing properties by transforming to aragonite with high compressive strength. In some embodiments, the vaterite transformation to aragonite results in cementitious product such as cement to form building materials and/or formed building materials such as drywall etc. In some embodiments, the vaterite in the product is stable and may be used as a filler or supplementary cementitious material when mixed with other cement such as OPC. The vaterite containing product may also be used as an aggregate where the vaterite containing precipitation material is chopped up after cementation. In some embodiments, the vaterite containing product may also be used as a precipitated calcium carbonate (PCC) filler in products such as paints, plastics, and paper.

“Carbide lime” as used herein, includes or comprises or consists essentially of calcium hydroxide. The carbide lime may further contain other impurities commonly found in carbide lime such as metal oxides, carbon or some carbonates. Typically, carbide lime does not contain any calcium oxide, or any substantial amount of calcium oxide, if any. Other synonyms of carbide lime include carbide sludge, generator slurry, lime slurry, lime sludge, lime hydrate, calcium hydrate, hydrated lime, lime water, and slaked lime etc. It is to be understood that all such synonyms of carbide lime fall within the scope of the invention. Carbide lime is a hydrated lime slurry that may be produced, for example, as a by-product of the generation of acetylene gas according to the following formula:

CaC₂+2H₂O→C₂H₂+Ca(OH)₂

The calcium carbide is typically produced by heating coke and low quality quicklime to very high temperature in an electric arc furnace. The end product is typically 80% pure with some quantities of lime impurities and unreacted coke present. After the generation of acetylene gas, these calcium carbide impurities may end up in the carbide lime, which, in turn, is usually disposed of in large landfills and lagoons. The acetylene thus formed may be used in producing PVC.

The present invention provides a greener and environment friendly use of the waste carbide lime and produces a calcium carbonate containing product in polymorphic forms such as vaterite, which may be used in several applications. Without being limited by any theory, the carbide lime may also be obtained from metallurgical process, calcium cyanamide production process, landfill, or combination thereof and all such processes that generate carbide lime are well within the scope of the invention.

Before the invention is described in greater detail, it is to be understood that this invention is not limited to particular embodiments described, as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

### I. Methods

There are provided methods and systems utilizing a source of CO₂ (e.g., from an industrial waste stream such as flue gas from power plant or cement plant comprising CO₂), a source of proton-removing agents (e.g., carbide lime providing Ca(OH)₂), and a source of divalent cations (e.g., carbide lime providing Ca²⁺, Mg²⁺) to form vaterite-containing compositions, as described in more detail herein. As described herein, the carbide lime can act both as a source of divalent cations as well as proton-removing agent. The calcium hydroxide present in carbide lime provides calcium ions as a source of divalent cations and hydroxide as a source of proton-removing agent to form calcium carbonate precipitates of the invention. The vaterite in the calcium carbonate precipitates may be a stable vaterite that may act as a filler in the products or the vaterite may be a reactive vaterite that may transform to aragonite during the dissolution-reprecipitation process, as described herein.

The waste sources of metal oxides such as combustion ash (e.g., fly ash, bottom ash, boiler slag), cement kiln dust, and slag (e.g. iron slag, phosphorous slag) may provide a supplemental source of divalent metal cations and proton-removing agents for preparation of the compositions described herein.

Carbide lime, carbon dioxide sources, optional supplemental divalent cation sources, optional supplemental proton-removing sources and methods in which carbide lime is used to produce compositions comprising vaterite, are described.

### Carbide Lime

One aspect relates to a method of treating carbide lime optionally containing insoluble impurities, to obtain useful and solid calcium carbonate products containing vaterite. In some embodiments, the vaterite is a reactive vaterite, as described herein. In some embodiments, the vaterite is a stable vaterite, as described herein. In one aspect, there is provided a method of contacting an aqueous solution comprising carbide lime with carbon dioxide from an industrial process; and producing a precipitation material comprising stable or reactive vaterite. In some embodiments, the method further includes subjecting the aqueous solution to precipitation conditions to produce the carbonate precipitation material. In some embodiments, the precipitation conditions favor formation of stable vaterite. In some embodiments, the precipitation conditions favor formation of reactive vaterite. In some embodiments, the method further includes separating the precipitation material from the aqueous solution by dewatering and optionally drying. The precipitated material may then be used to make cementitious materials, formed building materials or non-cementitious materials.

In some embodiments, the carbide lime method further includes making the precipitation material as a PCC and using it as a filler in non-cementitious compositions such as, but not limited to, paper product, polymer product, lubricant, adhesive, rubber product, chalk, asphalt product, paint, abrasive for paint removal, personal care product, cosmetic, cleaning product, personal hygiene product, ingestible product, agricultural product, soil amendment product, pesticide, environmental remediation product, and combination thereof. Such use of carbonate precipitation material as a filler in non-cementitious products is described in U.S. Pat. No. 7,829,053, issued Nov. 9, 2010, which is incorporated herein by reference in its entirety.

In some embodiments, the carbide lime provides divalent cations for producing the precipitation material. In some embodiments, the divalent cations comprise Ca²⁺, Mg²⁺, or a combination thereof. In some embodiments, the carbide lime also provides proton-removing agents for producing the precipitation material.

In some embodiments, the carbide lime is obtained from acetylene production process, metallurgical process, calcium cyanamide production process, landfill, or combination thereof. Accordingly, in one aspect, there is provided a method including contacting an aqueous solution comprising carbide lime with carbon dioxide from an industrial process; and producing a carbonate precipitation material comprising stable or reactive vaterite wherein the carbide lime is obtained from acetylene production process, metallurgical process, calcium cyanamide production process, landfill, or combination thereof. In one aspect, there is provided a method including contacting an aqueous solution comprising carbide lime with carbon dioxide from an industrial process; and producing a carbonate precipitation material comprising stable or reactive vaterite wherein the carbide lime is obtained from acetylene production process. In one aspect, there is provided a method including contacting an aqueous solution comprising carbide lime with carbon dioxide from an industrial process; and producing a carbonate precipitation material comprising stable or reactive vaterite wherein the carbide lime is obtained from landfill.

In some embodiments, following reaction takes place when an aqueous solution comprising carbide lime is contacted with carbon dioxide from an industrial process:

Ca(OH)₂(s or aq)+CO₂(g)=CaCO₃(s or aq)+H₂O

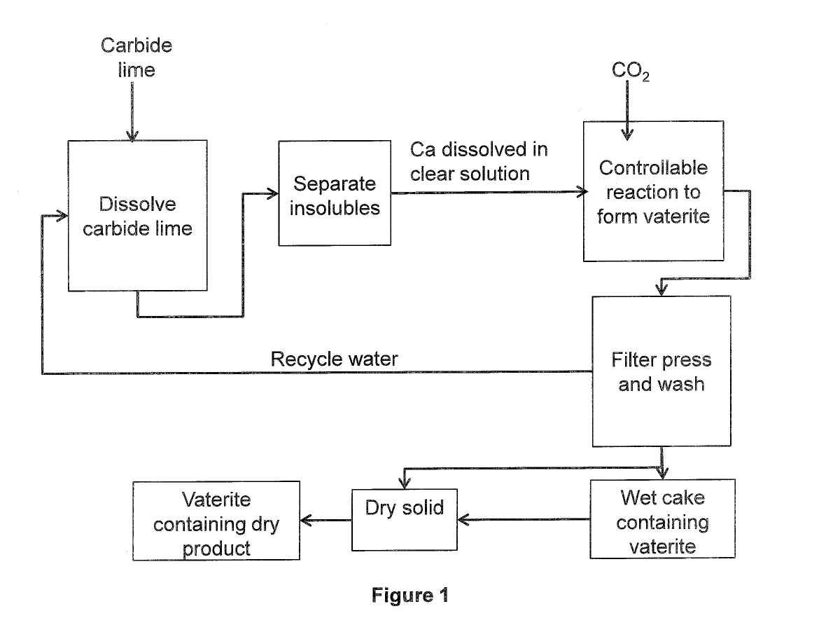

Typical pH during precipitation may be about 12.5 to 7.5. Such an embodiment is illustrated in FIG. 1. As illustrated in FIG. 1, the carbide lime is dissolved in water and optionally after the removal of insoluble impurities, is subjected to carbon dioxide absorption to precipitate out vaterite containing precipitation material. The precipitate may be separated from supernatant and dried to form a dried powdered precipitation material containing vaterite. In some embodiments, the precipitation conditions are such that there is a formation of stable vaterite or reactive vaterite in the product.

In another aspect, there is provided a method including contacting an aqueous solution comprising carbide lime with sodium carbonate to precipitate calcium carbonate product and obtain sodium hydroxide in the supernatant; separating the sodium hydroxide solution from the calcium carbonate product; contacting the sodium hydroxide solution with carbon dioxide from an industrial process to produce sodium carbonate; and contacting the sodium carbonate again with the aqueous solution comprising carbide lime. This method may be called causticization. The pH of this process may be between about 11.5 to 14.

Ca(OH)₂(s)+Na₂CO₃=CaCO₃(s)+2NaOH(aq) (Causticization)

2NaOH(aq)+CO₂(g)=Na₂CO₃(aq)

In another aspect, there is provided a method including contacting an aqueous solution comprising carbide lime with sodium bicarbonate to precipitate calcium carbonate product and obtain sodium carbonate in the supernatant; separating the sodium carbonate solution from the calcium carbonate product; contacting the sodium carbonate solution with carbon dioxide from an industrial process to produce sodium bicarbonate; and contacting the sodium bicarbonate again with the aqueous solution comprising carbide lime. This method may be called carbonatization. The pH of this process may be between about 7.5 to 11.5.

Ca(OH)₂(s)+2NaHCO₃=CaCO₃(s)+Na₂CO₃(aq) (Carbonatization)

Na₂CO₃(aq)+CO₂(g)+H₂O=2NaHCO₃(aq)

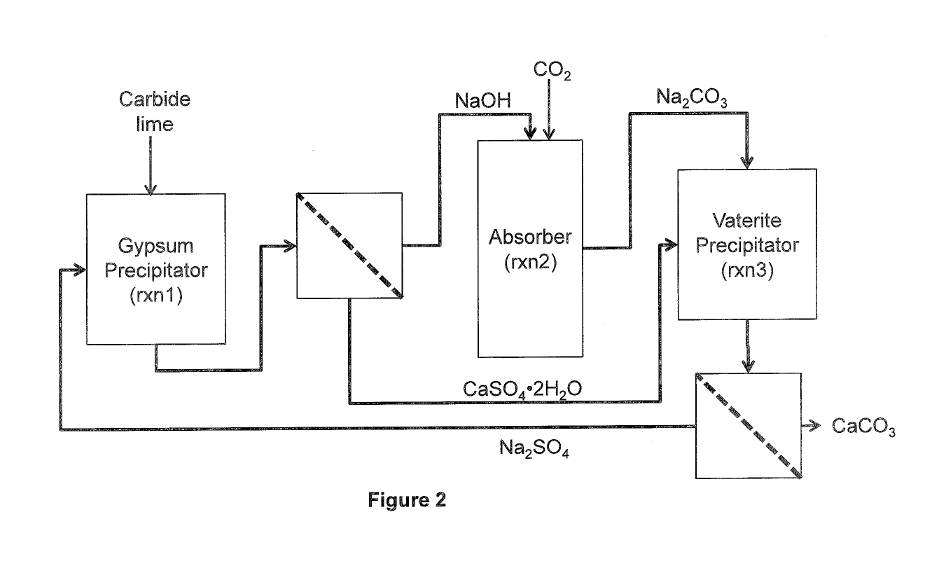

In yet another aspect, there is provided a method including contacting an aqueous solution comprising carbide lime with sodium sulfate to precipitate calcium sulfate product and obtain sodium hydroxide in the supernatant; separating the calcium sulfate product from the sodium hydroxide solution; contacting the sodium hydroxide solution with carbon dioxide from an industrial process to produce sodium carbonate; contacting the sodium carbonate with calcium sulfate to precipitate calcium carbonate and obtain sodium sulfate in the supernatant; and contacting the sodium sulfate solution again with the aqueous solution comprising carbide lime. This method may be called lime-gypsum carbonation. Such method is illustrated in FIG. 2.

Ca(OH)₂(s)+Na₂SO₄(aq)+2H₂O=CaSO₄.2H₂O(s)+2NaOH(aq) (Conversion)

2NaOH(aq)+CO₂(g)=Na₂CO₃(aq)+H₂O (Absorption)

Na₂CO₃(aq)+CaSO₄.2H₂O(s)=CaCO₃(s)+Na₂SO₄(aq)+2H₂O

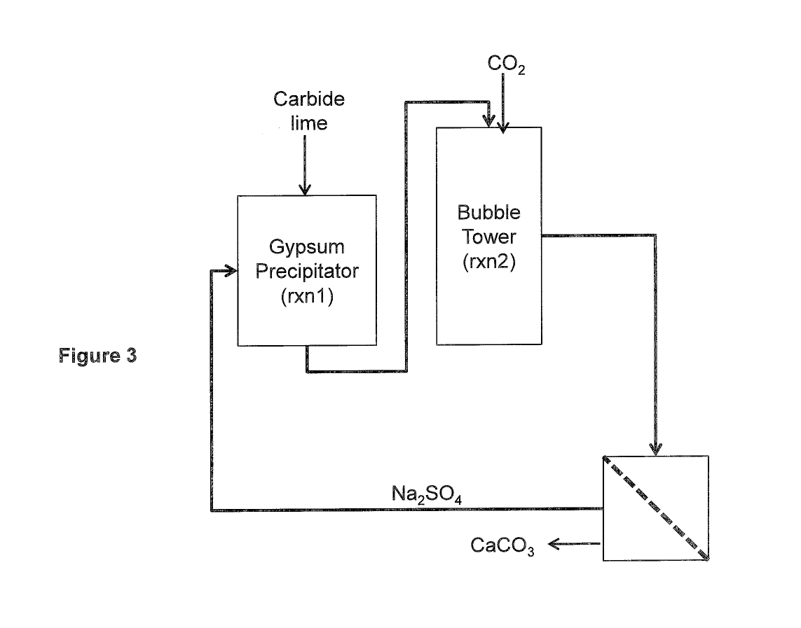

In yet another aspect, there is provided a method including contacting an aqueous solution comprising carbide lime with sodium sulfate to obtain a solution comprising calcium sulfate and sodium hydroxide; contacting the solution comprising calcium sulfate and sodium hydroxide with carbon dioxide from an industrial process to produce calcium carbonate and sodium sulfate; separating the calcium carbonate product from the sodium sulfate solution; and contacting the sodium sulfate solution again with the aqueous solution comprising carbide lime. Such method is illustrated in FIG. 3.

Ca(OH)₂(s)+Na₂SO₄(aq)+2H₂O=CaSO₄.2H₂O(s)+2NaOH(aq) (Conversion)

CaSO₄.2H₂O(s)+2NaOH(aq)+CO₂(g)=Ca₂CO₃(s)+Na₂SO₄(aq)+3H₂O (Absorption)

The dissolution of CO₂ into any of the solutions described above produces CO₂-charged water containing carbonic acid, a species in equilibrium with both bicarbonate and carbonate. In order to produce carbonate precipitation material, protons are removed from various species (e.g. carbonic acid, bicarbonate, hydronium, etc.) by the proton removing agent (e.g., Ca(OH)₂) and the divalent cation-containing solution of carbide lime to shift the equilibrium toward carbonate. As protons are removed, more CO₂ goes into solution. In some embodiments, other proton-removing agents may be used (as described herein) while contacting a divalent cation-containing aqueous solution with CO₂ to increase CO₂ absorption in one phase of the precipitation reaction, where the pH may remain constant, increase, or decrease, followed by a rapid removal of protons (e.g., by addition of a base) to cause precipitation of carbonate precipitation material. The carbonate precipitation material is prepared under precipitation conditions (as described herein) suitable to form vaterite containing material. The carbonate-containing precipitation material is then processed to from a dry vaterite containing precipitation material which can then be used to make building materials or as a PCC filler in materials such as; paints, paper, coatings, plastics, sealants and toothpaste. In some embodiments, the vaterite in the precipitation material may be formed under suitable conditions so that the vaterite is reactive and transforms to aragonite upon dissolution-precipitation process (during cementation). The aragonite may impart one or more unique characteristics to the product including, but not limited to, high compressive strength, complex microstructure network, neutral pH etc. In some embodiments, the vaterite in the precipitation material may be formed under suitable conditions so that the vaterite is stable and is used as PCC filler in various applications.

### Treatment of the Carbide Lime

In some embodiments, the carbide lime may be treated to remove impurities that may result from the original calcium carbide and/or from the conditions under which the acetylene is produced. The carbide lime may be in a dry powder form coming from a dry gas generator and/or is a water slurry from wet generators.

Carbide lime may be a grey-black substance. Typically it consists of calcium hydroxide, the remainder being impurities which depend upon the method used to manufacture the acetylene or any other product and also upon the source of the materials used to manufacture the calcium carbide (normally made by roasting calcium oxide and coal). The impurities may include, but not limited to, the oxides of silicon, iron, aluminium, magnesium, and manganese combined with carbon, ferrosilicon and calcium sulphate. Since the carbide lime does not have a significant commercial use and has the impurities, it may render disposal of the carbide lime difficult. There are millions of tonnes of carbide lime stored in carbide lime pits all over the world. These pits are an ever increasing environmental problem.

In some embodiments, the carbide lime is used in the methods and systems of the invention as is, i.e. without removing impurities. In some embodiments, the carbide lime is simply purified by removing the solid impurities by conventional techniques, such as centrifugation, filtration, etc. In some embodiments, the carbide lime is purified by treatment with water.

Calcium hydroxide is sparingly soluble in water where the solubility may decrease with increase in temperature. In the methods and systems provided herein, the carbide lime solubility is increased by its purification with various chemicals. In some embodiments of the invention, the carbide lime is purified by treating carbide lime with a weak base. The “weak base” as used herein includes any base with a PKb value of between 3-6.5. The “purifying” or “purification” or its grammatical equivalents include solubilizing of calcium hydroxide in aqueous medium. In some embodiments, the weak base is a solubilizing weak base that selectively solubilizes calcium hydroxide in the carbide lime and leaves the solid impurities. Such weak bases are well known in the art and include without limitation, borate, N-containing salt, or N-containing aliphatic or aromatic compound, etc. Examples of N-containing salt include, but not limited to, ammonium chloride, ammonium sulfate, ammonium nitrate, and the like. Examples of N-containing compounds include, but not limited to, amines (monoethanolamine or ethylamine), amino acid, amino alcohol, amino ester, alicyclic amines and heterocyclic amines such as pyridine, pyrrolidene, etc. Such chemicals are well known in the art and are commercially available.

In some embodiments, there is provided a method comprising a) purifying carbide lime by treatment with weak base to make an aqueous solution comprising carbide lime; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite. In some embodiments, the N-containing salt includes, but not limited to, ammonium chloride, ammonium sulfate, ammonium nitrate, and the like.

In some embodiments, there is provided a method comprising a) purifying carbide lime by treatment with N-containing salt, N-containing aliphatic compound, N-containing aromatic compound, or combinations thereof to make an aqueous solution comprising carbide lime; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with ammonium chloride, ammonium sulfate, ammonium nitrate, or combination thereof to make an aqueous solution comprising carbide lime; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with ammonium chloride to make an aqueous solution comprising carbide lime; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

The “stable vaterite” or its grammatical equivalent as used herein includes vaterite that does not transform to aragonite or calcite during and/or after dissolution-reprecipitation process. The “reactive vaterite” or “activated vaterite” or its grammatical equivalent as used herein, includes vaterite that results in aragonite formation during and/or after dissolution-re-precipitation process. The method for formation of such reactive vaterite has been described herein.

In some embodiments, the above recited methods further include separating the precipitation material from the aqueous solution by dewatering and optionally drying. The precipitated material may then be used to make cementitious or non-cementitious materials.

In some embodiments, carbide lime may be purified by other methods such as, but not limited to, heating, filtration, dissolution of calcium hydroxide in water followed by filtration, solution of calcium hydroxide in water, using an ammonium salt as a solvating aid, followed by filtration, etc.

In some embodiments, the amount of the weak base such as, borate, N-containing salt, N-containing aliphatic compound, N-containing aromatic compound, or combinations thereof is in 30% excess to carbide lime. In some embodiments, the weak base such as, borate, N-containing salt, N-containing aliphatic compound, N-containing aromatic compound, or combinations thereof is in a ratio of between 2:1 to 4:1 (weak base:carbide lime) or 2:1 to 3:1 or 2.5:1 to 3:1 or 3:1 to 4:1, or 2:1, or 3:1, or 4:1 with carbide lime. In some embodiments, the weak base such as, N-containing salt, such as ammonium chloride, ammonium sulfate, ammonium nitrate etc. is in a ratio of 2:1 to 4:1 (weak base:carbide lime) or 2:1 to 3:1 or 2.5:1 to 3:1 or 3:1 to 4:1, or 2:1, or 3:1, or 4:1 with carbide lime. Accordingly, in some embodiments, there is provided a method comprising a) purifying carbide lime by treatment with weak base, such as, but not limited to, borate, N-containing salt such as, ammonium chloride, ammonium sulfate, ammonium nitrate etc., N-containing aliphatic compound, N-containing aromatic compound, or combinations thereof to make an aqueous solution comprising carbide lime wherein ratio of the weak base:carbide lime is between 2:1 to 4:1 or 2:1 to 3:1 or 2.5:1 to 3:1 or 3:1 to 4:1, or 2:1, or 3:1, or 4:1; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with borate to make an aqueous solution comprising carbide lime wherein ratio of the borate:carbide lime is between 2:1 to 4:1 or 2:1 to 3:1 or 2.5:1 to 3:1 or 3:1 to 4:1, or 2:1, or 3:1, or 4:1; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with N-containing salt such as, ammonium chloride, ammonium sulfate, ammonium nitrate etc. to make an aqueous solution comprising carbide lime wherein ratio of the N-containing salt:carbide lime is between 2:1 to 4:1 or 2:1 to 3:1 or 2.5:1 to 3:1 or 3:1 to 4:1, or 2:1, or 3:1, or 4:1; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with N-containing aliphatic compound, such as, an amino acid, such as, glycine, N-containing aromatic compound, or combinations thereof to make an aqueous solution comprising carbide lime wherein ratio of the N-containing aliphatic compound, N-containing aromatic compound, or combinations thereof:carbide lime is between 2:1 to 4:1 or 2:1 to 3:1 or 2.5:1 to 3:1 or 3:1 to 4:1, or 2:1, or 3:1, or 4:1; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, there is provided a method comprising a) purifying carbide lime by treatment with N-containing salt, N-containing aliphatic compound, or combinations thereof to make an aqueous solution comprising carbide lime wherein ratio of the N-containing salt, N-containing aliphatic compound, or combinations thereof:carbide lime is between 2:1 to 4:1 or 2:1 to 3:1 or 2.5:1 to 3:1 or 3:1 to 4:1, or 2:1, or 3:1, or 4:1; b) contacting an aqueous solution comprising carbide lime with carbon dioxide from an industrial process; and c) producing a precipitation material comprising stable or reactive vaterite. In some embodiments, the method further includes subjecting the aqueous solution to precipitation conditions at step b) to produce the precipitation material comprising stable or reactive vaterite.

In some embodiments, the above recited ratios or such ratios herein are molar ratios.

In some embodiments, carbide lime may be purified by treating the lime with an aqueous solution of a polyhydroxy compound having three or more hydroxy groups and a straight chain of 3 to 8 carbon atoms; and optionally separating insoluble impurities from the solution. The polyhydroxy compound solution may be used as a solvent for the calcium and allow a much higher amount (e.g. about 65 g/l) of the calcium ions present in the lime to go into solution than would be the case of use of only water. After removal of insoluble impurities, there may remain a purified solution of calcium ions which may be used for the production of calcium containing products of considerably higher commercial value than carbide lime. The polyhydroxy compound may have a straight chain of 3 to 8 carbon atoms and have significant solubility in water under the conditions employed. Examples of polyhydroxy compounds which may be used are of the formula: HOCH₂(CHOH)nCH₂OH, where n is 1 to 6. Thus for example the polyhydroxy compound may be glycerol (n=1). In some embodiments, n is 2 to 6. For example, in some embodiments, the polyhydroxy compound is a sugar alcohol (a “hydrogenated monosaccharide”). Examples of sugar alcohols include sorbitol, mannitol, xylitol, threitol and erythritol. In some embodiments, the polydroxy compounds are those having a straight chain of n carbon atoms where n is 4 to 8 and (n−1) of the carbon atoms have a hydroxyl group bonded thereto. The other carbon atom (i.e. the one without the hydroxyl group) may have a saccharide residue bonded thereto. Such compounds are hydrogenated disaccharide alcohols and examples include maltitol and lactitol. In some embodiments, the examples include hydrogenated monosaccharide (e.g. sorbitol) and disaccharide alcohols because of their thermal stability which can be important for subsequent processing of the calcium ion solution. Mixtures of the above described polyhydric alcohols may also be used. For example, industrial sorbitol, which of the solids present, comprise about 80% sorbitol together with other polyhydroxy compounds such as mannitol and disaccharide alcohols. Examples of industrial sorbitol include Sorbidex NC 16205 from Cerestar and Meritol 160 from Amylum.

Depending on its solubility in water at the temperature used in the method, the polyhydroxy compound may be employed as a 10% to 80% by weight solution in water. When the polyhydroxy compound is a sugar alcohol, it may be used as 10% to 60% by weight solution, or 15% to 40% by weight solution in water. In contrast glycerol may be used as 60% to 80% by weight solution in water, or 65% to 75% by weight solution. Examples of saccharides that may be useful in the invention include glucose, fructose, ribose, xylose, arabinose, galactose, mannose, sucrose, lactose and maltose. Examples of saccharide derivatives which may be useful in the invention include saccharide alcohols such as sorbitol and mannitol. In some embodiments, the polyhydroxy compound is chosen from the group consisting of sucrose, glucose, sorbitol and glycerol.

In some embodiments of the methods described herein, no polyhydroxy compounds are employed to form the products of the invention. Accordingly, there is provided a method including contacting an aqueous solution comprising carbide lime with carbon dioxide from an industrial process; and producing a precipitation material comprising stable or reactive vaterite wherein no polyhydroxy compound is used in the method.

In some embodiments, there is provided a method including contacting an aqueous solution comprising carbide lime with carbon dioxide from an industrial process; and producing a precipitation material comprising stable or reactive vaterite wherein a component is added to the carbide lime selected from the group consisting of saccharides (mono-, di-, oligo-, and poly-. e.g. sucrose and glucose), polyols (e.g. glycerol and mannitol), polyamino carboxylic acids (e.g. EDTA and EGTA), and crown ethers (e.g. aza-crown ethers).

Agitation may be used to effect purification of carbide lime, for example, by eliminating hot and cold spots. In some embodiments of the invention, the concentration of carbide lime in water may be between 1 and 10 g/L, 10 and 20 g/L, 20 and 30 g/L, 30 and 40 g/L, 40 and 80 g/L, 80 and 160 g/L, 160 and 320 g/L, 320 and 640 g/L, or 640 and 1280 g/L. To optimize the purification of carbide lime, high shear mixing, wet milling, and/or sonication may be used to break open carbide lime. After high shear mixing and/or wet milling, the carbide lime mixture may be contacted with a source of carbon dioxide such as flue gas from a coal-fired power plant or exhaust from a cement kiln. Any of a number of the gas-liquid contacting protocols described herein may be utilized. Gas-liquid contact is continued until the pH of the precipitation reaction mixture is optimum, after which the precipitation reaction mixture is allowed to stir. The rate at which the pH drops may be controlled by addition of more carbide lime during gas-liquid contact. In addition, additional carbide lime may be added after sparging to raise the pH back to basic levels for precipitation of a portion or all of the precipitation material. In any case, precipitation material may be formed upon removing protons from certain species (e.g., carbonic acid, bicarbonate, hydronium) in the precipitation reaction mixture. A precipitation material comprising carbonates may then be separated and, optionally, further processed.

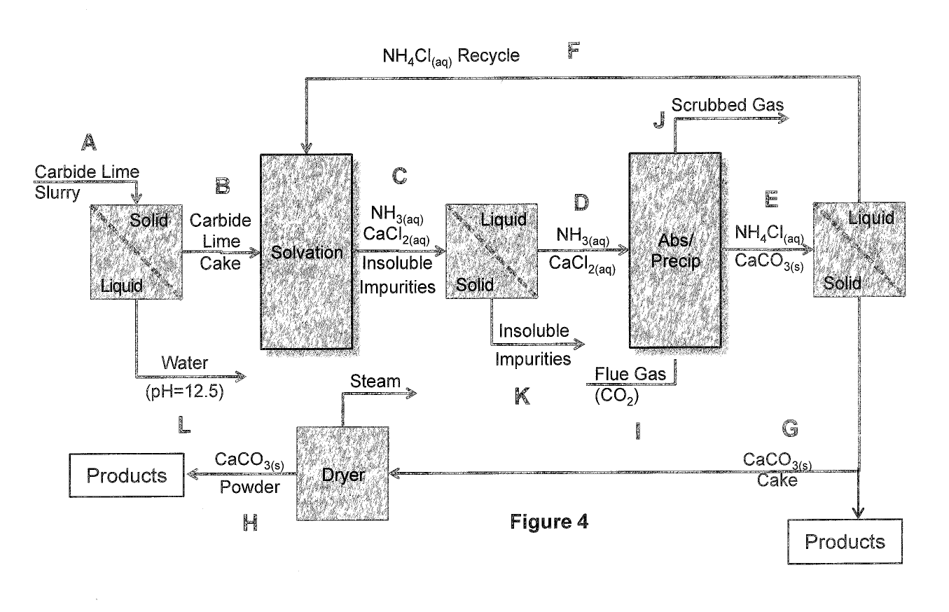

Some embodiments of the invention are illustrated in FIG. 4. It is to be understood that ammonium chloride is used for illustration purposes only and other weak bases to purify the carbide lime are well within the scope of the invention. One or more steps may be omitted or modified or the order of the steps may be changed in FIG. 4. As illustrated in FIG. 4, carbide lime slurry may be dewatered in step A using any technique such as centrifugation. The dewatered carbide lime cake may be then reacted with ammonium salt solution, such as, but not limited to, ammonium chloride solution (new and recycled) in step B when the reaction that occurs is:

Ca(OH)₂(s)+2NH₄Cl(aq)→2NH₃(aq)+CaCl₂(aq)+2H₂O(l)

The solution may optionally be then subjected to filtration at step C to remove insoluble impurities. The insoluble impurities may be disposed as waste or are used in other processes in step K. The solution is treated with flue gas at step D when the precipitation of calcium carbonate takes place to form calcium carbonate slurry. The scrubbed gas may be released at step J. Gas-liquid contact may be continued until the pH is optimum, after which the precipitation reaction mixture is allowed to stir. Other precipitation conditions that may favor formation of stable or reactive vaterite are described further herein. The rate at which the pH drops may be controlled by addition of additional supernatant or carbide lime during gas-liquid contact. In addition, additional supernatant or carbide lime may be added after gas-liquid contact to raise the pH back to basic levels for precipitation of a portion or all of the precipitation material. In any case, the carbonate precipitation material is formed upon removing protons from certain species (e.g., carbonic acid, bicarbonate, hydronium) in the precipitation reaction mixture.

The calcium carbonate slurry is subjected to dewatering and optionally rinsed at step E to form calcium carbonate slurry (with reduced water) or cake and the ammonium chloride solution. The ammonium chloride solution is recycled back for the treatment with carbide lime in step F or is treated as waste. Additional ammonium chloride may be added to the recycled solution to make up for the loss of the ammonium chloride during the process and bring the concentration of ammonium chloride to optimum level. The calcium carbonate cake may be sent to the dryer at step G to form calcium carbonate powder containing stable or reactive vaterite. The powder form the precipitation material comprising stable or reactive vaterite may be used further in applications to form products, as described herein. The cake may be dried using any drying techniques known in the art such as, but not limited to fluid bed dryer. The resulting solid powder is then mixed with additives to make different products described herein. In some embodiments, the slurry form with reduced water or the cake form of the precipitation material is directly used to form products, such as drywall, as described herein.

Optionally after step A, the carbide lime may be separated into a carbide sludge, which may be dried and used as a pozzolan, and a supernatant comprising divalent cations and proton-removing agents may be used for precipitation of precipitation material. The supernatant may then be contacted with a source of carbon dioxide (with or without dilution) such as flue gas from a coal-fired power plant or exhaust from a cement kiln.

Contact with Carbon Dioxide

An aqueous solution of carbide lime is contacted with CO₂ from a source of CO₂ at any time before, during, or after the carbide lime solution is subjected to precipitation conditions (i.e., conditions allowing for precipitation of one or more materials). Accordingly, in some embodiments, an aqueous solution of carbide lime solution is contacted with a source of CO₂ prior to subjecting the aqueous solution to precipitation conditions that favor formation of stable or reactive vaterite containing carbonate compounds. In some embodiments, an aqueous solution of carbide lime solution is contacted with a source of CO₂ while the aqueous solution is being subjected to precipitation conditions that favor formation of stable or reactive vaterite containing carbonate compounds. In some embodiments, an aqueous solution of carbide lime solution is contacted with a source of a CO₂ prior to and while subjecting the aqueous solution to precipitation conditions that favor formation of stable or reactive vaterite containing carbonate compounds. In some embodiments, an aqueous solution of carbide lime solution is contacted with a source of CO₂ after subjecting the aqueous solution to precipitation conditions that favor formation of stable or reactive vaterite containing carbonate compounds. In some embodiments, an aqueous solution of carbide lime solution is contacted with a source of CO₂ before, while, and after subjecting the aqueous solution to precipitation conditions that favor formation of stable or reactive vaterite containing carbonate compounds.

In some embodiments, the contacting of the aqueous solution comprising carbide lime with carbon dioxide from an industrial process is achieved by contacting water with the carbide lime to achieve a desired pH and/or desired divalent cation concentration using any convenient protocol. In some embodiments, the systems of the invention include a precipitation reactor configured to contact the aqueous solution comprising carbide lime with carbon dioxide from an industrial process.

In some embodiments, flue gas from a coal-fired power plant is passed directly into a precipitation reactor without prior removal of the fly ash, obviating the use of electrostatic precipitators and the like. In some embodiments, the carbide lime is provided to a precipitation reactor directly. In some embodiments, the carbide lime may be placed in a precipitation reactor holding water, wherein the amount of carbide lime added is sufficient to raise the pH to a desired level (e.g., a pH that induces precipitation of the precipitation material) such as pH 7-14, pH 8-14, pH 9-14, pH 10-14, pH 11-14, pH 12-14, or pH 13-14. In some embodiments, the carbide lime is immobilized in a column or bed. In such embodiments, water is passed through or over an amount of the carbide lime sufficient to raise the pH of the water to a desired pH or to a particular divalent cation concentration. In some embodiments, the aqueous solution of carbide lime may be cycled more than once, wherein a first cycle of precipitation removes primarily calcium carbonate minerals and leaves an alkaline solution to which additional carbide lime may be added. Carbon dioxide, when contacted with the recycled solution of carbide lime, allows for the precipitation of more carbonate and/or bicarbonate compounds. It will be appreciated that, in these embodiments, the aqueous solution following the first cycle of precipitation may be contacted with the CO₂ source before, during, and/or after carbide lime has been added. In these embodiments, the water may be recycled or newly introduced. As such, the order of addition of CO₂ and carbide lime may vary. For example, the carbide lime providing divalent cations and proton-removing agents may be added to, for example, brine, seawater, or freshwater, followed by the addition of CO₂. In another example, CO₂ may be added to, for example, brine, seawater, or freshwater, followed by the addition of carbide lime.

The aqueous solution comprising carbide lime may be contacted with a CO₂ using any convenient protocol. Where the CO₂ is a gas, contact protocols of interest include, but not limited to, direct contacting protocols (e.g., bubbling the CO₂ gas through the aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, in the precipitation reactor. In some embodiments, gas-liquid contact is accomplished by forming a liquid sheet of solution with a flat jet nozzle, wherein the CO₂ gas and the liquid sheet move in countercurrent, co-current, or crosscurrent directions, or in any other suitable manner. Further description in for example, U.S. Patent Application No. 61/158,992, filed 10 Mar. 2009, is hereby incorporated by reference in its entirety. In some embodiments, gas-liquid contact is accomplished by contacting liquid droplets of solution having an average diameter of 500 micrometers or less, such as 100 micrometers or less, with a CO₂ gas source. In some embodiments, a catalyst may be used to accelerate the dissolution of carbon dioxide into solution by accelerating the reaction toward equilibrium; the catalyst may be an inorganic substance such as zinc dichloride or cadmium, or an organic substance such as an enzyme (e.g., carbonic anhydrase).

The source of CO₂ may be any convenient CO₂ source. The CO₂ source may be a gas, a liquid, a solid (e.g., dry ice), a supercritical fluid, or CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulates. In some embodiments, the gaseous CO₂ source is a waste feed (i.e., a by-product of an active process of the industrial plant) such as exhaust from an industrial plant. The nature of the industrial plant may vary, the industrial plants of interest including, but not limited to, power plants, chemical processing plants, mechanical processing plants, refineries, cement plants, steel plants, and other industrial plants that produce CO₂ as a by-product of fuel combustion or another processing step (such as calcination by a cement plant).

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient for the invention include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems of the invention. In some embodiments, combustion gases in post-combustion effluent stacks of industrial plants such as power plants, cement plants, and coal processing plants is used.

Thus, the waste streams may be produced from a variety of different types of industrial plants. Suitable waste streams for the invention include waste streams produced by industrial plants that combust fossil fuels (e.g., coal, oil, natural gas) and anthropogenic fuel products of naturally occurring organic fuel deposits (e.g., tar sands, heavy oil, oil shale, etc.). In some embodiments, waste streams suitable for systems and methods of the invention are sourced from a coal-fired power plant, such as a pulverized coal power plant, a supercritical coal power plant, a mass burn coal power plant, a fluidized bed coal power plant; in some embodiments the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce aggregate in accordance with systems and methods of the invention.

Waste streams produced by cement plants are also suitable for systems and methods of the invention. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously.

Industrial waste gas streams may contain carbon dioxide as the primary non-air derived component, or may, especially in the case of coal-fired power plants, contain additional components such as nitrogen oxides (NOx), sulfur oxides (SOx), and one or more additional gases. Additional gases and other components may include CO, mercury and other heavy metals, and dust particles (e.g., from calcining and combustion processes). Additional components in the gas stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. The waste streams, particularly various waste streams of combustion gas, may include one or more additional components, for example, water, NOx (mononitrogen oxides: NO and NO2), SOx (monosulfur oxides: SO, SO₂ and SO₃), VOC (volatile organic compounds), heavy metals such as mercury, and particulate matter (particles of solid or liquid suspended in a gas). Flue gas temperature may also vary. In some embodiments, the temperature of the flue gas is from 0° C. to 2000° C., such as from 60° C. to 700° C., and including 100° C. to 400° C.

In various embodiments, one or more additional components are precipitated in precipitation material formed by contacting the waste gas stream comprising these additional components with an aqueous solution comprising carbide lime containing alkaline earth metal ions such as Ca²⁺. Sulfates and/or sulfites of calcium and optionally magnesium may be precipitated in precipitation material produced from waste gas streams comprising SOx (e.g., SO₂). Magnesium and calcium may react to form CaSO₄, MgSO₄, as well as other calcium- and magnesium-containing compounds (e.g., sulfites), effectively removing sulfur from the flue gas stream without a desulfurization step such as flue gas desulfurization (“FGD”). In addition, vaterite containing precipitate may be formed without additional release of CO₂. In instances where the aqueous solution of divalent cations contains high levels of sulfur compounds (e.g., sulfate), the aqueous solution may be enriched with calcium and magnesium so that calcium and magnesium are available to form carbonate compounds after, or in addition to, formation of CaSO₄, MgSO₄, and related compounds. In some embodiments, a desulfurization step may be staged to coincide with precipitation of the precipitation material, or the desulfurization step may be staged to occur before precipitation. In some embodiments, multiple reaction products (e.g., precipitation material containing vaterite, CaSO₄, etc.) are collected at different stages, while in other embodiments a single reaction product (e.g., carbonate containing precipitation material comprising vaterite, sulfates, etc.) is collected. In step with these embodiments, other components, such as heavy metals (e.g., mercury, mercury salts, mercury-containing compounds), may be trapped in the precipitation material or may precipitate separately.

A portion of the gaseous waste stream (i.e., not the entire gaseous waste stream) from an industrial plant may be used to produce precipitation material. In these embodiments, the portion of the gaseous waste stream that is employed in precipitation of precipitation material may be 75% or less, such as 60% or less, and including 50% and less of the gaseous waste stream. In yet other embodiments, substantially (e.g., 80% or more) the entire gaseous waste stream produced by the industrial plant is employed in precipitation of precipitation material. In these embodiments, 80% or more, such as 90% or more, including 95% or more, up to 100% of the gaseous waste stream (e.g., flue gas) generated by the source may be employed for precipitation of precipitation material.

Although industrial waste gas offers a relatively concentrated source of combustion gases, methods and systems of the invention are also applicable to removing combustion gas components from less concentrated sources (e.g., atmospheric air), which contains a much lower concentration of pollutants than, for example, flue gas. Thus, in some embodiments, methods and systems encompass decreasing the concentration of pollutants in atmospheric air by producing a stable precipitation material. In these cases, the concentration of pollutants, e.g., CO₂, in a portion of atmospheric air may be decreased by 10% or more, 20% or more, 30% or more, 40% or more, 50% or more, 60% or more, 70% or more, 80% or more, 90% or more, 95% or more, 99% or more, 99.9% or more, or 99.99%. Such decreases in atmospheric pollutants may be accomplished with yields as described herein, or with higher or lower yields, and may be accomplished in one precipitation step or in a series of precipitation steps.

Supplemental Source of Divalent Cation and/or Proton Removing Agent

In some embodiments, the divalent cations of carbide lime may be supplemented with divalent metal cations from other sources such as, but not limited to, combustion ash selected from fly ash, bottom ash, and boiler slag; cement kiln dust; and/or slag (e.g. iron slag, phosphorous slag). For example, the source of divalent cations may be a combination of carbide lime and seawater. When a combination (e.g., carbide lime in combination with another source of divalent cations) is used, the carbide lime may be used in any order. For example, a basic solution may already contain divalent cations (e.g., seawater) before adding the carbide lime, or a source of divalent cations may be added to a slurry of carbide lime in water. In any of these embodiments, as described in further detail herein, CO₂ is added before or after carbide lime.

In some locations, industrial waste streams from various industrial processes provide for convenient sources of divalent cations (as well as in some cases other materials useful in the process, e.g., metal hydroxide). Such waste streams include, but are not limited to, mining wastes; fossil fuel burning ash (e.g., fly ash, as described in further detail herein); slag (e.g. iron slag, phosphorous slag); cement kiln waste (described in further detail herein); oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge.

The aqueous solution of supplemental divalent cations may comprise divalent cations derived from freshwater, brackish water, seawater, or brine (e.g., naturally occurring brines or anthropogenic brines such as geothermal plant wastewaters, desalination plant waste waters), as well as other salines having a salinity that is greater than that of freshwater, any of which may be naturally occurring or anthropogenic. Brackish water is water that is saltier than freshwater, but not as salty as seawater. Brackish water has a salinity ranging from about 0.5 to about 35 ppt (parts per thousand). Seawater is water from a sea, an ocean, or any other saline body of water that has a salinity ranging from about 35 to about 50 ppt. Brine is water saturated or nearly saturated with salt. Brine has a salinity that is about 50 ppt or greater. In some embodiments, the saltwater source from which divalent cations are derived is a naturally occurring source selected from a sea, an ocean, a lake, a swamp, an estuary, a lagoon, a surface brine, a deep brine, an alkaline lake, an inland sea, or the like. In some embodiments, the saltwater source from which the divalent cations are derived is an anthropogenic brine selected from a geothermal plant wastewater or a desalination wastewater.

Freshwater may be a convenient source of divalent cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of divalent cations such as alkaline earth metal cations (e.g., Ca²⁺, Mg²⁺, etc.) to produce a mineral-rich water that is suitable for methods and systems described herein. Divalent cations or precursors thereof (e.g. salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, monovalent cations selected from Na⁺ and K⁺ are added to freshwater. In some embodiments, freshwater comprising Ca²⁺ is combined with magnesium silicates (e.g., olivine or serpentine), or products or processed forms thereof, yielding a solution comprising calcium and magnesium cations.

Many minerals provide supplemental sources of divalent cations and, in addition, some minerals are sources of base. Mafic and ultramafic minerals such as olivine, serpentine, and any other suitable mineral may be dissolved using any convenient protocol. Other minerals such as wollastonite may also be used. Dissolution may be accelerated by increasing surface area, such as by milling by conventional means or by, for example, jet milling, as well as by use of, for example, ultrasonic techniques. In addition, mineral dissolution may be accelerated by exposure to acid or base. Metal silicates (e.g., magnesium silicates) and other minerals comprising cations of interest may be dissolved, for example, in acid such as HCl (optionally from an electrochemical process) to produce, for example, magnesium and other metal cations for use in precipitation material. In some embodiments, magnesium silicates and other minerals may be digested or dissolved in an aqueous solution that has become acidic due to the addition of carbon dioxide and other components of waste gas (e.g., combustion gas). Alternatively, other metal species such as metal hydroxide(e.g., Mg(OH)₂, Ca(OH)₂) may be made available for use by dissolution of one or more metal silicates (e.g., olivine and serpentine) with aqueous alkali hydroxide (e.g., NaOH) or any other suitable caustic material. Any suitable concentration of aqueous alkali hydroxide or other caustic material may be used to decompose metal silicates, including highly concentrated and very dilute solutions. The concentration (by weight) of an alkali hydroxide (e.g., NaOH) in solution may be, for example, from 30% to 80% and from 70% to 20% water. Advantageously, metal silicates and the like digested with aqueous alkali hydroxide may be used directly to produce precipitation material. In addition, base value from the precipitation reaction mixture may be recovered and reused to digest additional metal silicates and the like.

In some embodiments, an aqueous solution of supplemental divalent cations may be obtained from an industrial plant that is also providing a combustion gas stream. For example, in water-cooled industrial plants, such as seawater-cooled industrial plants, water that has been used by an industrial plant for cooling may then be used as water for producing precipitation material. If desired, the water may be cooled prior to entering the precipitation system. Such approaches may be employed, for example, with once-through cooling systems. For example, a city or agricultural water supply may be employed as a once-through cooling system for an industrial plant. Water from the industrial plant may then be employed for producing precipitation material, wherein output water has a reduced hardness and greater purity.

The carbide lime may also be the sole source of proton-removing agents for preparation of the compositions described herein. In some embodiments, the proton removing agents of carbide lime may be supplemented with proton removing agents from other sources, such as, but not limited to, combustion ash selected from fly ash, bottom ash, and boiler slag; cement kiln dust; and/or slag (e.g. iron slag, phosphorous slag). Examples of other proton-removing agents that may be used include oxides (e.g., CaO), hydroxides (e.g., KOH, NaOH, brucite (Mg(OH)₂, etc.), carbonates (e.g., Na₂CO₃), serpentine, and the like. Serpentine, which also releases silica and magnesium into the reaction mixture, ultimately leads to compositions comprising carbonates and silica (in addition to that found in combustion ashes). The amount of supplemental proton-removing agent that may be used depends upon the particular nature of the supplemental proton-removing agent and the volume of water to which the supplemental proton-removing agent is being added.

In some embodiments, the carbide lime may be supplemented with divalent cations such as calcium chloride that can be obtained commercially and proton removing agents such as sodium hydroxide that may also be obtained commercially or obtained by electrochemical methods.

In some embodiments, proton-removing agents (and methods for effecting proton removal) are combined such that 1-30% of the proton-removing agent is sourced from carbide lime, 20-80% of the proton-removing agent is sourced from waste (e.g. red mud), minerals such as serpentine, or a combination thereof, and 10-50% of proton removal is effected through electrochemical methods. For example, some embodiments provide for a combination of proton-removing agents and electrochemical methods such that 10% of the proton-removing agent is sourced from carbide lime, 60% of the proton-removing agent is sourced from waste from a mining process (e.g. red mud), and 30% of the proton removal is effected by electrochemical methods. Some embodiments provide for a combination of proton-removing agents and electrochemical methods such that 70% of the proton-removing agent is sourced from carbide lime, 10% of the proton-removing agent is from sourced from naturally occurring mineral sources (e.g. dissolved serpentine), and 20% of the proton removal is effected by electrochemical methods. Some embodiments provide for a combination of proton-removing agents and electrochemical methods such that 30% of the proton-removing agent is sourced from carbide lime and 70% of the proton-removing agent is sourced from sodium hydroxide from electrochemical methods. Some embodiments provide for a combination of proton-removing agents and electrochemical methods such that 50-80% of the proton-removing agent is sourced from carbide lime and 20-50% of the proton-removing agent is sourced from sodium hydroxide from electrochemical methods.

### Precipitation Conditions

In methods provided herein, an aqueous solution comprising CO₂ charged water, produced by contacting the aqueous solution comprising carbide lime with CO₂, is subjected to one or more of carbonate compound precipitation conditions sufficient to produce a precipitation material comprising stable or reactive vaterite and a supernatant (i.e., the part of the precipitation reaction mixture that is left over after precipitation of the precipitation material). The one or more precipitation conditions favor production of a precipitation material comprising stable or reactive vaterite.

In some embodiments, there is provided a method comprising a) contacting an aqueous solution comprising carbide lime with carbon dioxide from an industrial process; b) subjecting the aqueous solution to one or more precipitation conditions to produce a precipitation material comprising stable or reactive vaterite.

In some embodiments, making the aqueous solution of the carbide lime occurs prior to charging the aqueous solution with a source of carbon dioxide. In some embodiments, making the aqueous solution of the carbide lime occurs at the same time as charging the aqueous solution with a source of carbon dioxide. In some embodiments, making the aqueous solution of the carbide lime, charging the aqueous solution with a source of carbon dioxide, and subjecting the aqueous solution to precipitation conditions occurs at the same time.

In some embodiments, there is provided a method comprising a) purifying carbide lime by treatment with weak base such as, but not limited to, borate, N-containing salt, N-containing aliphatic compound, N-containing aromatic compound, or combination thereof to make an aqueous solution comprising carbide lime; b) contacting the aqueous solution comprising carbide lime with carbon dioxide from an industrial process; and c) subjecting the aqueous solution to one or more precipitation conditions to produce a precipitation material comprising stable or reactive vaterite.

In some embodiments, there is provided a method comprising a) purifying carbide lime by treatment with weak base such as, but not limited to, N-containing salt to make an aqueous solution comprising carbide lime; b) contacting the aqueous solution comprising carbide lime with carbon dioxide from an industrial process; and c) subjecting the aqueous solution to one or more precipitation conditions to produce a precipitation material comprising stable or reactive vaterite. Examples of N-containing salt include, but not limited to, ammonium chloride, ammonium nitrate, ammonium sulfate etc.

In some embodiments, there is provided a method comprising a) purifying carbide lime by treatment with weak base such as, but not limited to, N-containing aliphatic compound to make an aqueous solution comprising carbide lime; b) contacting the aqueous solution comprising carbide lime with carbon dioxide from an industrial process; and c) subjecting the aqueous solution to one or more precipitation conditions to produce a precipitation material comprising stable or reactive vaterite.

In some embodiments, there is provided a method comprising a) purifying carbide lime by treatment with weak base, such as, but not limited to, borate, N-containing salt such as, ammonium chloride, ammonium sulfate, ammonium nitrate etc., N-containing aliphatic compound, N-containing aromatic compound, or combinations thereof to make an aqueous solution comprising carbide lime wherein molar ratio of the weak base:carbide lime is between 2:1 to 4:1 or 2:1 to 3:1 or 3:1 to 4:1, or 2:1, or 3:1, or 4:1; b) contacting the aqueous solution comprising carbide lime with carbon dioxide from an industrial process; and c) subjecting the aqueous solution to one or more precipitation conditions to produce a precipitation material comprising stable or reactive vaterite.

In some embodiments, there is provided a method comprising a) purifying carbide lime by treatment with weak base such as, but not limited to, N-containing salt to make an aqueous solution comprising carbide lime wherein molar ratio of the N-containing salt:carbide lime is between 2:1 to 4:1 or 2:1 to 3:1 or 3:1 to 4:1, or 2:1, or 3:1, or 4:1; b) contacting the aqueous solution comprising carbide lime with carbon dioxide from an industrial process; and c) subjecting the aqueous solution to one or more precipitation conditions to produce a precipitation material comprising stable or reactive vaterite. Examples of N-containing salt include, but not limited to, ammonium chloride, ammonium nitrate, ammonium sulfate etc.

In some embodiments, there is provided a method comprising a) purifying carbide lime by treatment with weak base such as, but not limited to, N-containing aliphatic compound to make an aqueous solution comprising carbide lime wherein molar ratio of the N-containing aliphatic compound:carbide lime is between 2:1 to 4:1 or 2:1 to 3:1 or 3:1 to 4:1, or 2:1, or 3:1, or 4:1; b) contacting the aqueous solution comprising carbide lime with carbon dioxide from an industrial process; and c) subjecting the aqueous solution to one or more precipitation conditions to produce a precipitation material comprising stable or reactive vaterite.

The precipitation conditions include those that modulate the environment of the CO₂ charged precipitation reaction mixture to produce the desired precipitation material comprising stable or reactive vaterite. Such one or more precipitation conditions, that can be used in the foregoing method embodiments or the method embodiments described herein, suitable to form stable or reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc. In some embodiments, the average particle size of the stable or the reactive vaterite may also depend on the one or more precipitation conditions used in the precipitation of the carbonate precipitation material. In some embodiments, the percentage of the stable or the reactive vaterite in the carbonate precipitation material may also depend on the one or more precipitation conditions used in the precipitation process.

For example, the temperature of the CO₂-charged precipitation reaction mixture may be raised to a point at which an amount suitable for precipitation of the desired precipitation material occurs. In such embodiments, the temperature of the CO₂ charged precipitation reaction mixture may be raised to a value from 5° C. to 70° C., such as from 20° C. to 50° C., and including from 25° C. to 45° C. While a given set of precipitation conditions may have a temperature ranging from 0° C. to 100° C., the temperature may be raised in certain embodiments to produce the desired precipitation material. In certain embodiments, the temperature of the precipitation reaction mixture is raised using energy generated from low or zero carbon dioxide emission sources (e.g., solar energy source, wind energy source, hydroelectric energy source, waste heat from the flue gases of the carbon emitter, etc). In some embodiments, the temperature of the precipitation reaction mixture may be raised utilizing heat from flue gases from coal or other fuel combustion.

The pH of the CO₂-charged precipitation reaction mixture may also be raised to an amount suitable for precipitation of the desired precipitation material. In such embodiments, the pH of the CO₂-charged precipitation reaction mixture is raised to alkaline levels for precipitation, wherein carbonate is favored over bicarbonate. The pH may be raised to pH 9 or higher, such as pH 10 or higher, including pH 11 or higher. For example, when carbide lime is used to raise the pH of the precipitation reaction mixture or precursor of the precipitation reaction mixture, the pH may be about pH 12.5 or higher.

Adjusting major ion ratios during precipitation may influence the nature of the precipitation material. Major ion ratios may have considerable influence on polymorph formation. For example, as the magnesium:calcium ratio in the water increases, aragonite may become the major polymorph of calcium carbonate in the precipitation material over low-magnesium vaterite. At low magnesium:calcium ratios, low-magnesium calcite may become the major polymorph. In some embodiments, where Ca²⁺ and Mg²⁺ are both present, the ratio of Ca²⁺ to Mg²⁺ (i.e., Ca²⁺:Mg²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000. In some embodiments, the ratio of Mg²⁺ to Ca²⁺ (i.e., Mg²⁺:Ca²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000.

Precipitation rate may also have an effect on compound phase formation, with the most rapid precipitation rate achieved by seeding the solution with a desired phase. Without seeding, rapid precipitation may be achieved by rapidly increasing the pH of the precipitation reaction mixture, which may result in more amorphous constituents. The higher the pH, the more rapid is the precipitation, which may result in a more amorphous precipitation material.

Accordingly, a set of precipitation conditions to produce a desired precipitation material from a precipitation reaction mixture may include, as above, the temperature and pH, as well as, in some instances, the concentrations of additives and ionic species in the water. The additives have been described herein below. The presence of the additives and the concentration of the additives may also favor formation of stable or reactive vaterite. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare precipitation material according to the invention may be batch, semi-batch, or continuous protocols. The precipitation conditions may be different to produce a given precipitation material in a continuous flow system compared to a semi-batch or batch system.

The precipitation material, following production from a precipitation reaction mixture, is separated from the reaction mixture to produce separated precipitation material (e.g., wet cake) and a supernatant as illustrated in the figures. In the systems of the invention, the separation step may be carried out on the separation station. The precipitation material may be stored in the supernatant for a period of time following precipitation and prior to separation (e.g., by drying). For example, the precipitation material may be stored in the supernatant for a period of time ranging from few min to hours to 1 to 1000 days or longer, such as 1 to 10 days or longer, at a temperature ranging from 1° C. to 40° C., such as 20° C. to 25° C. Separation of the precipitation material from the precipitation reaction mixture is achieved using any of a number of convenient approaches, including draining (e.g., gravitational sedimentation of the precipitation material followed by draining), decanting, filtering (e.g., gravity filtration, vacuum filtration, filtration using forced air), centrifuging, pressing, or any combination thereof. Separation of bulk water from the precipitation material produces a wet cake of precipitation material, or a dewatered precipitation material. Some examples of the separation are described in U.S. patent application Ser. No. 13/409,856, filed Mar. 1, 2012, which is herein incorporate by reference. Liquid-solid separator such as Epuramat's Extrem-Separator (“ExSep”) liquid-solid separator, Xerox PARC's spiral concentrator, or a modification of either of Epuramat's ExSep or Xerox PARC's spiral concentrator, may be useful for the separation of the precipitation material from the precipitation reaction mixture.

In some embodiments, the resultant dewatered precipitation material such as the wet cake material is directly used to make the products described herein (e.g. FIG. 4). For example, the wet cake of the dewatered precipitation material is mixed with one or more additives, described herein, and is spread out on the conveyer belt where the reactive vaterite in the precipitation material transforms to aragonite and sets and hardens. The hardened material is then cut into desired shapes such as boards or panels described herein. In some embodiments, the wet cake is poured onto a sheet of paper on top of the conveyer belt. Another sheet of paper may be put on top of the wet cake which is then pressed to remove excess water. After the setting and hardening of the precipitation material (vaterite transformation to aragonite), the material is cut into desired shapes, such as, cement siding boards and drywall etc. In some embodiments, the amount of the one or more additives may be optimized depending on the desired time required for the transformation of the vaterite to aragonite (described below). For example, for some applications, it may be desired that the material transform rapidly and in certain other instance, a slow transformation may be desired. In some embodiments, the wet cake may be heated on the conveyer belt to hasten the transformation of the vaterite to aragonite. In some embodiments, the wet cake may be poured in the molds of desired shape and the molds are then heated in the autoclave to hasten the transformation of the vaterite to aragonite. Accordingly, the continuous flow process, batch process or semi-batch process, all are well within the scope of the invention.

In some embodiments, the drywall product or the cement board product of the invention is made by any process well known in the board industry, such as, but not limited to, wet process, semi dry process, extrusion process, Wonderboard® process etc. The wet process may be the process in which the water/binder or the precipitation material >0.8 and the semi dry process may be the process in which the water/binder <0.8 or is ˜0.4. In some embodiments, in the wet process, a slurry of the precipitation material may be mixed with the additives and the admixtures or a slurry of the precipitation material may be prepared using the wet cake of the precipitation material with the additives and the admixtures and may be subjected to film forming and dewatering (e.g. using the Hantschek machine). The films of the material may then be stacked. The stacked material may be then cut into boards and dried (from ˜25% to 1% moisture content). In some embodiments, in the semi dry process, a dry powder or the stucco of the precipitation material may be mixed with the wetted additives and the admixtures (including fibers such as, but not limited to, shredded paper) and may be layered on the conveyer belt. The water may be sprayed on the material. The material may be then pressed on the continuous belt. The material may be then cut into boards and dried. The drying methods may be any method described herein or is well known in the art such as, autoclave, jet dryer, etc. The additives added during the process facilitate transformation of the reactive vaterite to the aragonite and the admixtures provide various strength and other related properties. The additives and the admixtures have been described herein. The board may be finished by sanding, coating (e.g. silicon emulsion, hydrophobes, etc.), and the like.

An example of the wet process is Hatschek process or the sieve cylinder process. In some embodiments, the drywall or the cement board product of the invention is made using the Hatschek process. Such process is well known in the art. In some embodiments, the precipitation material (slurry, wet cake or the dried form) is blended with other additives and/or admixtures and is delivered to the Hatschek machine as a dilute slurry. The slurry may be then supplied to holding tanks or vats which may have a number of rotating screen cylinders/sieve cylinders. These cylinders may pick up the wet solid material removing some of the water in the operation. An endless felt band may travel over the top surface of the cylinders and pick up a thin film at each cylinder forming a green lamina. The built up laminated ply may travel over vacuum dewatering devices and subsequently wrap around an accumulation roll or formation cylinder building additional thickness until the desired mat thickness is obtained. High intensity dewatering may be done at the nip of the roller. The pressure rolls in contact with the accumulation roll may again increase dewatering efficiency. Once the desired sheet thickness is obtained, an automatic cutting knife built into the accumulation roll may be activated and the green sheet may be dropped onto a conveyer, may be cut and conformed as a corrugated sheet or flat panel. Once green sheets are produced, they may be stacked and sent to the stacking press. The steam and autoclave cured sheets may be sent to a hardening chamber involving heat and humidity. Steam curing conditions may be 70° C. and autoclave curing conditions may be 180-185° C., 8-12 bars up to 16 hours. In some processes, it may include primary cutting in steam tunnels to accelerate curing. At this stage, these boards may be ready for priming and finishing (e.g. coating) and final cutting (e.g. edge treatment).

In some embodiments, the drywall or the cement board product of the invention is made using the extrusion process. In some embodiments, the drywall or the cement board product of the invention is made using the Wonderboard® process. In the extrusion process, the kneaded precipitation material may enter a screw conveyer passing through a vacuum pump, and may be deposited onto the moving conveyer belt. Embossing rolls may then impart the desired patterns onto the sheet which subsequently may be processed similar to the Hatschek process.

In some embodiments, the precipitation material, once separated from the precipitation reaction mixture, is washed with fresh water, then placed into a filter press to produce a filter cake with 30-60% solids. This filter cake is then mechanically pressed in a mold, using any convenient means, e.g., a hydraulic press, at adequate pressures, e.g., ranging from 5 to 5000 psi, such as 1000 to 5000 psi, to produce a formed solid, e.g., a rectangular brick. These resultant solids are then cured, e.g., by placing outside and storing, by placing in a chamber wherein they are subjected to high levels of humidity and heat, etc. These resultant cured solids are then used as building materials themselves or crushed to produce aggregate. Methods of producing such aggregate are further described in U.S. patent application Ser. No. 12/475,378, filed 29 May 2009, the disclosure of which is herein incorporated by reference.

In processes involving the use of temperature and pressure, the dewatered water precipitate cake may be dried. The cake is then exposed to a combination of rewatering, and elevated temperature and/or pressure for a certain time. The combination of the amount of water added back, the temperature, the pressure, and the time of exposure, as well as the thickness of the cake, can be varied according to composition of the starting material and the desired results.

A number of different ways of exposing the material to temperature and pressure are described herein; it will be appreciated that any convenient method may be used. An exemplary drying protocol is exposure to 40° C. for 24-48 hours, but greater or lesser temperatures and times may be used as convenient, e.g., 20-60° C. for 3-96 hours or even longer. Water is added back to the desired percentage, e.g., to 1%-50%, e.g., 1% to 10%, such as 1, 2, 3, 4, 5, 6, 7, 8, 9, or 10% w/w, such as 5% w/w, or 4-6% w/w, or 3-7% w/w. Thickness and size of the cake may be adjusted as desired; the thickness can vary in some embodiment from 0.05 inch to 5 inches, e.g. 0.1-2 inches, or 0.3-1 inch. In some embodiments the cake may be 0.5 inch to 6 feet or even thicker. The cake is then exposed to elevated temperature and/or pressure for a given time, by any convenient method, for example, in a platen press using heated platens. The heat to elevate the temperature, e.g., for the platens, may be provided, e.g., by heat from an industrial waste gas stream such as a flue gas stream. The temperature may be any suitable temperature; in general, for a thicker cake a higher temperature is desired; examples of temperature ranges are 40-150° C., e.g., 60-120° C., such as 70-110° C., or 80-100° C. Similarly, the pressure may be any suitable pressure to produce the desired results; exemplary pressures include 1000-100,000 pounds per square inch (psi), including 2000-50,000 psi, or 2000-25,000 psi, or 2000-20,000 psi, or 3000-5000 psi. Finally, the time that the cake is pressed may be any suitable time, e.g., 1-100 seconds, or 1-100 minute, or 1-50 minutes, or 2-25 minutes, or 1-10,000 days. The resultant hard tablet may optionally then cured, e.g., by placing outside and storing, by placing in a chamber wherein they are subjected to high levels of humidity and heat, etc. These hard tablets, optionally cured, are then used as building materials themselves or crushed to produce aggregate.

Another method of providing temperature and pressure is the use of a press, as described more fully in U.S. patent application Ser. No. 12/475,378, filed 29 May 2009. A suitable press, e.g., a platen press, may be used to provide pressure at the desired temperature (using heat supplied, e.g., by a flue gas or by other steps of the process to produce a precipitate, e.g., from an electrochemical process) for a desired time. A set of rollers may be used in similar fashion.

Another way to expose the cake to elevated temperature and pressure is by means of an extruder, e.g., a screw-type extruder, also described further in U.S. patent application Ser. No. 12/475,378, filed 29 May 2009. The barrel of the extruder can be outfitted to achieve an elevated temperature, e.g., by jacketing; this elevated temperature can be supplied by, e.g., flue gases or the like. Extrusion may be used as a means of pre-heating and drying the feedstock prior to a pressing operation. Such pressing can be performed by means of a compression mold, via rollers, via rollers with shaped indentations (which can provide virtually any shape of aggregate desired), between a belt which provides compression as it travels, or any other convenient method. Alternatively, the extruder may be used to extrude material through a die, exposing the material to pressure as it is forced through the die, and giving any desired shape. In some embodiments, the carbonate precipitate is mixed with fresh water and then placed into the feed section of a rotating screw extruder. The extruder and/or the exit die may be heated to further assist in the process. The turning of the screw conveys the material along its length and compresses it as the flite depth of the screw decreases. The screw and barrel of the extruder may further include vents in the barrel with decompression zones in the screw coincident with the barrel vent openings. Particularly in the case of a heated extruder, these vented areas allow for the release of steam from the conveyed mass, removing water from the material.

The screw conveyed material is then forced through a die section which further compresses the material and shapes it. Typical openings in the die can be circular, oval, square, rectangular, trapezoidal, etc., although any shape which the final aggregate is desired in could be made by adjusting the shape of the opening. The material exiting the die may be cut to any convenient length by any convenient method, such as by a fly knife. A typical length can be from 0.05 inches to 6 inches, although lengths outside those ranges are possible. Typical diameters can be 0.05 inches to 1.0 inches, though diameters outside of these ranges are possible.

Use of a heated die section may further assist in the formation of the product by accelerating the transition of the carbonate mineral to a hard, stable form. Heated dies may also be used in the case of binders to harden or set the binder. Temperatures of 100° C. to 600° C. are commonly used in the heated die section. Heat for the heated die may come in whole or in part from the flue gas or other industrial gas used in the process of producing the precipitate, where the flue gas is first routed to the die to transfer heat from the hot flue gas to the die.

In yet other embodiments, the precipitate may be employed for in situ or form-in-place structure fabrication. For example, roads, paved areas, or other structures may be fabricated from the precipitate by applying a layer of precipitate, e.g., as described above, to a substrate, e.g., ground, roadbed, etc., and then hydrating the precipitate, e.g., by allowing it to be exposed to naturally applied water, such as in the form of rain, or by irrigation. Hydration solidifies the precipitate into a desired in situ or form-in-place structure, e.g., road, paved over area, etc. The process may be repeated, e.g., where thicker layers of in-situ formed structures are desired.

In some embodiments, the production of the precipitation material and the products is carried out in the same facility. In some embodiments, the precipitation material is produced in one facility and is transported to another facility to make the end product. The precipitation material may be transported in the slurry form, wet cake form, or dry powder form.

In some embodiments, the resultant dewatered precipitation material obtained from the separation station is dried at the drying station to produce a powder form of the carbonate precipitation material comprising stable or reactive vaterite. Drying may be achieved by air-drying the precipitation material. In certain embodiments, drying is achieved by freeze-drying (i.e., lyophilization), wherein the precipitation material is frozen, the surrounding pressure is reduced, and enough heat is added to allow the frozen water in the precipitation material to sublime directly into gas. In yet another embodiment, the precipitation material is spray-dried to dry the precipitation material, wherein the liquid containing the precipitation material is dried by feeding it through a hot gas (such as the gaseous waste stream from the power plant), and wherein the liquid feed is pumped through an atomizer into a main drying chamber and a hot gas is passed as a co-current or counter-current to the atomizer direction. Depending on the particular drying protocol of the system, the drying station may include a filtration element, freeze-drying structure, spray-drying structure, etc. In some embodiments, the precipitate may be dried by fluid bed dryer. In certain embodiments, waste heat from a power plant or similar operation may be used to perform the drying step when appropriate. For example, in some embodiments, dry product is produced by the use of elevated temperature (e.g., from power plant waste heat), pressure, or a combination thereof.

Following separation of the precipitation material from the supernatant, the separated precipitation material may be further processed as desired; however, the precipitation material may simply be transported to a location for long-term storage, effectively sequestering CO₂. For example, the precipitation material may be transported and placed at long-term storage site, for example, above ground (as a storage-stable CO₂-sequestering material), below ground, in the deep ocean, etc.

The resultant supernatant of the precipitation process, or a slurry of precipitation material may also be processed as desired. For example, the supernatant or slurry may be returned to the carbide lime-containing aqueous solution (e.g. see FIG. 4), or to another location. In some embodiments, the supernatant may be contacted with a source of CO₂, as described above, to sequester additional CO₂. For example, in embodiments in which the supernatant is to be returned to the precipitation reactor, the supernatant may be contacted with a gaseous waste source of CO₂ in a manner sufficient to increase the concentration of carbonate ion present in the supernatant. As described above, contact may be conducted using any convenient protocol. In some embodiments, the supernatant has an alkaline pH, and contact with the CO₂ source is carried out in a manner sufficient to reduce the pH to a range between pH 5 and 9, pH 6 and 8.5, or pH 7.5 to 8.2.

In some embodiments, the composition of the invention containing precipitation material are in a storage-stable form (which may simply be dried precipitation material) may be stored above ground under exposed conditions (i.e., open to the atmosphere) without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer. As the storage-stable form of the precipitation material undergoes little if any degradation, the amount of degradation if any as measured in terms of CO₂ gas release from the product may not exceed 5%/year, and in certain embodiments will not exceed 1%/year. The aboveground storage-stable forms of the precipitation material are stable under a variety of different environment conditions, e.g., from temperatures ranging from −100° C. to 600° C. and humidity ranging from 0 to 100% where the conditions may be calm, windy or stormy. For example, in some embodiments, the precipitation material produced by methods of the invention is employed as a building material (e.g., a construction material for some type of man-made structure such as buildings, roads, bridges, dams, and the like), such that CO₂ is effectively sequestered in the built environment. Any man made structure, such as foundations, parking structures, houses, office buildings, commercial offices, governmental buildings, infrastructures (e.g., pavements; roads; bridges; overpasses; walls; footings for gates, fences and poles; and the like) is considered a part of the built environment. Mortars of the invention find use in binding construction blocks (e.g., bricks) together and filling gaps between construction blocks. Mortars can also be used to fix existing structure (e.g., to replace sections where the original mortar has become compromised or eroded), among other uses.

In certain embodiments, the composition is employed as a component of a cement, which sets and hardens after combining with water. Such carbonate compound hydraulic cements, methods for their manufacture, and use are described in U.S. patent application Ser. No. 12/126,776 titled “Hydraulic Cements Comprising Carbonate Compounds Compositions” and filed on May 23, 2008; the disclosure of which application is herein incorporated by reference.

In some embodiments, an aggregate is produced from the resultant precipitation material. In such embodiments, where the drying process produces particles of the desired size, little if any additional processing is required to produce the aggregate. In yet other embodiments, further processing of the precipitation material is performed in order to produce the desired aggregate. For example, the precipitation material may be combined with fresh water in a manner sufficient to cause the precipitate to form a solid product, where the metastable carbonate compounds such as vaterite and ACC present in the precipitate convert to aragonite. By controlling the water content of the wet material, the porosity, and eventual strength and density of the final aggregate may be controlled. Typically a wet cake may be 40-60 volume % water. For denser aggregates, the wet cake may be <50% water, for less dense cakes, the wet cake may be >50% water. After hardening, the resultant solid product may then be mechanically processed, e.g., crushed or otherwise broken up and sorted to produce aggregate of the desired characteristics, e.g., size, particular shape, etc. In these processes the setting and mechanical processing steps may be performed in a substantially continuous fashion or at separate times. In certain embodiments, large volumes of precipitate may be stored in the open environment where the precipitate is exposed to the atmosphere. For the setting step, the precipitate may be irrigated in a convenient fashion with fresh water, or allowed to be rained on naturally in order to produce the set product. The set product may then be mechanically processed as described above. Following production of the precipitate, the precipitate is processed to produce the desired aggregate. In some embodiment the precipitate may be left outdoors, where rainwater can be used as the freshwater source, to cause the meteoric water stabilization reaction to occur, hardening the precipitate to form aggregate.

In an example of one embodiment of the invention, the precipitate is mechanically spread in a uniform manner using a belt conveyor and highway grader onto a compacted earth surface to a depth of interest, e.g., up to twelve inches, such as 1 to 12 inches, including 6 to 12 inches. The spread material is then irrigated with fresh water at a convenient rate, e.g., of one/half gallon of water per cubic foot of precipitate. The material is then compacted using multiple passes with a steel roller, such as those used in compacting asphalt. The surface is re-irrigated on a weekly basis until the material exhibits the desired chemical and mechanical properties, at which point the material is mechanically processed into aggregate by crushing.

### Vaterite Containing Precipitate

The “compositions,” “precipitation material,” “carbonate precipitation material,” “carbonate containing precipitation material,” and “carbonate containing compositions” are used interchangeably herein. The carbonate precipitation material formed in the methods and systems of the invention comprises vaterite. The stable vaterite includes vaterite that does not transform to aragonite or calcite during and/or after dissolution-re-precipitation process. The reactive vaterite or activated vaterite includes vaterite that results in aragonite formation during and/or after dissolution-re-precipitation process. In some embodiments, the methods described herein fruther include contacting the precipitation material (in dried or wet form) with water and transforming the reactive vaterite to aragonite. In some embodiments, the stable vaterite when contacted with water does not transform to aragonite and stays either in the vaterite form or transforms over a long period of time to calcite.

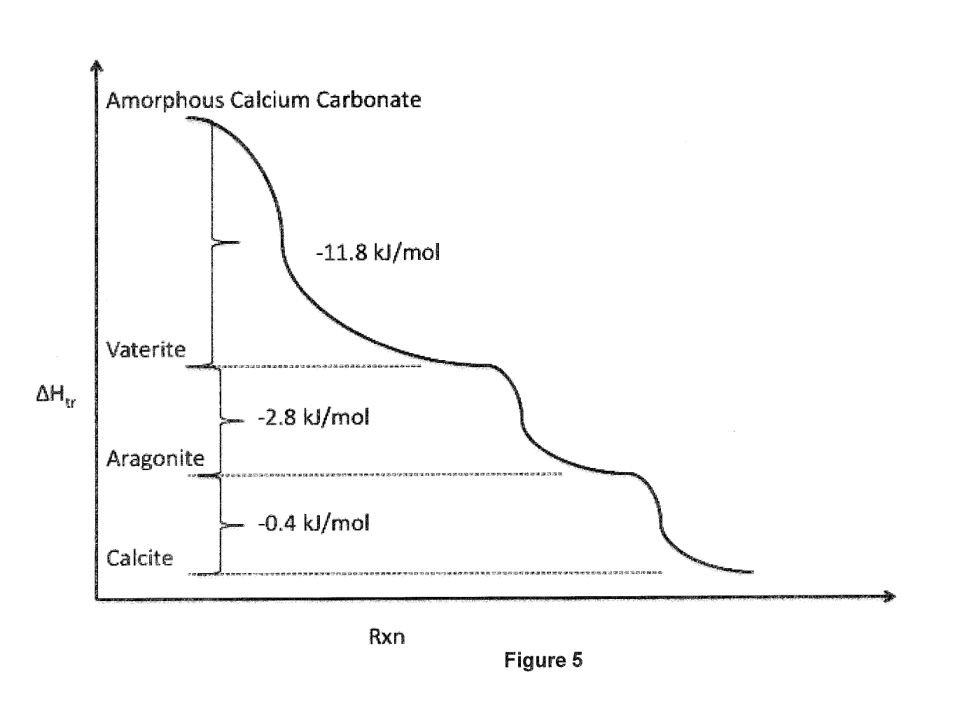

Typically, upon precipitation of calcium carbonate, amorphous calcium carbonate (ACC) may initially precipitate and transform into one or more of its three more stable phases (vaterite, aragonite, or calcite). A thermodynamic driving force may exist for the transformation from unstable phases to more stable phases, as described by Ostwald in his Step Rule (Ostwald, W. Zeitschrift fur Physikalische Chemie 289 (1897)). For this reason, calcium carbonate phases transform in the order: ACC to vaterite, aragonite, and calcite where intermediate phases may or may not be present. During this transformation, excesses of energy are released, as exhibited by FIG. 5. This intrinsic energy may be harnessed to create a strong aggregation tendency and surface interactions that may lead to agglomeration and setting or cementing. It is to be understood that the values reported in FIG. 5 are well known in the art and may vary.

Applicants have been surprisingly and unexpectedly able to produce or isolate the precipitation material in the vaterite form. The precipitation material may be in a wet form or a dry powder form. This precipitation material may have a stable vaterite form that does not transform readily to any other polymorph or may have a reactive vaterite form that transforms to aragonite form. The aragonite form does not convert further to more stable calcite form. The product containing the aragonite form of the precipitate shows one or more unexpected properties, including but not limited to, high compressive strength, high porosity (low density or light weight), neutral pH (useful as artificial reef described below), microstructure network, etc.

Other minor polymorph forms of calcium carbonate that may be present in the carbonate containing precipitation material include, but not limited to, amorphous calcium carbonate, aragonite, calcite, a precursor phase of vaterite, a precursor phase of aragonite, an intermediary phase that is less stable than calcite, polymorphic forms in between these polymorphs or combination thereof.

Vaterite may be present in monodisperse or agglomerated form, and may be in spherical, ellipsoidal, plate like shape, or hexagonal system. Vaterite typically has a hexagonal crystal structure and forms polycrystalline spherical particles upon growth. The precursor form of vaterite comprises nanoclusters of vaterite and the precursor form of aragonite comprises sub-micron to nanoclusters of aragonite needles. Aragonite, if present in the composition along with vaterite, may be needle shaped, columnar, or crystals of the rhombic system. Calcite, if present in the composition along with vaterite, may be cubic, spindle, or crystals of hexagonal system. An intermediary phase that is less stable than calcite may be a phase that is between vaterite and calcite, a phase between precursor of vaterite and calcite, a phase between aragonite and calcite, and/or a phase between precursor of aragonite and calcite.

In some embodiments, the compositions of the invention are synthetic compositions and are not naturally occurring. In some embodiments, the composition of the invention is in a powder form. In some embodiments, the composition of the invention is in a dry powder form. In some embodiments, the composition of the invention is disordered or is not in an ordered array or is in the powdered form. In still some embodiments, the composition of the invention is in a partially or wholly hydrated form. In still some embodiments, the composition of the invention is in saltwater or fresh water. In still some embodiments, the composition of the invention is in water containing sodium chloride. In still some embodiments, the composition of the invention is in water containing alkaline earth metal ions, such as, but are not limited to, calcium, magnesium, etc. In some embodiments, the compositions of the invention are non-medical or are not for medical procedures.

The products made from the compositions provided herein show one or more properties, such as, high compressive strength, high durability, high porosity (light weight), high flexural strength, and less maintenance costs. In some embodiments, the compositions upon combination with water, setting, and hardening, have a compressive strength of at least 3 MPa (megapascal), or at least 7 MPa, or at least 10 MPa or in some embodiments, between 3-30 MPa, or between 14-80 MPa or 14-35 MPa.

In some embodiments of the foregoing aspects and embodiments, the composition includes at least 10% w/w vaterite; or at least 20% w/w vaterite; or at least 30% w/w vaterite; or at least 40% w/w vaterite; or at least 50% w/w vaterite; or at least 60% w/w vaterite; or at least 70% w/w vaterite; or at least 80% w/w vaterite; or at least 90% w/w vaterite; or at least 95% w/w vaterite; or at least 99% w/w vaterite; or from 10% w/w to 99% w/w vaterite; or from 10% w/w to 90% w/w vaterite; or from 10% w/w to 80% w/w vaterite; or from 10% w/w to 70% w/w vaterite; or from 10% w/w to 60% w/w vaterite; or from 10% w/w to 50% w/w vaterite; or from 10% w/w to 40% w/w vaterite; or from 10% w/w to 30% w/w vaterite; or from 10% w/w to 20% w/w vaterite; or from 20% w/w to 99% w/w vaterite; or from 20% w/w to 95% w/w vaterite; or from 20% w/w to 90% w/w vaterite; or from 20% w/w to 75% w/w vaterite; or from 20% w/w to 50% w/w vaterite; or from 30% w/w to 99% w/w vaterite; or from 30% w/w to 95% w/w vaterite; or from 30% w/w to 90% w/w vaterite; or from 30% w/w to 75% w/w vaterite; or from 30% w/w to 50% w/w vaterite; or from 40% w/w to 99% w/w vaterite; or from 40% w/w to 95% w/w vaterite; or from 40% w/w to 90% w/w vaterite; or from 40% w/w to 75% w/w vaterite; or from 50% w/w to 99% w/w vaterite; or from 50% w/w to 95% w/w vaterite; or from 50% w/w to 90% w/w vaterite; or from 50% w/w to 75% w/w vaterite; or from 60% w/w to 99% w/w vaterite; or from 60% w/w to 95% w/w vaterite; or from 60% w/w to 90% w/w vaterite; or from 70% w/w to 99% w/w vaterite; or from 70% w/w to 95% w/w vaterite; or from 70% w/w to 90% w/w vaterite; or from 80% w/w to 99% w/w vaterite; or from 80% w/w to 95% w/w vaterite; or from 80% w/w to 90% w/w vaterite; or from 90% w/w to 99% w/w vaterite; or 10% w/w vaterite; or 20% w/w vaterite; or 30% w/w vaterite; or 40% w/w vaterite; or 50% w/w vaterite; or 60% w/w vaterite; or 70% w/w vaterite; or 75% w/w vaterite; or 80% w/w vaterite; or 85% w/w vaterite; or 90% w/w vaterite; or 95% w/w vaterite; or 99% w/w vaterite. The vatreite may be stable vaterite or reactive vaterite.

In some embodiments, there is provided a method of a) contacting an aqueous solution comprising carbide lime with carbon dioxide from an industrial process; and b) producing a precipitation material comprising at least 50% w/w, or at least 75% w/w, or at least 90% w/w, or at least 95% w/w, or at least 99% w/w, or between 50-99% w/w, or between 75-99% w/w, stable or reactive vaterite. In some embodiments, there is provided a method of contacting an aqueous solution comprising carbide lime with carbon dioxide from an industrial process; and producing a precipitation material comprising at least 50% w/w, or at least 75% w/w, or at least 90% w/w, or at least 95% w/w, or at least 99% w/w, or between 50-99% w/w, or between 75-99% w/w, stable vaterite. In some embodiments, there is provided a method of contacting an aqueous solution comprising carbide lime with carbon dioxide from an industrial process; and producing a precipitation material comprising at least 50% w/w, or at least 75% w/w, or at least 90% w/w, or at least 95% w/w, or at least 99% w/w, or between 50-99% w/w, or between 75-99% w/w, reactive vaterite.

In some embodiments, in the foregoing methods, the step a) is conducted under precipitation conditions that favor the formation of stable or reactive vaterite. Such precipitation conditions, that can be used in the foregoing method embodiments or the method embodiments described herein, suitable to form stable or reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc.

In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, stable or reactive vaterite. In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, stable vaterite. In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite.

In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, stable or reactive vaterite. In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, stable vaterite. In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite. In some embodiments, there is provided a method comprising a) purifying carbide lime by treatment with ammonium chloride to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite. In some embodiments, the method further includes subjecting the aqueous solution to precipitation conditions at step b) to produce the precipitation material comprising stable or reactive vaterite. Such precipitation conditions suitable to form stable or reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc. In some embodiments, the N-containing salt includes, but not limited to, ammonium chloride, ammonium sulfate, ammonium nitrate, and the like.

In some embodiments, in the above recited methods the molar ratio of the weak base selected from borate, N-containing salt, such as ammonium chloride, N-containing aliphatic compound, such as, glycine, N-containing aromatic compound, or combination thereof:carbide lime is between 2:1 to 4:1 or 2:1 to 3:1 or 3:1 to 4:1, or 2:1, or 3:1, or 4:1.

In some embodiments, there is provided a method comprising a) purifying carbide lime by treatment with ammonium chloride to make an aqueous solution comprising carbide lime wherein molar ratio of the ammonium chloride:carbide lime is between 2:1 to 4:1 or 2:1 to 3:1 or 3:1 to 4:1, or 2:1, or 3:1, or 4:1; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite. In some embodiments, the method further includes subjecting the aqueous solution to precipitation conditions at step b) to produce the precipitation material comprising stable or reactive vaterite. Such precipitation conditions suitable to form stable or reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc.

In some embodiments of the foregoing aspects and the foregoing embodiments, the precipitation material comprising vaterite after combination with water, setting, and hardening (i.e. transformation to aragonite) or the stable vaterite mixed with cement and water and after setting and hardening, has a compressive strength of at least 3 MPa; at least 7 MPa; at least 14 MPa; or at least 16 MPa; or at least 18 MPa; or at least 20 MPa; or at least 25 MPa; or at least 30 MPa; or at least 35 MPa; or at least 40 MPa; or at least 45 MPa; or at least 50 MPa; or at least 55 MPa; or at least 60 MPa; or at least 65 MPa; or at least 70 MPa; or at least 75 MPa; or at least 80 MPa; or at least 85 MPa; or at least 90 MPa; or at least 95 MPa; or at least 100 MPa; or from 3-50 MPa; or from 3-25 MPa; or from 3-15 MPa; or from 3-10 MPa; or from 14-25 MPa; or from 14-100 MPa; or from 14-80 MPa; or from 14-75 MPa; or from 14-50 MPa; or from 14-25 MPa; or from 17-35 MPa; or from 17-25 MPa; or from 20-100 MPa; or from 20-75 MPa; or from 20-50 MPa; or from 20-40 MPa; or from 30-90 MPa; or from 30-75 MPa; or from 30-60 MPa; or from 40-90 MPa; or from 40-75 MPa; or from 50-90 MPa; or from 50-75 MPa; or from 60-90 MPa; or from 60-75 MPa; or from 70-90 MPa; or from 70-80 MPa; or from 70-75 MPa; or from 80-100 MPa; or from 90-100 MPa; or from 90-95 MPa; or 14 MPa; or 3 MPa; or 7 MPa; or 16 MPa; or 18 MPa; or 20 MPa; or 25 MPa; or 30 MPa; or 35 MPa; or 40 MPa; or 45 MPa. For example, in some embodiments of the foregoing aspects and the foregoing embodiments, the composition after setting, and hardening has a compressive strength of 3 MPa to 25 MPa; or 14 MPa to 40 MPa; or 17 MPa to 40 MPa; or 20 MPa to 40 MPa; or 30 MPa to 40 MPa; or 35 MPa to 40 MPa. In some embodiments, the compressive strengths described herein are the compressive strengths after 1 day, or 3 days, or 7 days, or 28 days, or 56 days, or longer.

The calcium carbonate in the compositions of the invention may contain carbon dioxide from any number of sources including, but not limited to, an industrial waste stream including flue gas from combustion; a flue gas from a chemical processing plant; a flue gas from a plant that produces CO₂ as a byproduct; or combination thereof. In some embodiments, the carbon dioxide sequestered into the calcium carbonate in the compositions of the invention, originates from the burning of fossil fuel, and thus some (e.g., at least 10, 50, 60, 70, 80, 90, 95%) or substantially all (e.g., at least 99, 99.5, or 99.9%) of the carbon in the carbonates is of fossil fuel origin, i.e., of plant origin.

Typically, carbon of plant origin has a different ratio of stable isotopes (¹³C and ¹²C) than carbon of inorganic origin. The plants from which fossil fuels are derived preferentially utilize ¹²C over ¹³C, thus fractionating the carbon isotopes so that the value of their ratio differs from that in the atmosphere in general. This value, when compared to a standard value (PeeDee Belemnite, or PDB, standard), is termed the carbon isotopic fractionation (δ¹³C) value. Typically, δ¹³C values for coal are in the range −30 to −20%; δ¹³C values for methane may be as low as −20% to −40% or even −40% to −80%; δ¹³C values for atmospheric CO₂ are −10% to −7%; for limestone +3% to −3%; and for marine bicarbonate, 0%.

In some embodiments, the carbon in the vaterite and/or other polymorphs in the composition of the invention, has a δ¹³C of less than −12%, −13%, −14%, −15%, −20%, or less than −25%, or less than −30%, or less than −35%, or less than −45%, or less than −50%, as described in further detail herein. In some embodiments, the composition of the invention includes a CO₂-sequestering additive including carbonates, such as, vaterite, bicarbonates, or a combination thereof, in which the carbonates, bicarbonates, or a combination thereof have a carbon isotopic fractionation (δ¹³C) value less than −12%.

The relative carbon isotope composition (δ¹³C) value with units of % (per mille) is a measure of the ratio of the concentration of two stable isotopes of carbon, namely ¹²C and ¹³C, relative to a standard of fossilized belemnite (the PDB standard).

δ¹³C %=[(¹³C/¹²Cₛₐₘₚₗₑ−¹³C/¹²C_{PDB standard})/(¹³C/¹²C_{PDB standard})]×1000

¹² is preferentially taken up by plants during photosynthesis and in other biological processes that use inorganic carbon because of its lower mass. The lower mass of ¹²C allows for kinetically limited reactions to proceed more efficiently than with ¹³C. Thus, materials that are derived from plant material, e.g., fossil fuels, have relative carbon isotope composition values that are less than those derived from inorganic sources. The carbon dioxide in flue gas produced from burning fossil fuels reflects the relative carbon isotope composition values of the organic material that was fossilized.

Material incorporating carbon from fossil fuels reflects δ¹³C values that are like those of plant derived material, i.e. less than that which incorporates carbon from atmospheric or non-plant marine sources. The δ¹³C value of the material produced by the carbon dioxide from the burning fossil fuels can be verified by measuring the δ¹³C value of the material and confirming that it is not similar to the values for atmospheric carbon dioxide or marine sources of carbon.

In some embodiments, the invention provides a method of characterizing the composition of the invention by measuring its δ¹³C value. Any suitable method may be used for measuring the δ¹³C value, such as mass spectrometry or off-axis integrated-cavity output spectroscopy (off-axis ICOS). Any mass-discerning technique sensitive enough to measure the amounts of carbon, can be used to find ratios of the ¹³C to ¹²C isotope concentrations. The δ¹³C values can be measured by the differences in the energies in the carbon-oxygen double bonds made by the ¹²C and ¹³C isotopes in carbon dioxide. The δ¹³C value of a carbonate may serve as a fingerprint for a CO₂ gas source, as the value can vary from source to source. In some embodiments, the amount of carbon in the vaterite and/or polymorphs in the compositions of the invention, may be determined any suitable technique known in the art. Such techniques include, but are not limited to, coulometry.

In some embodiments of the foregoing aspects and the foregoing embodiments, the composition has a δ¹³C of less than −12%; or less than −13%; or less than −14%; or less than −15%; or less than −16%; or less than −17%; or less than −18%; or less than −19%; or less than −20%; or less than −21%; or less than −22%; or less than −25%; or less than −30%; or less than −40%; or less than −50%; or less than −60%; or less than −70%; or less than −80%; or less than −90%; or less than −100%; or from −12% to −80%; or from −12% to −70%; or from −12% to −60%; or from −12% to −50%; or from −12% to −45%; or from −12% to −40%; or from −12% to −35%; or from −12% to −30%; or from −12% to −25%; or from −12% to −20%; or from −12% to −15%; or from −13% to −80%; or from −13% to −70%; or from −13% to −60%; or from −13% to −50%; or from −13% to −45%; or from −13% to −40%; or from −13% to −35%; or from −13% to −30%; or from −13% to −25%; or from −13% to −20%; or from −13% to −15%; from −14% to −80%; or from −14% to −70%; or from −14% to −60%; or from −14% to −50%; or from −14% to −45%; or from −14% to −40%; or from −14% to −35%; or from −14% to −30%; or from −14% to −25%; or from −14% to −20%; or from −14% to −15%; or from −15% to −80%; or from −15% to −70%; or from −15% to −60%; or from −15% to −50%; or from −15% to −45%; or from −15% to −40%; or from −15% to −35%; or from −15% to −30%; or from −15% to −25%; or from −15% to −20%; or from −16% to −80%; or from −16% to −70%; or from −16% to −60%; or from −16% to −50%; or from −16% to −45%; or from −16% to −40%; or from −16% to −35%; or from −16% to −30%; or from −16% to −25%; or from −16% to −20%; or from −20% to −80%; or from −20% to −70%; or from −20% to −60%; or from −20% to −50%; or from −20% to −40%; or from −20% to −35%; or from −20% to −30%; or from −20% to −25%; or from −30% to −80%; or from −30% to −70%; or from −30% to −60%; or from −30% to −50%; or from −30% to −40%; or from −40% to −80%; or from −40% to −70%; or from −40% to −60%; or from −40% to −50%; or from −50% to −80%; or from −50% to −70%; or from −50% to −60%; or from −60% to −80%; or from −60% to −70%; or from −70% to −80%; or −12%; or −13%; or −14%; or −15%; or −16%; or −17%; or −18%; or −19%; or −20%; or −21%; or −22%; or −25%; or −30%; or −40%; or −50%; or −60%; or −70%; or −80%; or −90%; or −100%.

In some embodiments, the precipitation material comprising vaterite is a particulate composition with an average particle size of 0.1-100 microns. The average particle size (or average particle diameter) may be determined using any conventional particle size determination method, such as, but not limited to, multi-detector laser scattering or laser diffraction or sieving. In certain embodiments, unimodel or multimodal, e.g., bimodal or other, distributions are present. Bimodal distributions may allow the surface area to be minimized, thus allowing a lower liquids/solids mass ratio when composition is mixed with water yet providing smaller reactive particles for early reaction. In some embodiments, the composition provided herein is a particulate composition with an average particle size of 0.1-1000 microns; or 0.1-500 microns; or 0.1-100 microns; or 0.1-50 microns; or 0.1-20 microns; or 0.1-10 microns; or 0.1-5 microns; or 1-50 microns; or 1-25 microns; or 1-20 microns; or 1-10 microns; or 1-5 microns; or 5-70 microns; or 5-50 microns; or 5-20 microns; or 5-10 microns; or 10-100 microns; or 10-50 microns; or 10-20 microns; or 10-15 microns; or 15-50 microns; or 15-30 microns; or 15-20 microns; or 20-50 microns; or 20-30 microns; or 30-50 microns; or 40-50 microns; or 50-100 microns; or 50-60 microns; or 60-100 microns; or 60-70 microns; or 70-100 microns; or 70-80 microns; or 80-100 microns; or 80-90 microns; or 0.1 microns; or 0.5 microns; or 1 microns; or 2 microns; or 3 microns; or 4 microns; or 5 microns; or 8 microns; or 10 microns; or 15 microns; or 20 microns; or 30 microns; or 40 microns; or 50 microns; or 60 microns; or 70 microns; or 80 microns; or 100 microns. For example, in some embodiments, the composition provided herein is a particulate composition with an average particle size of 0.1-20 micron; or 0.1-15 micron; or 0.1-10 micron; or 0.1-8 micron; or 0.1-5 micron; or 1-25 micron; or 1-20 micron; or 1-15 micron; or 1-10 micron; or 1-5 micron; or 5-20 micron; or 5-10 micron. In some embodiments, the carbonate additive or carbonate composition includes one or more different sizes of the particles in the composition. In some embodiments, the composition includes two or more, or three or more, or four or more, or five or more, or ten or more, or 20 or more, or 3-20, or 4-10 different sizes of the particles in the composition. For example, the composition may include two or more, or three or more, or between 3-20 particles ranging from 0.1-10 micron, 10-50 micron, 50-100 micron, 100-200 micron, 200-500 micron, 500-1000 micron, and/or sub-micron sizes of the particles.

In some embodiments, there is provided a method of a) contacting an aqueous solution comprising carbide lime with carbon dioxide from an industrial process; and b) producing a precipitation material comprising at least 50% w/w, or at least 75% w/w, or at least 90% w/w, or at least 95% w/w, or at least 99% w/w, or between 50-99% w/w, or between 75-99% w/w, stable or reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, there is provided a method of contacting an aqueous solution comprising carbide lime with carbon dioxide from an industrial process; and producing a precipitation material comprising at least 50% w/w, or at least 75% w/w, or at least 90% w/w, or at least 95% w/w, or at least 99% w/w, or between 50-99% w/w, or between 75-99% w/w, stable vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, there is provided a method of contacting an aqueous solution comprising carbide lime with carbon dioxide from an industrial process; and producing a precipitation material comprising at least 50% w/w, or at least 75% w/w, or at least 90% w/w, or at least 95% w/w, or at least 99% w/w, or between 50-99% w/w, or between 75-99% w/w, reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, in the foregoing methods, the step a) is conducted under precipitation conditions that favor the formation of stable or reactive vaterite with a desired average particle size. Such precipitation conditions, that can be used in the foregoing method embodiments or the method embodiments described herein, suitable to form stable or reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof.

In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, stable or reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, stable or reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, the method further includes subjecting the aqueous solution to precipitation conditions at step b) to produce the precipitation material comprising stable or reactive vaterite. Such precipitation conditions suitable to form stable or reactive vaterite with a desired particle size include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof. In some embodiments, the N-containing salt includes, but not limited to, ammonium chloride, ammonium sulfate, ammonium nitrate, and the like. In some embodiments, there is provided a method comprising a) purifying carbide lime by treatment with ammonium chloride to make an aqueous solution comprising carbide lime; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns.

In some embodiments, there is provided a method comprising a) purifying carbide lime by treatment with N-containing salt to make an aqueous solution comprising carbide lime wherein molar ratio of the N-containing salt:carbide lime is between 2:1 to 4:1 or 2:1 to 3:1 or 3:1 to 4:1, or 2:1, or 3:1, or 4:1; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, there is provided a method comprising a) purifying carbide lime by treatment with ammonium chloride to make an aqueous solution comprising carbide lime wherein molar ratio of the ammonium chloride:carbide lime is between 2:1 to 4:1 or 2:1 to 3:1 or 3:1 to 4:1, or 2:1, or 3:1, or 4:1; b) contacting an aqueous solution comprising carbide lime with carbon dioxide from an industrial process; and c) producing a precipitation material comprising at least 50% w/w, or at least 75% w/w, or at least 90% w/w, or at least 95% w/w, or at least 99% w/w, or between 50-99% w/w, or between 75-99% w/w, reactive vaterite wherein an average particle size of vaterite is between 1-50 microns, or 1-25 microns, or 5-50 microns, or 10-50 microns, or 5-25 microns, or 5-20 microns, or 15-20 microns, or 10-20 microns. In some embodiments, the method further includes subjecting the aqueous solution to precipitation conditions at step b) to produce the precipitation material comprising stable or reactive vaterite with a desired particle size. Such precipitation conditions suitable to form stable or reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof.

In some embodiments, the composition of the invention may further include Ordinary Portland Cement (OPC) or Portland cement clinker. The amount of Portland cement component may vary and range from 10 to 95% w/w; or 10 to 90% w/w; or 10 to 80% w/w; or 10 to 70% w/w; or 10 to 60% w/w; or 10 to 50% w/w; or 10 to 40% w/w; or 10 to 30% w/w; or 10 to 20% w/w; or to 90% w/w; or 20 to 80% w/w; or 20 to 70% w/w; or 20 to 60% w/w; or 20 to 50% w/w; or 20 to 40% w/w; or 20 to 30% w/w; or 30 to 90% w/w; or 30 to 80% w/w; or 30 to 70% w/w; or 30 to 60% w/w; or 30 to 50% w/w; or 30 to 40% w/w; or 40 to 90% w/w; or 40 to 80% w/w; or 40 to 70% w/w; or 40 to 60% w/w; or 40 to 50% w/w; or 50 to 90% w/w; or 50 to 80% w/w; or 50 to 70% w/w; or 50 to 60% w/w; or 60 to 90% w/w; or 60 to 80% w/w; or 60 to 70% w/w; or 70 to 90% w/w; or 70 to 80% w/w. For example, the composition may include a blend of 75% OPC and 25% composition of the invention; or 80% OPC and 20% composition of the invention; or 85% OPC and 15% composition of the invention; or 90% OPC and 10% composition of the invention; or 95% OPC and 5% composition of the invention.

In certain embodiments, the composition may further include an aggregate. Aggregate may be included in the composition to provide for mortars which include fine aggregate and concretes which also include coarse aggregate. The fine aggregates are materials that almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed round marble, glass spheres, granite, limestone, calcite, feldspar, alluvial sands, sands or any other durable aggregate, and mixtures thereof. As such, the term “aggregate” is used broadly to refer to a number of different types of both coarse and fine particulate material, including, but are not limited to, sand, gravel, crushed stone, slag, and recycled concrete. The amount and nature of the aggregate may vary widely. In some embodiments, the amount of aggregate may range from 25 to 80%, such as 40 to 70% and including 50 to 70% w/w of the total composition made up of both the composition and the aggregate.

In some embodiments, there is provided a method of a) contacting an aqueous solution comprising carbide lime with carbon dioxide from an industrial process; b) producing a precipitation material comprising reactive vaterite, and c) transforming the reactive vaterite to aragonite. In some embodiments, in the foregoing methods, the step a) is conducted under precipitation conditions that favor the formation of reactive vaterite. Such precipitation conditions, that can be used in the foregoing method embodiments or the method embodiments described herein, suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof. The product containing the aragonite form of the precipitate shows one or more unexpected properties, including but not limited to, high compressive strength, high porosity (low density or light weight), neutral pH (useful as artificial reef described below), microstructure network, etc.

In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; c) producing a precipitation material comprising reactive vaterite; and d) transforming the reactive vaterite to aragonite. In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; c) producing a precipitation material comprising reactive vaterite; and d) transforming the reactive vaterite to aragonite. In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; c) producing a precipitation material comprising reactive vaterite; and d) transforming the reactive vaterite to aragonite. In some embodiments, the foregoing methods further include subjecting the aqueous solution to precipitation conditions at step b) to produce the precipitation material comprising reactive vaterite. Such precipitation conditions suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof. In some embodiments, the N-containing salt includes, but not limited to, ammonium chloride, ammonium sulfate, ammonium nitrate, and the like. In some embodiments, there is provided a method comprising a) purifying carbide lime by treatment with ammonium chloride to make an aqueous solution comprising carbide lime; b) contacting an aqueous solution comprising carbide lime with carbon dioxide from an industrial process; c) producing a precipitation material comprising reactive vaterite; and d) transforming the reactive vaterite to aragonite.

In some embodiments, in the foregoing methods, the precipitation material comprises at least 50% w/w, or at least 75% w/w, or at least 90% w/w, or at least 95% w/w, or at least 99% w/w, or between 50-99% w/w, or between 75-99% w/w, reactive vaterite. In some embodiments, in the foregoing methods, the molar ratio of the weak base, such as, borate, N-containing salt, N-containing aliphatic compound, N-containing aromatic compound:carbide lime, or N-containing salt:carbide lime is between 2:1 to 4:1, or 2:1 to 3:1, or 2.5:1 to 3:1, or 3:1 to 4:1, or 2:1, or 3:1, or 4:1. In some embodiments, in the foregoing methods, the average particle size of the reactive vaterite is between 1-50 microns, or 1-25 microns, or 5-50 microns, or 10-50 microns, or 5-25 microns, or 5-20 microns, or 15-20 microns, or 10-20 microns.

### Activation of the Reactive Vaterite

The transformation between calcium carbonate polymorphs may occur via solid-state transition, may be solution mediated, or both. In some embodiments, the transformation is solution-mediated as it may require less energy than the thermally activated solid-state transition. Vaterite is metastable and the difference in thermodynamic stability of calcium carbonate polymorphs may be manifested as a difference in solubility, where the least stable phases are the most soluble (Ostwald, supra). Therefore, vaterite may dissolve readily in solution and transform favorably towards a more stable polymorph, such as aragonite. In a polymorphic system like calcium carbonate, two kinetic processes may exist simultaneously in solution: dissolution of the metastable phase and growth of the stable phase. In some embodiments, the aragonite crystals may be growing while vaterite is undergoing dissolution in the aqueous medium.

In one aspect, the reactive vaterite may be activated such that the reactive vaterite leads to aragonitic pathway and not calcite pathway during dissolution-reprecipitation process. In some embodiments, the reactive vaterite containing composition is activated in such a way that after the dissolution-reprecipitation process, aragonite formation is enhanced and calcite formation is suppressed. The activation of the reactive vaterite containing composition may result in control over the aragonite formation and crystal growth. The activation of the vaterite containing composition may be achieved by various processes. Various examples of the activation of vaterite, such as, but not limited to, nuclei activation, thermal activation, mechanical activation, chemical activation, or combination thereof, are described herein. In some embodiments, the vaterite is activated through various processes such that aragonite formation and its morphology and/or crystal growth can be controlled upon reaction of vaterite containing composition with water. The aragonite formed results in higher tensile strength and fracture tolerance to the products formed from the reactive vaterite.

In some embodiments, the reactive vaterite may be activated by mechanical means, as described herein. For example, the reactive vaterite containing compositions may be activated by creating surface defects on the vaterite composition such that aragonite formation is accelerated. In some embodiments, the activated vaterite is a ball-milled reactive vaterite or is a reactive vaterite with surface defects such that aragonite formation pathway is facilitated.

The reactive vaterite containing compositions may also be activated by providing chemical or nuclei activation to the vaterite composition. Such chemical or nuclei activation may be provided by one or more of aragonite seeds, inorganic additive, or organic additive. The aragonite seed present in the compositions provided herein may be obtained from natural or synthetic sources. The natural sources include, but not limited to, reef sand, limestone, hard skeletal material of certain fresh-water and marine invertebrate organisms, including pelecypods, gastropods, mollusk shell, and calcareous endoskeleton of warm- and cold-water corals, pearls, rocks, sediments, ore minerals (e.g., serpentine), and the like. The synthetic sources include, but not limited to, precipitated aragonite, such as formed from sodium carbonate and calcium chloride; or aragonite formed by the transformation of vaterite to aragonite, such as transformed vaterite described herein.

In some embodiments, the inorganic additive or the organic additive in the compositions provided herein can be any additive that activates reactive vaterite. Some examples of inorganic additive or organic additive in the compositions provided herein, include, but not limited to, sodium decyl sulfate, lauric acid, sodium salt of lauric acid, urea, citric acid, sodium salt of citric acid, phthalic acid, sodium salt of phthalic acid, taurine, creatine, dextrose, poly(n-vinyl-1-pyrrolidone), aspartic acid, sodium salt of aspartic acid, magnesium chloride, acetic acid, sodium salt of acetic acid, glutamic acid, sodium salt of glutamic acid, strontium chloride, gypsum, lithium chloride, sodium chloride, glycine, sodium citrate dehydrate, sodium bicarbonate, magnesium sulfate, magnesium acetate, sodium polystyrene, sodium dodecylsulfonate, poly-vinyl alcohol, or combination thereof. In some embodiments, inorganic additive or organic additive in the compositions provided herein, include, but not limited to, taurine, creatine, poly(n-vinyl-1-pyrrolidone), lauric acid, sodium salt of lauric acid, urea, magnesium chloride, acetic acid, sodium salt of acetic acid, strontium chloride, magnesium sulfate, magnesium acetate, or combination thereof. In some embodiments, inorganic additive or organic additive in the compositions provided herein, include, but not limited to, magnesium chloride, magnesium sulfate, magnesium acetate, or combination thereof. Such activation of the vaterite to form activated or reactive vaterite, are described in U.S. patent application Ser. No. 13/457,156, filed Apr. 26, 2012, which is incorporated herein by reference in its entirety.

Without being limited by any theory, it is contemplated that the activation of vaterite by ball-milling or by addition of aragonite seed, inorganic additive or organic additive or combination thereof may result in control of formation of aragonite during dissolution-reprecipitation process of the activated reactive vaterite including control of properties, such as, but not limited to, polymorph, morphology, particle size, cross-linking, agglomeration, coagulation, aggregation, sedimentation, crystallography, inhibiting growth along a certain face of a crystal, allowing growth along a certain face of a crystal, or combination thereof. For example, the aragonite seed, inorganic additive or organic additive may selectively target the morphology of aragonite, inhibit calcite growth and promote the formation of aragonite that may generally not be favorable kinetically.

In some embodiments, one or more inorganic additives may be added to facilitate transformation of vaterite to aragonite. The one or more additives may be added during any step of the process. For example, the one or more additives may be added during purification of carbide lime, during contact of the purified carbide lime solution with carbon dioxide, after contact of the purified carbide lime solution with carbon dioxide, during precipitation of the precipitation material, after precipitation of the precipitation material in the slurry, in the slurry after the dewatering of the precipitation material, in the powder after the drying of the slurry, in the aqueous solution to be mixed with the powder precipitation material, or in the slurry made from the powdered precipitation material with water, or any combination thereof. In some embodiments, the water used in the process of making the carbonate precipitation material may already contain the one or more additives or the one or more additive ions. For example, if sea water is used in the process, then the additive ion may already be present in the sea water.

In some embodiments, there is provided a method of a) contacting an aqueous solution comprising carbide lime with carbon dioxide from an industrial process; b) producing a precipitation material comprising reactive vaterite; c) adding one or more additives to the precipitation material; and d) transforming the reactive vaterite to aragonite. In some embodiments, in the foregoing methods, the step a) is conducted under precipitation conditions that favor the formation of reactive vaterite. Such precipitation conditions, that can be used in the foregoing method embodiments or the method embodiments described herein, suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof.

In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; c) producing a precipitation material comprising reactive vaterite; c) adding one or more additives to the precipitation material; and d) transforming the reactive vaterite to aragonite. In some embodiments, there is provided a method comprising a) purifying carbide lime by treatment with weak base selected from N-containing aliphatic compound, N-containing aromatic compound, or combination thereof to make an aqueous solution comprising carbide lime; b) contacting an aqueous solution comprising carbide lime with carbon dioxide from an industrial process; c) producing a precipitation material comprising reactive vaterite; c) adding one or more additives to the precipitation material; and d) transforming the reactive vaterite to aragonite. In some embodiments, there is provided a method comprising a) purifying carbide lime by treatment with N-containing salt to make an aqueous solution comprising carbide lime; b) contacting an aqueous solution comprising carbide lime with carbon dioxide from an industrial process; c) producing a precipitation material comprising reactive vaterite; c) adding one or more additives to the precipitation material; and d) transforming the reactive vaterite to aragonite. In some embodiments, the foregoing methods further include subjecting the aqueous solution to precipitation conditions at step b) to produce the precipitation material comprising reactive vaterite. Such precipitation conditions suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof. In some embodiments, the N-containing salt includes, but not limited to, ammonium chloride, ammonium sulfate, ammonium nitrate, and the like. In some embodiments, there is provided a method comprising a) purifying carbide lime by treatment with ammonium chloride to make an aqueous solution comprising carbide lime; b) contacting an aqueous solution comprising carbide lime with carbon dioxide from an industrial process; c) producing a precipitation material comprising reactive vaterite; c) adding one or more additives to the precipitation material; and d) transforming the reactive vaterite to aragonite.

In some embodiments, in the foregoing methods, the precipitation material comprises at least 50% w/w, or at least 75% w/w, or at least 90% w/w, or at least 95% w/w, or at least 99% w/w, or between 50-99% w/w, or between 75-99% w/w, reactive vaterite. In some embodiments, in the foregoing methods, the molar ratio of the weak base, such as, borate, N-containing salt, N-containing aliphatic compound, N-containing aromatic compound, or N-containing salt:carbide lime is between 2:1 to 4:1, or 2:1 to 3:1, or 2.5:1 to 3:1, or 3:1 to 4:1, or 2:1, or 3:1, or 4:1. In some embodiments, in the foregoing methods, the average particle size of the reactive vaterite is between 1-50 microns, or 1-25 microns, or 5-50 microns, or 10-50 microns, or 5-25 microns, or 5-20 microns, or 15-20 microns, or 10-20 microns.

In some embodiments, in the foregoing methods, the one or more additives are alkaline earth metal ions selected from beryllium, magnesium, strontium, barium, or combination thereof. In some embodiments, the one or more additives are a salt of the ion including, but not limited to, magnesium, strontium, barium, sodium, potassium, chloride, bromide, iodide, etc. For example, the one or more additives added during the process are, but not limited to, beryllium chloride, magnesium chloride, magnesium bromide, magnesium iodide, strontium chloride, strontium bromide, strontium iodide, barium chloride, barium bromide, barium iodide, sodium chloride, sodium bromide, sodium iodide, potassium chloride, potassium bromide, potassium iodide, etc.

In some embodiments, in the foregoing methods, the amount of the one or more additives added during the process is more than 0.1% by weight, or more than 0.5% by weight, or more than 1% by weight, or more than 1.5% by weight, or more than 1.6% by weight, or more than 1.7% by weight, or more than 1.8% by weight, or more than 1.9% by weight, or more than 2% by weight, or more than 2.1% by weight, or more than 2.2% by weight, or more than 2.3% by weight, or more than 2.4% by weight, or more than 2.5% by weight, or more than 2.6% by weight, or more than 2.7% by weight, or more than 2.8% by weight, or more than 2.9% by weight, or more than 3% by weight, or more than 3.5% by weight, or more than 4% by weight, or more than 4.5% by weight, or more than 5% by weight, or between 0.5-5% by weight, or between 0.5-4% by weight, or between 0.5-3% by weight, or 0.5-2% by weight, or 0.5-1% by weight, or 1-3% by weight, or 1-2.5% by weight, or 1-2% by weight, or 1.5-2.5% by weight, or 2-3% by weight, or 2.5-3% by weight, or 0.5% by weight, or 1% by weight, or 1.5% by weight, or 2% by weight, or 2.5% by weight, or 3% by weight, or 3.5% by weight, or 4% by weight, or 4.5% by weight, or 5% by weight. In some embodiments, in the foregoing methods, the amount of the one or more additives added during the process is between 0.5-3% by weight or between 1.5-2.5% by weight.

In some embodiments, the composition of the invention, as prepared by the methods described above, set and harden after treatment with the aqueous medium under one or more suitable conditions. The aqueous medium includes, but is not limited to, fresh water optionally containing additives or brine. In some embodiments, the one or more suitable conditions include, but are not limited to, temperature, pressure, time period for setting, a ratio of the aqueous medium to the composition, and combination thereof. The temperature may be related to the temperature of the aqueous medium. In some embodiments, the temperature is in a range of 0-110° C.; or 0-80° C.; or 0-60° C.; or 0-40° C.; or 25-100° C.; or 25-75° C.; or 25-50° C.; or 37-100° C.; or 37-60° C.; or 40-100° C.; or 40-60° C.; or 50-100° C.; or 50-80° C.; or 60-100° C.; or 60-80° C.; or 80-100° C. In some embodiments, the pressure is atmospheric pressure or above atm. pressure. In some embodiments, the time period for setting the cement product is 30 min. to 48 hrs; or 30 min. to 24 hrs; or 30 min. to 12 hrs; or 30 min. to 8 hrs; or 30 min. to 4 hrs; or 30 min. to 2 hrs; 2 to 48 hrs; or 2 to 24 hrs; or 2 to 12 hrs; or 2 to 8 hrs; or 2 to 4 hrs; 5 to 48 hrs; or 5 to 24 hrs; or 5 to 12 hrs; or 5 to 8 hrs; or 5 to 4 hrs; or 5 to 2 hrs; 10 to 48 hrs; or 10 to 24 hrs; or 24 to 48 hrs.

In some embodiments, the ratio of the aqueous medium to the dry components or to the composition of the invention (aqueous medium:dry components or aqueous medium:precipitation material of the invention) is 0.1-10; or 0.1-8; or 0.1-6; or 0.1-4; or 0.1-2; or 0.1-1; or 0.2-10; or 0.2-8; or 0.2-6; or 0.2-4; or 0.2-2; or 0.2-1; or 0.3-10; or 0.3-8; or 0.3-6; or 0.3-4; or 0.3-2; or 0.3-1; or 0.4-10; or 0.4-8; or 0.4-6; or 0.4-4; or 0.4-2; or 0.4-1; or 0.5-10; or 0.5-8; or 0.5-6; or 0.5-4; or 0.5-2; or 0.5-1; or 0.6-10; or 0.6-8; or 0.6-6; or 0.6-4; or 0.6-2; or 0.6-1; or 0.8-10; or 0.8-8; or 0.8-6; or 0.8-4; or 0.8-2; or 0.8-1; or 1-10; or 1-8; or 1-6; or 1-4; or 1-2; or 1:1; or 2:1; or 3:1.

In some embodiments, the precipitate may be rinsed with fresh water to remove halite or the chloride content from the precipitate. The chloride may be undesirable in some applications, for example, in aggregates intended for use in concrete since the chloride may have a tendency to corrode rebar. For example, the self-cementing composition can be kept in the saltwater until before use and is rinsed with fresh water that may remove the halite from the precipitate and facilitate the formation of the cemented material.

In some embodiments, such rinsing may not be desirable as it may reduce the yield of the composition. In such embodiments, the precipitate may be washed with a solution having a low chloride concentration but high concentration of divalent cations (such as, calcium, magnesium, etc.). Such high concentration of the divalent ion may prevent the dissolution of the precipitate, thereby reducing the yield loss and the conversion to cemented material.

During the mixing of the composition with the aqueous medium, the precipitate may be subjected to high shear mixer. After mixing, the precipitate may be dewatered again and placed in pre-formed molds to make formed building materials or may be used to make formed building materials using the processes well known in the art or as described herein. Alternatively, the precipitate may be mixed with water and may be allowed to set. The precipitate may set over a period of days and may be then placed in the oven for drying, e.g., at 40° C., or from 40° C.-60° C., or from 40° C.-50° C., or from 40° C.-100° C., or from 50° C.-60° C., or from 50° C.-80° C., or from 50° C.-100° C., or from 60° C.-80° C., or from 60° C.-100° C. The precipitate may be subjected to curing at high temperature, such as, from 50° C.-60° C., or from 50° C.-80° C., or from 50° C.-100° C., or from 60° C.-80° C., or from 60° C.-100° C., or 60° C., or 80° C.-100° C., in high humidity, such as, in 30%, or 40%, or 50%, or 60% humidity.

The product produced by the methods described herein may be an aggregate or building material or a pre-cast material or a formed building material. In some embodiments, the product produced by the methods described herein includes non-cementitous materials such as paper, paint, PVC etc. In some embodiments, the product produced by the methods described herein includes artificial reefs. These products have been described herein.

### Admixture

In some embodiments, the precipitation material in wet or dried form, may be mixed with one or more admixtures to impart one or more properties to the product including, but not limited to, strength, flexural strength, compressive strength, porosity, thermal conductivity, etc. The amount of admixture that is employed may vary depending on the nature of the admixture. In some embodiments, the amount of the one or more admixtures range from 1 to 50% w/w, such as 1-30% w/w, or 1-25% w/w, or 1-20% w/w/, or 2 to 10% w/w. Examples of the admixtures include, but not limited to, set accelerators, set retarders, air-entraining agents, foaming agents, defoamers, alkali-reactivity reducers, bonding admixtures, dispersants, coloring admixtures, corrosion inhibitors, damp-proofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, reinforced material such as fibers, and any other admixture. When using an admixture, the composition or the carbonate precipitation material, to which the admixture raw materials are introduced, is mixed for sufficient time to cause the admixture raw materials to be dispersed relatively uniformly throughout the composition.

Set accelerators may be used to accelerate the setting and early strength development of cement. Examples of set accelerators that may be used include, but are not limited to, POZZOLITH®NC534, non-chloride type set accelerator and/or RHEOCRETE®CNI calcium nitrite-based corrosion inhibitor, both sold under the above trademarks by BASF Admixtures Inc. of Cleveland, Ohio. Set retarding, also known as delayed-setting or hydration control, admixtures are used to retard, delay, or slow the rate of setting of cement. Most set retarders may also act as low level water reducers and can also be used to entrain some air into product. An example of a retarder is DELVO® by BASF Admixtures Inc. of Cleveland, Ohio. The air entrainer includes any substance that will entrain air in the compositions. Some air entrainers can also reduce the surface tension of a composition at low concentration. Air-entraining admixtures are used to purposely entrain microscopic air bubbles into cement. Air entrainment may increase the workability of the mix while eliminating or reducing segregation and bleeding. Materials used to achieve these desired effects can be selected from wood resin, natural resin, synthetic resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition. Examples of air entrainers that can be utilized in the admixture system include, but are not limited to MB AE 90, MB VR and MICRO AIR®, all available from BASF Admixtures Inc. of Cleveland, Ohio.

In some embodiments, the precipitation material is mixed with foaming agent. The foaming agents incorporate large quantities of air voids/porosity and facilitate reduction of the material's density. Examples of foaming agents include, but not limited to, soap, detergent (alkyl ether sulfate), Millifoam™ (alkyl ether sulfate), Cedepal™ (ammonium alkyl ethoxy sulfate), Witcolate™ 12760, and the like.

Also of interest as admixtures are defoamers. Defoamers are used to decrease the air content in the cementitious composition. Also of interest as admixtures are dispersants. The dispersant includes, but is not limited to, polycarboxylate dispersants, with or without polyether units. The term dispersant is also meant to include those chemicals that also function as a plasticizer, water reducer such as a high range water reducer, fluidizer, antiflocculating agent, or superplasticizer for compositions, such as lignosulfonates, salts of sulfonated naphthalene sulfonate condensates, salts of sulfonated melamine sulfonate condensates, beta naphthalene sulfonates, sulfonated melamine formaldehyde condensates, naphthalene sulfonate formaldehyde condensate resins for example LOMAR D® dispersant (Cognis Inc., Cincinnati, Ohio), polyaspartates, or oligomeric dispersants. Polycarboxylate dispersants can be used, by which is meant a dispersant having a carbon backbone with pendant side chains, wherein at least a portion of the side chains are attached to the backbone through a carboxyl group or an ether group.

Natural and synthetic admixtures may be used to color the product for aesthetic and safety reasons. These coloring admixtures may be composed of pigments and include carbon black, iron oxide, phthalocyanine, umber, chromium oxide, titanium oxide, cobalt blue, and organic coloring agents. Also of interest as admixtures are corrosion inhibitors. Corrosion inhibitors may serve to protect embedded reinforcing steel from corrosion. The materials commonly used to inhibit corrosion are calcium nitrite, sodium nitrite, sodium benzoate, certain phosphates or fluorosilicates, fluoroaluminites, amines and related chemicals. Also of interest are damp-proofing admixtures. Damp-proofing admixtures reduce the permeability of the product that has low cement contents, high water-cement ratios, or a deficiency of fines in the aggregate. These admixtures retard moisture penetration into dry products and include certain soaps, stearates, and petroleum products. Also of interest are gas former admixtures. Gas formers, or gas-forming agents, are sometimes added to the mix to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers. Also of interest are permeability reducers. Permeability reducers may be used to reduce the rate at which water under pressure is transmitted through the mix. Silica fume, fly ash, ground slag, natural pozzolans, water reducers, and latex may be employed to decrease the permeability of the mix.

Also of interest are rheology modifying agent admixtures. Rheology modifying agents may be used to increase the viscosity of the compositions. Suitable examples of rheology modifier include firmed silica, colloidal silica, hydroxyethyl cellulose, starch, hydroxypropyl cellulose, fly ash (as defined in ASTM C618), mineral oils (such as light naphthenic), clay such as hectorite clay, polyoxyalkylenes, polysaccharides, natural gums, or mixtures thereof. Some of the mineral extenders such as, but not limited to, sepiolite clay are rheology modifying agents.

Also of interest are shrinkage compensation admixtures. TETRAGUARD® is an example of a shrinkage reducing agent and is available from BASF Admixtures Inc. of Cleveland, Ohio. Bacterial and fungal growth on or in hardened product may be partially controlled through the use of fungicidal and germicidal admixtures. The materials for these purposes include, but are not limited to, polyhalogenated phenols, dialdrin emulsions, and copper compounds. Also of interest in some embodiments is workability improving admixtures. Entrained air, which acts like a lubricant, can be used as a workability improving agent. Other workability agents are water reducers and certain finely divided admixtures.

In some embodiments, the compositions of the invention are employed with reinforced material such as fibers, e.g., where fiber-reinforced product is desirable. Fibers can be made of zirconia containing materials, aluminum, glass, steel, carbon, ceramic, grass, bamboo, wood, fiberglass, or synthetic materials, e.g., polypropylene, polycarbonate, polyvinyl chloride, polyvinyl alcohol, nylon, polyethylene, polyester, rayon, high-strength aramid, (i.e. Kevlar®), or mixtures thereof. The reinforced material is described in U.S. patent application Ser. No. 13/560,246, filed Jul. 27, 2012, which is incorporated herein in its entirety in the present disclosure.

The components of the compositions of the invention can be combined using any suitable protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

### II. Systems

The methods and systems of the invention may be carried out at land (e.g., at a location where a suitable carbide lime-containing source is present, or is easily and economically transported in), at sea, or in the ocean. In some embodiments, the methods and systems of the invention are carried out near the acetylene production plant that has a surplus of carbide lime. In some embodiments, the methods and systems of the invention are carried out near the landfill that has a surplus of carbide lime. In some embodiments, the methods and systems of the invention are integrated with the acetylene production plant such that the carbide lime obtained from acetylene production is used simultaneously in the production of the carbonate containing precipitation material comprising stable or reactive vaterite.

Aspects of the invention include systems, including processing plants or factories, for practicing the methods as described herein. Systems of the invention may have any configuration that enables practice of the particular production method of interest. In some embodiments, the system is configured to produce the precipitation material in excess of 1 ton per day. In some embodiments, the system is configured to produce the precipitation material in excess of 10 tons per day. In some embodiments, the system is configured to produce the precipitation material in excess of 100 tons per day. In some embodiments, the system is configured to produce the precipitation material in excess of 1000 tons per day. In some embodiments, the system is configured to produce carbonate-containing precipitation material in excess of 10,000 tons per day.

In certain embodiments, the systems include a source of carbide lime or a source of carbide lime-containing aqueous solution such as a structure having an input for the aqueous solution. For example, the systems may include a pipeline or analogous feed of carbide lime-containing aqueous solution, wherein the aqueous solution is brine, seawater, or freshwater. The system further includes a source of CO₂, as well as components for combining these sources with water (optionally an aqueous solution such as water, brine or seawater) before the precipitation reactor or in the precipitation reactor. As such, the precipitation system may include a separate source of CO₂, for example, wherein the system is configured to be employed in embodiments where the aqueous solution of carbide lime and/or supernatant is contacted with a carbon dioxide source at some time during the process. This source may be any of those described herein (e.g., a waste feed from an industrial power plant), gas contact being effected by, for example, a gas-liquid contactor such as that described in U.S. Provisional Patent Application 61/178,475, filed 14 May 2009, which is hereby incorporated by reference in its entirety. In some embodiments, the gas-liquid contactor is configured to contact enough CO₂ to produce precipitation material in excess of 1, 10, 100, 1,000, or 10,000 tons per day.

The systems further include a precipitation reactor that subjects the water introduced to the precipitation reactor to carbonate compound precipitation conditions (as described herein) and produces precipitation material and supernatant. In some embodiments, the precipitation reactor is configured to hold water sufficient to produce precipitation material in excess of 1, 10, 100, 1,000, or 10,000 tons per day. The precipitation reactor may also be configured to include any of a number of different elements such as temperature modulation elements (e.g., configured to heat the water to a desired temperature), chemical additive elements (e.g., configured for introducing additives etc. into the precipitation reaction mixture), electrolysis elements (e.g., cathodes, anodes, etc.), computer automation, and the like.

A gaseous waste stream may be provided from an industrial plant to the site of precipitation in any convenient manner that conveys the gaseous waste stream from the industrial plant to the precipitation plant. In some embodiments, the gaseous waste stream is provided with a gas conveyer (e.g., a duct) that runs from a site of the industrial plant (e.g., an industrial plant flue) to one or more locations of the precipitation site. The source of the gaseous waste stream may be a distal location relative to the site of precipitation such that the source of the gaseous waste stream is a location that is 1 mile or more, such as 10 miles or more, including 100 miles or more, from the precipitation location. For example, the gaseous waste stream may have been transported to the site of precipitation from a remote industrial plant via a CO₂ gas conveyance system (e.g., a pipeline). The industrial plant generated CO₂ containing gas may or may not be processed (e.g., remove other components) before it reaches the precipitation site (i.e., the site in which precipitation and/or production of aggregate takes place). In yet other instances, the gaseous waste stream source is proximal to the precipitation site. For example, the precipitation site is integrated with the gaseous waste stream source, such as a power plant that integrates a precipitation reactor for precipitation of precipitation material that may be used to produce the products.

As indicated above, the gaseous waste stream may be one that is obtained from a flue or analogous structure of an industrial plant. In these embodiments, a line (e.g., duct) is connected to the flue so that gas leaves the flue through the line and is conveyed to the appropriate location(s) of a precipitation system. Depending upon the particular configuration of the precipitation system at the point at which the gaseous waste stream is employed, the location of the source from which the gaseous waste stream is obtained may vary (e.g., to provide a waste stream that has the appropriate or desired temperature). As such, in certain embodiments, where a gaseous waste stream having a temperature ranging for 0° C. to 1800° C., such as 60° C. to 700° C., is desired, the flue gas may be obtained at the exit point of the boiler or gas turbine, the kiln, or at any point of the power plant or stack, that provides the desired temperature. Where desired, the flue gas is maintained at a temperature above the dew point (e.g., 125° C.) in order to avoid condensation and related complications. If it is not possible to maintain the temperature above the dew point, steps may be taken to reduce the adverse impact of condensation (e.g., employing ducting that is stainless steel, fluorocarbon (such as poly(tetrafluoroethylene) lined, diluted with water, and pH controlled, etc.) so the duct does not rapidly deteriorate.

Where the saltwater source that is processed by the system to produce the carbonate compound composition is seawater, the input is in fluid communication with a source of sea water, e.g., such as where the input is a pipeline or feed from ocean water to a land based system or a inlet port in the hull of ship, e.g., where the system is part of a ship, e.g., in an ocean based system.

The methods and systems of the invention may also include one or more detectors configured for monitoring the source of aqueous medium or the source of carbon dioxide (not illustrated in figures). Monitoring may include, but is not limited to, collecting data about the pressure, temperature and composition of the water or the carbon dioxide gas. The detectors may be any convenient device configured to monitor, for example, pressure sensors (e.g., electromagnetic pressure sensors, potentiometric pressure sensors, etc.), temperature sensors (resistance temperature detectors, thermocouples, gas thermometers, thermistors, pyrometers, infrared radiation sensors, etc.), volume sensors (e.g., geophysical diffraction tomography, X-ray tomography, hydroacoustic surveyers, etc.), and devices for determining chemical makeup of the water or the carbon dioxide gas (e.g, IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

In some embodiments, detectors may also include a computer interface which is configured to provide a user with the collected data about the aqueous medium, divalent cation solution, and/or the carbon dioxide gas. For example, a detector may determine the internal pressure of the aqueous medium, divalent cation solution, and/or the carbon dioxide gas and the computer interface may provide a summary of the changes in the internal pressure within the aqueous medium, divalent cation solution, and/or the carbon dioxide gas over time. In some embodiments, the summary may be stored as a computer readable data file or may be printed out as a user readable document.

In some embodiments, the detector may be a monitoring device such that it can collect real-time data (e.g., internal pressure, temperature, etc.) about the aqueous medium, divalent cation solution, and/or the carbon dioxide gas. In other embodiments, the detector may be one or more detectors configured to determine the parameters of the aqueous medium, divalent cation solution, and/or the carbon dioxide gas at regular intervals, e.g., determining the composition every 1 minute, every 5 minutes, every 10 minutes, every 30 minutes, every 60 minutes, every 100 minutes, every 200 minutes, every 500 minutes, or some other interval.

The system further includes a liquid-separator separator for separating carbonate-containing precipitation material from the reaction mixture from which it was produced. As detailed in U.S. Provisional Patent Application 61/170,086, filed 16 Apr. 2009, which is herein incorporate by reference, liquid-solid separators such as Epuramat's Extrem-Separator (“ExSep”) liquid-solid separator, Xerox PARC's spiral concentrator, or a modification of either of Epuramat's ExSep or Xerox PARC's spiral concentrator, is useful for separation of the precipitation material from the precipitation reaction mixture. In certain embodiments, the separator is a drying station for drying the precipitated carbonate mineral composition produced by the carbonate mineral precipitation station. Depending on the particular drying protocol of the system, the drying station may include a filtration element, freeze drying structure, spray drying structure, etc., as described herein.

In certain embodiments, the system may further include a station for preparing a building material, such as cement or aggregate, from the precipitate. See e.g., U.S. patent application Ser. No. 12/126,776 titled “Hydraulic Cements Comprising Carbonate Compounds Compositions” and filed on May 23, 2008 and U.S. Provisional Patent Application Ser. No. 61/056,972 titled “CO2 Sequestering Aggregate, and Methods of Making and Using the Same,” filed on May 23, 2008, the disclosures of which applications are herein incorporated by reference. Other materials such as formed building materials and/or non-cementitious materials may also be formed from the precipitate and appropriate station may be used for preparing the same.

As indicated above, the system may be present on land or sea. For example, the system may be land-based system that is in a coastal region, e.g., close to a source of seawater, or even an interior location, where water is piped into the system from a salt-water source, e.g., ocean. Alternatively, the system is a water based system, i.e., a system that is present on or in water. Such a system may be present on a boat, ocean based platform etc., as desired.

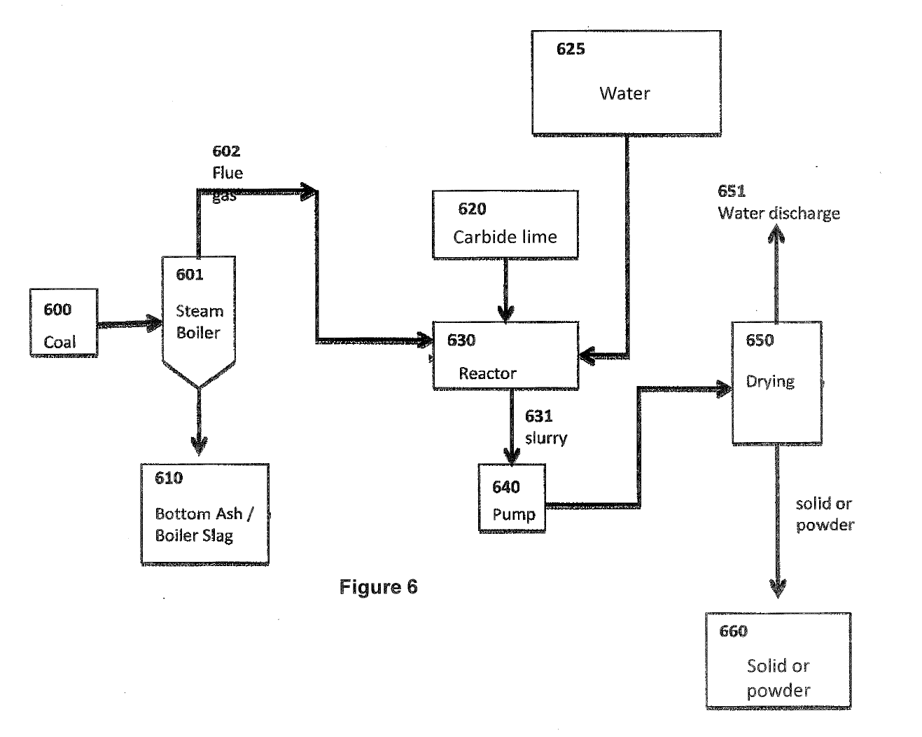

FIG. 6 illustrates a typical power plant process for burning coal and removing wastes such as ash and sulfur utilizing carbide lime. FIG. 6 represents an example of one embodiment of the invention in which CO₂ (containing fly ash, NOx, SOx, Hg and other pollutants) is utilized as reactants in a carbonate compound precipitation process to remove these moieties and sequester them into the built environment, e.g., via their use in cement, formed building material, and/or non-cementitious material. In this example, the carbide lime is utilized as reactant to both increase pH and provide divalent cations, such as calcium.

Coal 600 is burned in steam boiler 601, which produces steam to power a turbine generator and produce electricity. The burning of the coal produces flue gas 602, which contains CO₂, SOx, NOx, Hg, etc. as well as fly ash. In this embodiment, the coal utilized may be a high-sulfur sub-bituminous coal, which is inexpensive to obtain but which produces larger quantities of SOx and other pollutants. The burning of the coal also produces bottom ash 610, which may be sent to a landfill or used as a low-value aggregate. The flue gas 602 may or may not run through a separation device, generally an electrostatic precipitator, which may result in removal of fly ash from the flue gas 602. Depending on the manner of combustion and the type of coal, fly ash may find beneficial use in concrete or is land filled. Flue gas 602, carbide lime 620 (after purification with weak base), water 625 and in some embodiments, optionally additional alkali source and/or proton removing agent are charged into reactor 630, wherein a carbonate mineral precipitation process takes place, producing slurry 631.

Slurry 631 is pumped via pump 640 to drying system 650, which in some embodiments includes a filtration step followed by spray drying. The water 651 separated from the drying system 650 is discharged or is recirculated to the reactor 630. The resultant solid or powder 660 from drying system 650 is utilized as cement or aggregate to produce building materials, effectively sequestering the CO₂, SOx, and, in some embodiments, other pollutants such as mercury and/or NOx into the built environment. The solid or powder 660 may also be used as a PCC filler in non-cementitious products such as paper, plastic, paint etc. The solid or powder 660 may also be used in forming formed building materials, such as drywall, cement boards, etc.

As such, in one aspect there is provided a system comprising a precipitation reactor configured to contact an aqueous solution comprising carbide lime with carbon dioxide from a source of carbon dioxide; and a liquid-solid separator operably connected to the precipitation reactor and configured to separate the precipitation material obtained from the precipitation reactor. In some embodiments, the system comprises a source of carbon dioxide. In some embodiments, the source of carbon dioxide is from a coal-fired power plant or cement plant. In some embodiments, the system further comprises a supplemental source of proton-removing agents. In some embodiments, the system further comprises a supplemental source of divalent cations. In some embodiments, the system further comprises a building-materials production unit configured to produce a building material from solid product of the liquid-solid separator.

In some embodiments, the systems of the invention may include a control station, configured to control the amount of the carbon dioxide and/or the amount of carbide lime conveyed to the precipitator or the charger; the amount of the precipitate conveyed to the separator; the amount of the precipitate conveyed to the drying station; and/or the amount of the precipitate conveyed to the refining station. A control station may include a set of valves or multi-valve systems which are manually, mechanically or digitally controlled, or may employ any other convenient flow regulator protocol. In some instances, the control station may include a computer interface, (where regulation is computer-assisted or is entirely controlled by computer) configured to provide a user with input and output parameters to control the amount, as described above.

### III. Products

The invention provides methods and systems for utilizing carbide lime to produce carbonate-containing compositions from CO₂, wherein the CO₂ may be from a variety of different sources (e.g., an industrial waste by-product such as a gaseous waste stream produced by a power plant during the combustion of carbon-based fuel). As such, the invention provides for removing or separating CO₂ from a gaseous waste source of CO₂, and fixing the CO₂ into a non-gaseous, storage-stable form (e.g., materials for the construction of structures such as buildings and infrastructure, as well as the structures themselves or formed building materials such as drywall, or non-cementitious materials such as paper, paint, plastic, etc. or artificial reefs) such that the CO₂ cannot escape into the atmosphere.

### Building Material

The “building material” used herein includes material used in construction. In one aspect, there is provided a structure or a building material comprising the set and hardened form of the carbonate precipitation material i.e. where the reactive vaterite has converted to aragonite. In some embodiments, there is provided a method of a) contacting an aqueous solution comprising carbide lime with carbon dioxide from an industrial process; b) producing a precipitation material comprising reactive vaterite, and c) transforming the reactive vaterite to aragonite, and d) forming a building material from the aragonite. In some embodiments, there is provided a method comprising a) purifying carbide lime by treatment with weak base selected from borate, N-containing salt, N-containing aliphatic compound, N-containing aromatic compound, or combination thereof to make an aqueous solution comprising carbide lime; b) contacting an aqueous solution comprising carbide lime with carbon dioxide from an industrial process; c) producing a precipitation material comprising reactive vaterite; d) transforming the reactive vaterite to aragonite, and e) forming a building material from the aragonite. In some embodiments, in the foregoing methods, the step of contacting the aqueous solution comprising carbide lime with carbon dioxide is conducted under precipitation conditions that favor the formation of reactive vaterite. Such precipitation conditions, that can be used in the foregoing method embodiments or the method embodiments described herein, suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation, presence of seed crystals, catalysts, membranes, or substrates, dewatering, drying, ball milling, and combinations thereof. The product containing the aragonite form of the precipitate shows one or more unexpected properties, including but not limited to, high compressive strength, high porosity (low density or light weight), neutral pH (useful as artificial reef described below), microstructure network, etc.

Examples of such structures or the building materials include, but are not limited to, building, driveway, foundation, kitchen slab, furniture, pavement, road, bridges, motorway, overpass, parking structure, brick, block, wall, footing for a gate, fence, or pole, and combination thereof. Since these structures or building materials comprise and/or are produced from the compositions of the invention, they may include markers or components that identify them as being obtained from carbon dioxide of fossil fuel origin (e.g., δ¹³C vales) and/or being obtained from water having trace amounts of various elements present in the initial salt water source, and/or being obtained from carbide lime, as described herein. For example, where the mineral component of the cement component of the concrete is one that has been produced from carbide lime, the set product may contain a carbide lime marker profile of different elements in identifying amounts, such as magnesium, potassium, sulfur, boron, sodium, and chloride, etc.

### Formed Building Material

The “formed building material” used herein includes materials shaped (e.g., molded, cast, cut, or otherwise produced) into structures with defined physical shape. The formed building material may be a pre-cast building material, such as, a pre-cast cement or concrete product. The formed building materials and the methods of making and using the formed building materials are described in U.S. application Ser. No. 12/571,398, filed Sep. 30, 2009, which is incorporated herein by reference in its entirety. The formed building materials of the invention may vary greatly and include materials shaped (e.g., molded, cast, cut, or otherwise produced) into structures with defined physical shape, i.e., configuration. Formed building materials are distinct from amorphous building materials (e.g., powder, paste, slurry, etc.) that do not have a defined and stable shape, but instead conform to the container in which they are held, e.g., a bag or other container. Formed building materials are also distinct from irregularly or imprecisely formed materials (e.g., aggregate, bulk forms for disposal, etc.) in that formed building materials are produced according to specifications that allow for use of formed building materials in, for example, buildings. Formed building materials may be prepared in accordance with traditional manufacturing protocols for such structures, with the exception that the composition of the invention is employed in making such materials.

In one aspect, there is provided a formed building material comprising the set and hardened form of the composition or the precipitation material of the invention where the reactive vaterite has converted to aragonite, described herein. In some embodiments, there is provided a method of a) contacting an aqueous solution comprising carbide lime with carbon dioxide from an industrial process; b) producing a precipitation material comprising reactive vaterite; c) setting and hardening the precipitation material by transforming the reactive vaterite to aragonite, and d) forming the formed building material. In some embodiments, in the foregoing methods, the step a) is conducted under precipitation conditions that favor the formation of reactive vaterite. Such precipitation conditions, that can be used in the foregoing method embodiments or the method embodiments described herein, suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc. In some embodiments, the foregoing methods further include before step a), a step of purifying carbide lime by treatment with weak base selected from borate, N-containing salt, N-containing aliphatic compound, N-containing aromatic compound, or combination thereof to make an aqueous solution comprising carbide lime. In some embodiments, the foregoing methods further include before step a), a step of purifying carbide lime by treatment with N-containing salt, to make an aqueous solution comprising carbide lime. In some embodiments, the N-containing salt includes, but not limited to, ammonium chloride, ammonium sulfate, ammonium nitrate, and the like. In some embodiments, in the foregoing methods, the precipitation material comprises at least 50% w/w, or at least 75% w/w, or at least 90% w/w, or at least 95% w/w, or at least 99% w/w, or between 50-99% w/w, or between 75-99% w/w, reactive vaterite. In some embodiments, in the foregoing methods, the molar ratio of the weak base, such as, borate, N-containing salt, N-containing aliphatic compound, N-containing aromatic compound:carbide lime, or N-containing salt:carbide lime is between 2:1 to 4:1 or 2:1 to 3:1 or 2.5:1 to 3:1, or 3:1 to 4:1, or 2:1, or 3:1, or 4:1. In some embodiments, in the foregoing methods, the average particle size of the reactive vaterite is between 1-50 microns, or 1-25 microns, or 5-50 microns, or 10-50 microns, or 5-25 microns, or 5-20 microns, or 15-20 microns, or 10-20 microns. In some embodiments, the foregoing methods further include adding one or more additives to the precipitation material at step a), b), c), and/or d). In some embodiments, in the foregoing methods, the one or more additives are alkaline earth metal ions selected from beryllium, magnesium, strontium, barium, or combination thereof. In some embodiments, the one or more additives are a salt of the ion including, but not limited to, magnesium, strontium, barium, sodium, potassium, chloride, bromide, iodide, etc. For example, the one or more additives added during the process are, but not limited to, magnesium chloride, magnesium bromide, magnesium iodide, strontium chloride, strontium bromide, strontium iodide, barium chloride, barium bromide, barium iodide, sodium chloride, sodium bromide, sodium iodide, potassium chloride, potassium bromide, potassium iodide, etc. In some embodiments, in the foregoing methods, the amount of the one or more additives added during the process is more than 0.1% by weight, or more than 0.5% by weight, or more than 1% by weight, or more than 1.5% by weight, or more than 1.6% by weight, or more than 1.7% by weight, or more than 1.8% by weight, or more than 1.9% by weight, or more than 2% by weight, or more than 2.1% by weight, or more than 2.2% by weight, or more than 2.3% by weight, or more than 2.4% by weight, or more than 2.5% by weight, or more than 2.6% by weight, or more than 2.7% by weight, or more than 2.8% by weight, or more than 2.9% by weight, or more than 3% by weight, or more than 3.5% by weight, or more than 4% by weight, or more than 4.5% by weight, or more than 5% by weight, or between 0.5-3% by weight, or 0.5-2% by weight, or 0.5-1% by weight, or 1-3% by weight, or 1-2.5% by weight, or 1-2% by weight, or 1.5-2.5% by weight, or 2-3% by weight, or 2.5-3% by weight, or 0.5% by weight, or 1% by weight, or 1.5% by weight, or 2% by weight, or 2.5% by weight, or 3% by weight, or 3.5% by weight, or 4% by weight, or 4.5% by weight, or 5% by weight. In some embodiments, in the foregoing methods, the amount of the one or more additives added during the process is between 0.5-5% by weight, or 0.5-3% by weight, or 1.5-2.5% by weight.

In some embodiments, the formed building materials made from the composition of the invention have a compressive strength of at least 3 MPa, at least 10 MPa, or at least 14 MPa, or between 3-30 MPa, or between about 14-100 MPa, or between about 14-45 MPa; or the compressive strength of the composition of the invention after setting, and hardening, as described herein. In some embodiments, the formed building materials made from the composition of the invention have a δ¹³C of less than −12%; or between −12% to −30%; or less than −13%; or less than −14%; or less than −15%; or from −15% to −80%; or the δ¹³C of the composition of the invention, as described herein.

Examples of the formed building materials that can be produced by the foregoing methods, include, but not limited to, masonry units, for example only, bricks, blocks, and tiles including, but not limited to, ceiling tiles; construction panels, for example only, cement board (boards traditionally made from cement) and/or drywall (boards traditionally made from gypsum); conduits; basins; beam; column, slab; acoustic barrier; insulation material; or combinations thereof. Construction panels are formed building materials employed in a broad sense to refer to any non-load-bearing structural element that are characterized such that their length and width are substantially greater than their thickness. As such the panel may be a plank, a board, shingles, and/or tiles. Exemplary construction panels formed from the compositions of the invention include cement boards and/or drywall. Construction panels are polygonal structures with dimensions that vary greatly depending on their intended use. The dimensions of construction panels may range from 50 to 500 cm in length, including 100 to 300 cm, such as 250 cm; width ranging from 25 to 200 cm, including 75 to 150 cm, such as 100 cm; thickness ranging from 5 to 25 mm, including 7 to 20 mm, including 10 to 15 mm.

In some embodiments, the cement board and/or the drywall may be used in making different types of boards such as, but not limited to, paper-faced board (e.g. surface reinforcement with cellulose fiber), fiberglass-faced or glass mat-faced board (e.g. surface reinforcement with glass fiber mat), fiberglass mesh reinforced board (e.g. surface reinforcement with glass mesh), and/or fiber-reinforced board (e.g. cement reinforcement with cellulose, glass, fiber etc.). These boards may be used in various applications including, but not limited to, fiber-cement sidings, roofing, soffit, sheathing, cladding, decking, ceiling, shaft liner, wall board, backer, and/or underlayment.

Table I below shows various combinations of the cement boards and drywall in making various boards products that can be used in various applications. All of such combination are well within the scope of the invention and represent individual embodiments. For example, the drywall product made from the composition of the invention may be formed as a fiber-reinforced board which may be used in one or more of the applications, including but not limited to, fiber-cement sidings, roofing, soffit, sheathing, cladding, decking, ceiling, shaft liner, wall board, backer, and/or underlayment.

TABLE I

| | Construction panel | | | | | |
|---|---|---|---|---|---|---|
| | Drywall | | | | Cement board | |
| | | fiberglass- | fiberglass | | fiberglass | |
| | paper- | faced or glass | mesh | fiber- | mesh | fiber- |
| | faced | mat-faced | reinforced | reinforced | reinforced | reinforced |
| Applications | board | board | board | board | board | board |
| fiber-cement sidings | X | X | X | X | X | X |
| roofing | X | X | X | X | X | X |
| soffit | X | X | X | X | X | X |
| sheathing | X | X | X | X | X | X |
| cladding | X | X | X | X | X | X |
| decking | X | X | X | X | X | X |
| ceiling | X | X | X | X | X | X |
| shaft liner | X | X | X | X | X | X |
| wall board | X | X | X | X | X | X |
| backer | X | X | X | X | X | X |
| underlayment | X | X | X | X | X | X |

The cement boards traditionally are made from cement such as Ordinary Portland cement (OPC), magnesium oxide cement and/or calcium silicate cement. The cement boards made by the methods of the invention are made from the carbonate precipitation material that partially or wholly replaces the traditional cement in the board. There is provided a method of forming a cement board, comprising a) contacting an aqueous solution comprising carbide lime with carbon dioxide from an industrial process under one or more precipitation conditions; b) producing a precipitation material comprising reactive vaterite; c) setting and hardening the precipitation material by transforming the reactive vaterite to aragonite, and d) forming the cement board. The above recited method may further comprise adding an admixture to the precipitation material, such as fiber and/or fiber glass. In some embodiments, the cement boards formed by the methods of the invention may comprise construction panels prepared as a combination of aragonitic cement (setting and hardening when vaterite transforms to aragonite) and fiber and/or fiberglass and may possess additional fiber and/or fiberglass reinforcement at both faces of the board.

The cement boards are formed building materials which in some embodiments, are used as backer boards for ceramics that may be employed behind bathroom tiles, kitchen counters, backsplashes, etc. and may have lengths ranging from 100 to 200 cm, such as 125 to 175 cm, e.g., 150 to 160 cm; a breadth ranging from 75 to 100 cm, such as 80 to 100 cm, e.g., 90 to 95 cm, and a thickness ranging from 5 to 25 mm, e.g., 5 to 15 mm, including 5 to 10 mm. Cement boards of the invention may vary in physical and mechanical properties. In some embodiments, the flexural strength may vary, ranging between 1 to 7.5 MPa, including 2 to 6 MPa, such as 5 MPa. The compressive strengths may also vary, ranging from 5 to 50 MPa, including 10 to 30 MPa, such as 15 to 20 MPa. In some embodiments of the invention, cement boards may be employed in environments having extensive exposure to moisture (e.g., commercial saunas). The maximum water absorption of the cement boards of the invention may vary, ranging from 5 to 15% by weight, including 8 to 10%, such as 9%. Cement boards formed from the compositions of the invention may also undergo moisture movement (expansion or contraction) due to the absorption or loss of water to its environment. The dimensional stability (i.e., linear shrinkage or expansion) due to moisture movement may vary, in certain instances ranging from 0.035 to 0.1%, including 0.04 to 0.08%, such as 0.05 to 0.06%. The composition of the invention may be used to produce the desired shape and size to form a cement board. In addition, a variety of further components may be added to the cement boards which include, but are not limited to, plasticizers, clay, foaming agents, accelerators, retarders and air entrainment additives. The composition is then poured out into sheet molds or a roller may be used to form sheets of a desired thickness. The shaped composition may be further compacted by roller compaction, hydraulic pressure, vibrational compaction, or resonant shock compaction. The sheets are then cut to the desired dimensions of the cement boards. In some instances, the resultant composition may also be foamed using mechanically or chemically introduced gases prior to being shaped or while the composition is setting in order to form a lightweight cement board. The shaped composition is then allowed to set and further cured in an environment with a controlled temperature and humidity. The cement boards formed from the compositions of the invention then may be covered in a fiberglass mat on both faces of the board. Where desired, the cement boards formed from the compositions of the invention may also be prepared using chemical admixtures such that they possess increased fire, water, and frost resistance as well as resistance to damage by bio-degradation and corrosion. The cement board may also be combined with components such as dispersed glass fibers, which may impart improved durability, increased flexural strength, and a smoother surface.

Another type of construction panel formed from the compositions of the invention is backer board. The backer board may be used for the construction of interior, and/or exterior floors, walls and ceilings. In the embodiments of the invention, the backer board is made partially or wholly from the carbonate precipitation material. In some embodiments, there is provided a method of forming backer board, comprising a) contacting an aqueous solution comprising carbide lime with carbon dioxide from an industrial process under one or more precipitation conditions; b) producing a precipitation material comprising reactive vaterite; c) setting and hardening the precipitation material by transforming the reactive vaterite to aragonite, and d) forming the backer board. In some embodiments, the above recited method does not include adding gypsum. The above recited method may further comprise adding an admixture to the precipitation material, such as fiber, cellulose, glass, and/or fiber glass. In some embodiments, the backer board formed by the methods of the invention may comprise construction panels prepared as a combination of aragonitic cement (setting and hardening when vaterite transforms to aragonite) and cellulose, fiber and/or fiberglass and may possess additional paper, fiber, fiberglass mesh and/or fiberglass mat reinforcement at both faces of the board.

Another type of construction panel formed from the compositions of the invention is drywall. The “drywall” as used herein, includes board that is used for construction of interior, and/or exterior floors, walls and ceilings. Traditionally, drywall is made from gypsum (called paper-faced board). In the embodiments of the invention, the drywall is made partially or wholly from the carbonate precipitation material thereby replacing gypsum from the drywall product. In some embodiments, there is provided a method of forming drywall, comprising a) contacting an aqueous solution comprising carbide lime with carbon dioxide from an industrial process; b) producing a precipitation material comprising reactive vaterite; c) setting and hardening the precipitation material by transforming the reactive vaterite to aragonite, and d) forming the drywall. In some embodiments, the above recited method does not include adding gypsum. The above recited method may further comprise adding an admixture to the precipitation material, such as fiber, cellulose, glass, and/or fiber glass. In some embodiments, the drywall formed by the methods of the invention may comprise construction panels prepared as a combination of aragonitic cement (setting and hardening when vaterite transforms to aragonite) and cellulose, fiber and/or fiberglass and may possess additional paper, fiber, fiberglass mesh and/or fiberglass mat reinforcement at both faces of the board. Various processes for making the drywall product are well known in the art and are well within the scope of the invention. Some examples include, but not limited to, wet process, semi dry process, extrusion process, Wonderborad® process, etc., that have been described herein.

In some embodiments, in the foregoing methods, the step a) is conducted under one or more precipitation conditions that favor the formation of reactive vaterite. Such precipitation conditions, that can be used in the foregoing method embodiments or the method embodiments described herein, suitable to form reactive vaterite containing carbonate precipitation material include, but are not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc. In some embodiments, the foregoing methods further include before step a), a step of purifying carbide lime by treatment with weak base selected from borate, N-containing salt, N-containing aliphatic compound, N-containing aromatic compound, or combination thereof to make an aqueous solution comprising carbide lime. In some embodiments, the foregoing methods further include before step a), a step of purifying carbide lime by treatment with N-containing salt, to make an aqueous solution comprising carbide lime. In some embodiments, the N-containing salt includes, but not limited to, ammonium chloride, ammonium sulfate, ammonium nitrate, and the like. In some embodiments, in the foregoing methods, the precipitation material comprises at least 50% w/w, or at least 75% w/w, or at least 90% w/w, or at least 95% w/w, or at least 99% w/w, or between 50-99% w/w, or between 75-99% w/w, reactive vaterite. In some embodiments, in the foregoing methods, the molar ratio of the weak base, such as, borate, N-containing salt, N-containing aliphatic compound, N-containing aromatic compound:carbide lime, or N-containing salt:carbide lime is between 2:1 to 4:1 or 2:1 to 3:1 or 2.5:1 to 3:1, or 3:1 to 4:1, or 2:1, or 3:1, or 4:1. In some embodiments, in the foregoing methods, the average particle size of the reactive vaterite is between 1-50 microns, or 1-25 microns, or 5-50 microns, or 10-50 microns, or 5-25 microns, or 5-20 microns, or 15-20 microns, or 10-20 microns. In some embodiments, the foregoing methods further include adding one or more additives to the precipitation material at step a), b), c), and/or d). In some embodiments, in the foregoing methods, the one or more additives are alkaline earth metal ions selected from beryllium, magnesium, strontium, barium, or combination thereof. In some embodiments, the one or more additives are a salt of the ion including, but not limited to, magnesium, strontium, barium, sodium, potassium, chloride, bromide, iodide, etc. For example, the one or more additives added during the process are, but not limited to, magnesium chloride, magnesium bromide, magnesium iodide, strontium chloride, strontium bromide, strontium iodide, barium chloride, barium bromide, barium iodide, sodium chloride, sodium bromide, sodium iodide, potassium chloride, potassium bromide, potassium iodide, etc. In some embodiments, in the foregoing methods, the amount of the one or more additives added during the process is more than 0.1% by weight, or more than 0.5% by weight, or more than 1% by weight, or more than 1.5% by weight, or more than 1.6% by weight, or more than 1.7% by weight, or more than 1.8% by weight, or more than 1.9% by weight, or more than 2% by weight, or more than 2.1% by weight, or more than 2.2% by weight, or more than 2.3% by weight, or more than 2.4% by weight, or more than 2.5% by weight, or more than 2.6% by weight, or more than 2.7% by weight, or more than 2.8% by weight, or more than 2.9% by weight, or more than 3% by weight, or more than 3.5% by weight, or more than 4% by weight, or more than 4.5% by weight, or more than 5% by weight, or between 0.5-3% by weight, or 0.5-2% by weight, or 0.5-1% by weight, or 1-3% by weight, or 1-2.5% by weight, or 1-2% by weight, or 1.5-2.5% by weight, or 2-3% by weight, or 2.5-3% by weight, or 0.5% by weight, or 1% by weight, or 1.5% by weight, or 2% by weight, or 2.5% by weight, or 3% by weight, or 3.5% by weight, or 4% by weight, or 4.5% by weight, or 5% by weight. In some embodiments, in the foregoing methods, the amount of the one or more additives added during the process is between 0.5-5% by weight, or 0.5-3% by weight, or 1.5-2.5% by weight.

The inner core of drywall of the invention may include at least some amount of or made wholly from the aragonitic precipitation material (vaterite transformed to aragonite) of the invention. In some embodiments, the drywall may be panels made solely from the compositions of the invention without the need for a paper liner around the core. In one aspect, there is provided a drywall product comprising aragonite, wherein the aragonite has δ¹³C value between −12% to −35%, wherein the density of the drywall product is between 0.4-1 g/cm³ or between 0.4-0.8 g/cm³, wherein the porosity of the drywall is between 50-90 vol % or between 75-90 vol %, and wherein the compressive strength of the drywall product is between 200-2500 psi or between 200-2000 psi or between 200-1000 psi.

In some embodiments, the drywall is panel made of a paper liner wrapped around an inner core. For example, in some embodiments, during the process of making the drywall product from the precipitation material, the slurry of the precipitation material comprising vaterite is poured over a sheet of paper. Another sheet of paper is then put on top of the precipitation material such that the precipitation material is flanked by the paper on both sides (the resultant composition sandwiched between two sheets of outer material, e.g., heavy paper or fiberglass mats). The vaterite in the precipitation material is then transformed to aragonite (using additives and/or heat) which then sets and hardens. When the core sets and is dried in a large drying chamber, the sandwich becomes rigid and strong enough for use as a building material. The drywall sheets are then cut and separated. In some embodiments, the methods of the invention are also used to make the paper from the precipitation material of the invention. The paper is then used to make the paper liner for the drywall product also made from the precipitation material of the invention. Without being limited by any theory, it is contemplated that the aragonitic microstructure of the paper made from the precipitation material of the invention, may provide aragonite seeding to the poured precipitation material and may lead to greater bonding and adhesion of the paper with the material as well as may cause facilitation of the transformation of the vaterite to aragonite. The formation of the paper from the reactive vaterite is being described in detail in application with Attorney Docket No. CLRA-082, filed on even date herewith, which is incorporated herein by reference in its entirety in the present disclosure.

The dimensions of the drywall building materials of the invention may vary, in certain instances ranging from 100 to 200 cm, such as 125 to 175 cm, e.g., 150 to 160 cm in length; ranging from 75 to 100 cm, such as 80 to 100 cm, e.g., 90 to 95 cm in breadth, and ranging from 5 to 50 mm, e.g., 5 to 30 mm, including 10 to 25 mm in thickness. The flexural and compressive strengths of drywall provided by the invention are equal to or higher than conventional drywall prepared with gypsum plaster, which is known to be a soft construction material. In some embodiments, the flexural strength may range between 0.1 to 3 MPa, including 0.5 to 2 MPa, such as 1.5 MPa. The compressive strengths may also vary, in some instances ranging from 1 to 20 MPa, including 5 to 15 MPa, such as 8 to 10 MPa. The maximum water absorption of drywall of the invention may vary, ranging from 2 to 10% by mass, including 4 to 8%, such as 5%. In certain embodiments, the inner core may be analogous to a conventional drywall core which is made primarily from gypsum plaster (the semi-hydrous form of calcium sulfate (CaSO₄.½H₂O), with at least a portion of or whole of the gypsum component replaced with the aragonitic material of the invention. In addition, the core may include a variety of further components, such as, but not limited to, fibers (e.g., paper and/or fiberglass), clay, plasticizers, foaming agents, accelerators, e.g., potash, retarders, e.g., EDTA or other chelators, various additives that may increase mildew and fire resistance (e.g., fiberglass or vermiculite), and may reduce density by increasing porosity.

In some embodiments, the formed building materials such as, the construction panels such as, but not limited to, cement boards and drywall (as shown in table I above) produced by the methods described herein, have low density and high porosity making them suitable for lightweight and insulation applications. The high porosity and light weight of the formed building materials such as construction panels may be due to the development of the aragonitic microstructure when vaterite transforms to aragonite. The transformation of vaterite during dissolution/re-precipitation process may lead to micro porosity generation while at the same time the voids created between the aragonitic crystals formed may provide nano porosity thereby leading to highly porous and light weight structure. Certain admixtures may be added during the transformation process such as, but not limited to, foaming agents, rheology modifiers and mineral extenders, such as, but not limited to, clay, starch, etc. which may add to the porosity in the product as the foaming agent may entrain air in the mixture and lower the overall density and mineral extender such as sepiolite clay may increase the viscosity of the mixture thereby preventing segregation of the precipitation material and water (as illustrated in Example 3). In some embodiments, the methods provided herein produce formed building material, such as drywall or cement boards that has a porosity of between 20-90%, or between 20-80%, or between 20-60%, or between 20-50%, or between 20-40%, or between 30-90%, or between 30-80%, or between 30-60%, or between 40-90%, or between 40-80%, or between 40-60%, or between 50-90%, or between 50-75%, or between 60-90%, or between 70-90%, or between 75-90%, or between 80-90%, by volume.

One of the applications of the cement board or drywall is fiber cement siding. Fiber-cement sidings formed by the methods of the invention comprise construction panels prepared as a combination of aragonitic cement, aggregate, interwoven cellulose, and/or polymeric fibers and may possess a texture and flexibility that resembles wood. Fiber-cement sidings formed from the compositions of the invention are formed building materials used to cover the exterior or roofs of buildings and include, but are not limited to, building sheets, roof panels, ceiling panels, eternits, and the like. They may also find use as a substitute for timber fascias and barge boards in high fire areas. Fiber-cement sidings may have dimensions that vary, ranging from 200 to 400 cm in length, e.g., 250 cm and 50 to 150 cm in width, e.g., 100 cm and a thickness ranging from 4 to 20 mm, e.g., 5 to 15 mm, including 10 mm. Fiber-cement sidings formed from the compositions of the invention may possess physical and mechanical properties that vary. In some embodiments, the flexural strength may range between 0.5 to 5 MPa, including 1 to 3 MPa, such as 2 MPa. The compressive strengths may also vary, in some instances ranging from 2 to 25 MPa, including 10 to 15 MPa, such as 10 to 12 MPa. In some embodiments of the invention, fiber-cement sidings may be employed on buildings that are subject to varying weather conditions, in some embodiments ranging from extremely arid to wet (i.e., low to high levels of humidity). Accordingly, the maximum water absorption of the fiber-cement sidings of the invention may vary, ranging from 10 to 25% by mass, including 10 to 20%, such as 12 to 15%. The dimensional stability (i.e., linear shrinkage or expansion) due to moisture movement may vary, in certain instances ranging from 0.05 to 0.1%, including 0.07 to 0.09%. The composition of the invention may be used to produce the desired shape and size to form a fiber-cement siding. In addition, a variety of further components may be added to the fiber-cement sidings which include, but not limited to, cellulose, fibers, plasticizers, foaming agents, accelerators, retarders and air entrainment additives. The composition is then poured into sheet molds or a roller is used to form sheets of a desired thickness. The shaped composition may be further compacted by roller compaction, hydraulic pressure, vibrational compaction, or resonant shock compaction. The sheets are then cut to the desired dimensions of the fiber-cement sidings. In some instances, the resultant composition may also be foamed using mechanically or chemically introduced gases prior to being shaped or while the composition is setting in order to form a lightweight fiber-cement siding. The shaped composition is then allowed to set and further cured in an environment with a controlled temperature and humidity. The fiber-cement sidings of the invention may then be covered with a polymeric film, enamel or paint. Where desired, the fiber-cement sidings formed from the compositions of the invention may also be prepared using chemical admixtures such that they possess increased fire, water, and frost resistance as well as resistance to damage by bio-degradation and corrosion.

In some embodiments, the formed building materials are masonry units. Masonry units are formed building materials used in the construction of load-bearing and non-load-bearing structures that are generally assembled using mortar, grout, and the like. Exemplary masonry units formed from the compositions of the invention include bricks, blocks, and tiles. Bricks and blocks of the invention are polygonal structures possessing linear dimensions. Any unit with dimensions (mm) between 337.5×225×112.5 to 2000×1000×500 (length×width×depth) is termed a “block.” Structural units with dimensions (mm) exceeding 2000×1000×500 (length×width×depth) are termed “slabs.” Tiles refer to masonry units that possess the same dimensions as bricks or blocks, but may vary considerably in shape, i.e., may not be polygonal (e.g., hacienda-style roof tiles). One type of masonry unit provided by the invention is a brick, which refers to a structural unit of material used in masonry construction, generally laid using mortar. Bricks may vary in grade, class, color, texture, size, weight and can be solid, cellular, perforated, frogged, or hollow. Bricks formed from the compositions of the invention may include, but are not limited to, building brick, facing brick, load bearing brick, engineering brick, thin veneer brick, paving brick, glazed brick, firebox brick, chemical resistant brick, sewer and manhole brick, industrial floor brick, etc. The bricks may also vary in frost resistance (i.e., frost resistant, moderately frost resistant or non frost resistant), which relates to the durability of bricks in conditions where exposure to water may result in different levels of freezing and thawing. The compressive strength of bricks formed from the compositions of the invention may range, in certain instances, from 5 to 100 MPa; or 20-100 MPa; or 50-100 MPa; or 80-100 MPa; or 20-80 MPa; or 20-40 MPa; or 60-80 MPa. The flexural strength of bricks formed from the compositions of the invention may vary, ranging from 0.5 to 10 MPa, including 2 to 7 MPa, such as 2 to 5 MPa. The composition of the invention may be molded, extruded, or sculpted into the desired shape and size to form a brick. The shaped composition is then dried and further hardened by hydraulic pressure, autoclave or fired in a kiln at temperatures ranging between 900° to 1200° C., such as 900° to 1100° C. and including 1000° C. Another type of masonry unit provided by the invention is blocks, (e.g., concrete, cement, foundation, etc.). Blocks are distinct from bricks based on their structural dimensions. Blocks formed from the compositions of the invention may vary in color, texture, size, and weight and can be solid, cellular, and hollow or employ insulation (e.g., expanded polystyrene foam) in the block void volume. Blocks may be load-bearing, non-load-bearing or veneer (i.e., decorative) blocks. The compressive strength of blocks may vary, in certain instances ranging from 5 to 100 MPa, including 15 to 75 MPa, such as 20 to 40 MPa. The flexural strength of blocks formed from the compositions of the invention may also vary, ranging from 0.5 to 15 MPa, including 2 to 10 MPa, such as 4 to 6 MPa. The composition of the invention may be molded, extruded, or sculpted into the desired shape and size to form a block. The shaped composition may be further compacted by roller compaction, hydraulic pressure, vibrational compaction, or resonant shock compaction. Another type of building material provided by the invention is a tile. Tiles formed from the compositions of the invention refer to non-load-bearing building materials that are commonly employed on roofs, ceilings, and to pave exterior and interior floors of commercial and residential structures. The tile may also be used as a ceiling tile. In some embodiments, there is provide a method of forming ceiling tile, comprising a) contacting an aqueous solution comprising carbide lime with carbon dioxide from an industrial process under one or more precipitation conditions; b) producing a precipitation material comprising reactive vaterite; c) setting and hardening the precipitation material by transforming the reactive vaterite to aragonite, and d) forming the ceiling tile.

Some examples where tiles may be employed include, but are not limited to, the roofs of commercial and residential buildings, decorative patios, bathrooms, saunas, kitchens, building foyer, driveways, pool decks, porches, walkways, sidewalks, ceiling, and the like. Tiles may take on many forms depending on their intended use and/or intended geographical location of use, varying in shape, size, weight, and may be solid, webbed, cellular or hollow. The compressive strengths of tiles formed from the compositions of the invention may also vary, in certain instances ranging from 5 to 75 MPa, including 15 to 40 MPa, such as 25 MPa. The flexural strength of tiles formed from the compositions of the invention may vary, ranging from 0.5 to 7.5 MPa, including 2 to 5 MPa, such as 2.5 MPa. As such, the composition of the invention may be molded or cast into the desired tile shape and size. The shaped composition may be further compacted by roller compaction, hydraulic pressure, vibrational compaction, or resonant shock compaction. The resultant composition may also be poured out into sheets or a roller may be used to form sheets of a desired thickness. The sheets are then cut to the desired dimensions of the tiles. Tiles may be further polished, colored, textured, shot blasted, inlaid with decorative components and the like.

Another formed building material formed from the compositions of the invention is a conduit. Conduits are tubes or analogous structures configured to convey a gas or liquid, from one location to another. Conduits of the invention can include any of a number of different structures used in the conveyance of a liquid or gas that include, but are not limited to, pipes, culverts, box culverts, drainage channels and portals, inlet structures, intake towers, gate wells, outlet structures, and the like. Conduits of the invention may vary considerably in shape, which is generally determined by hydraulic design and installation conditions. Shapes of conduits of the invention may include, but are not limited to circular, rectangular, oblong, horseshoe, square, etc. In certain embodiments, conduits may be designed in order to support high internal pressure from water flow within the conduit. In yet other embodiments, conduits formed from the compositions of the invention may be designed to support high external loadings (e.g., earth loads, surface surcharge loads, vehicle loads, external hydrostatic pressures, etc.). Accordingly, the compressive strength of the walls of conduits of the invention may also vary, depending on the size and intended use of the conduit, in some instances ranging, from 5 to 75 MPa, such as 10 to 50 MPa, e.g., 15 to 40 MPa. In producing conduits of the invention, the composition after combining with water is poured into a mold in order to form the desired conduit shape and size. The shaped composition may be further compacted by roller compaction, hydraulic pressure, vibrational compaction, or resonant shock compaction. The shaped composition is further allowed to set and is cured in an environment with a controlled temperature and humidity. In addition, the conduits of the invention may include a variety of further components, such as, but not limited to, plasticizers, foaming agents, accelerators, retarders and air entrainment additives. Where desired, the further components may include chemical admixtures such that the conduits of the invention possess increased resistance to damage by bio-degradation, frost, water, fire and corrosion. In some embodiments, the conduits formed from the compositions of the invention may employ structural support components such as, but not limited to, cables, wires and mesh composed of steel, polymeric materials, ductile iron, aluminum or plastic.

Another formed building material formed from the compositions of the invention is basins. The term basin may include any configured container used to hold a liquid, such as water. As such, a basin may include, but is not limited to structures such as wells, collection boxes, sanitary manholes, septic tanks, catch basins, grease traps/separators, storm drain collection reservoirs, etc. Basins may vary in shape, size, and volume capacity. Basins may be rectangular, circular, spherical, or any other shape depending on its intended use. In some embodiments, basins may possess a greater width than depth, becoming smaller toward the bottom. The dimensions of the basin may vary depending on the intended use of the structure (e.g., from holding a few gallons of liquid to several hundred or several thousand or more gallons of liquid). The wall thicknesses may vary considerably, ranging in certain instances from 0.5 to 25 cm or thicker, such as 1 to 15 cm, e.g., 1 to 10 cm. Accordingly, the compressive strength may also vary considerably, depending on the size and intended use of the basin, in some instances ranging, from 5 to 60 MPa, such as 10 to 50 MPa, e.g., 15 to 40 MPa. In some embodiments, the basin may be designed to support high external loadings (e.g., earth loads, surface surcharge loads, vehicle loads, etc.). In certain other embodiments, the basins may be employed with various coatings or liners (e.g., polymeric), and may be configured so that they may be combined with conveyance elements (e.g., drainage pipe). In other embodiments, basins may be configured so that they may be connected to other basins so that they may form a connected series of basins. In producing basins, the composition after combining with water may be poured into a mold to form the desired basin shape and size. The shaped composition may be further compacted by roller compaction, hydraulic pressure, vibrational compaction, or resonant shock compaction. The basins may also be prepared by pouring the composition into sheet molds and the basins further assembled by combining the sheets together to form basins with varying dimensions (e.g., polygonal basins, rhomboidal basins, etc.). In some instances, the resultant composition may also be foamed using mechanically or chemically introduced gases prior to being shaped or while the composition is setting in order to form a lightweight basin structure. The shaped composition is further allowed to set and is cured in an environment with a controlled temperature and humidity. In addition, the basins formed from the compositions of the invention may include a variety of further components, such as, but not limited to, plasticizers, foaming agents, accelerators, retarders and air entrainment additives. Where desired, the further components may include chemical admixtures such that the basins of the invention possess increased resistance to damage by bio-degradation, frost, water, fire and corrosion. In some embodiments, the basins of the invention may employ structural support components such as, but not limited to, cables, wires and mesh composed of steel, polymeric materials, ductile iron, aluminum or plastic.

Another formed building material formed from the compositions of the invention is a beam, which, in a broad sense, refers to a horizontal load-bearing structure possessing large flexural and compressive strengths. Beams may be rectangular cross-shaped, C-channel, L-section edge beams, I-beams, spandrel beams, H-beams, possess an inverted T-design, etc. Beams of the invention may also be horizontal load-bearing units, which include, but are not limited to joists, lintels, archways and cantilevers. Beams generally have a much longer length than their longest cross-sectional dimension, where the length of the beam may be 5-fold or more, 10-fold or more, 25-fold or more, longer than the longest cross-sectional dimension. Beams formed from the compositions of the invention may vary in their mechanical and physical properties. For example, unreinforced concrete beams may possess flexural capacities that vary, ranging from 2 to 25 MPa, including 5 to 15 MPa, such as 7 to 12 MPa and compressive strengths that range from 10 to 75 MPa, including 20 to 60 MPa, such as 40 MPa. Structurally reinforced concrete beams may possess considerably larger flexural capacities, ranging from 15 to 75 MPa, including as 25 to 50 MPa, such as 30 to 40 MPa and compressive strengths that range from 35 to 150 MPa, including 50 to 125 MPa, such as 75 to 100 MPa. The beams formed from the compositions of the invention may be internal or external, and may be symmetrically loaded or asymmetrically loaded. In some embodiments, beams may be composite, wherein it acts compositely with other structural units by the introduction of appropriate interface shear mechanisms. In other embodiments, beams may be non-composite, wherein it utilizes the properties of the basic beam alone. In producing beams of the invention, the composition of the invention after mixing with water may be poured into a beam mold or cast around a correlated steel reinforcing beam structure (e.g., steel rebar). In some embodiments, the steel reinforcement is pretensioned prior to casting the composition around the steel framework. In other embodiments, beams of the invention may be cast with a steel reinforcing cage that is mechanically anchored to the concrete beam. The beams of the invention may also employ additional structural support components such as, but not limited to cables, wires and mesh composed of steel, ductile iron, polymeric fibers, aluminum or plastic. The structural support components may be employed parallel, perpendicular, or at some other angle to the carried load. The molded or casted composition may be further compacted by roller compaction, hydraulic pressure, vibrational compaction, or resonant shock compaction. The composition is further allowed to set and is cured in an environment with a controlled temperature and humidity. In addition, the beams of the invention may include a variety of further components, such as but not limited to, plasticizers, foaming agents, accelerators, retarders and air entrainment additives. Where desired, the further components may include chemical admixtures such that the beams of the invention possess increased resistance to damage by bio-degradation, frost, water, fire and corrosion.

Another formed building material formed from the compositions of the invention is a column, which, in a broad sense, refers to a vertical load-bearing structure that carries loads chiefly through axial compression and includes structural elements such as compression members. Other vertical compression members of the invention may include, but are not limited to pillars, piers, pedestals, or posts. Columns formed from the compositions of the invention may be rigid, upright supports, composed of relatively few pieces. Columns may also be decorative pillars having a cylindrical or polygonal, smooth or fluted, tapered or straight shaft with a capital and usually a base, among other configurations. The capital and base of the column may have a similar shape as the column or may be different. Any combination of shapes for the capital and base on a column are possible. Polygonal columns formed from the compositions of the invention possess a width that is not more than four times its thickness. Columns formed from the compositions of the invention may be constructed such that they are solid, hollow (e.g., decorative columns), reinforcement filled, or any combination thereof. Columns can be short columns (i.e., columns where strength is governed by construction components and the geometry of its cross section) or slender columns (i.e., cross-sectional dimensions that are less than 5 times its length). The dimensions of the column may vary greatly depending on the intended use of the structure, e.g., from being less than a single story high, to several stories high or more, and having a corresponding width. Columns may vary in their mechanical and physical properties. Properties such as compressive and flexural strengths may vary depending on the design and intended use of the column. For example, unreinforced concrete columns may possess flexural strengths that range from 2 to 20 MPa, including 5 to 15 MPa, such as 7 to 12 MPa and compressive strengths that range from 10 to 100 MPa, including 25 to 75 MPa, such as 50 MPa. Structurally reinforced concrete columns of the invention may possess considerably larger flexural strengths, ranging from 15 to 50 MPa, including 20 to 40 MPa, such as 25 to 35 MPa and compressive strengths that range from 25 to 200 MPa, including 50 to 150 MPa, such as 75 to 125 MPa. In some embodiments, columns may be composite, wherein it may act compositely with other structural units by the introduction of interfacial shear mechanisms. In other embodiments, columns may be non-composite, wherein it utilizes the properties of the basic column alone. In producing columns of the invention, the composition after combination with water may be poured into a column form or cast around a correlated steel reinforcing column structure (e.g., steel rebar). In some embodiments, the steel reinforcement is pre-tensioned prior to casting the composition around the steel framework. In other embodiments, columns of the invention may be cast with a steel reinforcing cage that is mechanically anchored to the concrete column. The columns of the invention may also employ additional structural support components such as, but not limited to, cables, wires and mesh composed of steel, ductile iron, polymeric fibers, aluminum or plastic. The structural support components may be employed parallel, perpendicular, or at some other angle to the carried load. The molded or casted composition may be further compacted by roller compaction, hydraulic pressure, vibrational compaction, or resonant shock compaction. The composition is further allowed to set and is cured in an environment with a controlled temperature and humidity. In addition, the columns of the invention may include a variety of additional components, such as but not limited to, plasticizers, foaming agents, accelerators, retarders and air entrainment additives. Where desired, these additional components may include chemical admixtures such that the columns of the invention possess increased resistance to damage by bio-degradation, frost, water, fire and corrosion.

Another formed building material formed from the compositions of the invention is a concrete slab. Concrete slabs are those building materials used in the construction of prefabricated foundations, floors and wall panels. In some instances, a concrete slab may be employed as a floor unit (e.g., hollow plank unit or double tee design). In other instances, a precast concrete slab may be a shallow precast plank used as a foundation for in-situ concrete formwork. Wall panels are, in a broad sense, vertical load-bearing members of a building that are polygonal and possess a width that is more than four times its thickness. Precast concrete foundation, floors and wall panels may vary considerably in dimension depending on the intended use of the precast concrete slab (e.g., one or two storey building). As such, precast concrete slabs may have dimensions which range from 1 to 10 m in length or longer, including 3 to 8 m, such as 5 to 6 m; height that ranges from 1 to 10 m or taller, including 4 to 10 m, such as 4 to 5 m; and a thickness that may range from 0.005 to 0.25 m or thicker, including 0.1 to 0.2 m such as 0.1 to 0.15 m. Formed building materials such as slabs, and structures made therefrom, may be thicker than corresponding structures that lack components of the composition of the invention. In addition, structures made from amorphous building materials formed from the composition of the invention may be thicker than corresponding structures that are not formed from the composition of the invention.

In some embodiments, thickness of formed building materials or related structures is increased by 1.5 fold or more, 2-fold or more, or 5-fold or more. Concrete slabs formed from the compositions of the invention may vary in their mechanical and physical properties depending on their intended use. For example, a prefabricated slab that is employed in a floor unit may possess larger flexural strengths and lesser compressive strengths than a slab that is employed as a load-bearing wall. For example, unreinforced concrete slabs may possess flexural strengths that vary, ranging from 2 to 25 MPa, including 5 to 15 MPa, such as 7 to 12 MPa and compressive strengths that range from 10 to 100 MPa, including 25 to 75 MPa, such as 50 MPa. Structurally reinforced concrete slabs of the invention may possess considerably larger flexural strengths, ranging from 15 to 50 MPa, including 20 to 40 MPa, such as 25 to 35 MPa and compressive strengths that range from 25 to 200 MPa, including 50 to 150 MPa, such as 75 to 125 MPa. In producing concrete slabs, the composition after combination with water may be poured into a slab mold or cast around a correlated steel reinforcing structure (e.g., steel rebar). In some embodiments, the steel reinforcement is pretensioned prior to casting the composition around the steel framework. In other embodiments, slabs of the invention may be cast with a steel reinforcing cage that is mechanically anchored to the concrete slab. In some embodiments, the concrete slabs of the invention may improve its structural capacity by casting a second, supportive concrete layer that is mechanically anchored to the previously precast concrete slab. The slabs formed from the compositions of the invention may also employ additional structural support components such as, but not limited to, cables, wires and mesh composed of steel, ductile iron, polymeric fibers, aluminum or plastic. The structural support components may be employed parallel, perpendicular, or at some other angle to the carried load. The molded or casted composition may be further compacted by roller compaction, hydraulic pressure, vibrational compaction, or resonant shock compaction. The composition is further allowed to set and is cured in an environment with a controlled temperature and humidity. In addition, the slabs of the invention may include a variety of further components, such as but not limited to, plasticizers, foaming agents, accelerators, retarders and air entrainment additives. Where desired, the further components may include chemical admixtures such that the slabs formed from the compositions of the invention possess increased resistance to damage by bio-degradation, frost, water, fire and corrosion.

Another formed building material formed from the compositions of the invention is an acoustic barrier, which refers to a structure used as a barrier for the attenuation or absorption of sound. As such, an acoustic barrier may include, but is not limited to, structures such as acoustical panels, reflective barriers, absorptive barriers, reactive barriers, etc. Acoustic barriers formed from the compositions of the invention may widely vary in size and shape. Acoustic barriers may be polygonal, circular, or any other shape depending on its intended use. Acoustic barrier may be employed in the attenuation of sound from highways, roadways, bridges, industrial facilities, power plants, loading docks, public transportation stations, military facilities, gun ranges, housing complexes, entertainment venues (e.g., stadiums, concert halls) and the like. Acoustic barriers may also be employed for sound insulation for the interior of homes, music studios, movie theaters, classrooms, etc. The acoustic barriers formed from the compositions of the invention may have dimensions that vary greatly depending on its intended use, ranging from 0.5 to 10 m in length or longer, e.g., 5 m and 0.1 to 10 m in height/width or wider, e.g., 5m and a thickness ranging from 10 to 100 cm, or thicker e.g., 25 to 50 cm, including 40 cm. Where desired, the acoustic barrier may be employed with various coatings or liners (e.g., polymeric), and may be configured for easy joining with each other or pillars separating additional acoustic barriers to produce long acoustic barrier structures made up of multiple acoustic barriers of the invention. In some embodiments, acoustic barriers formed from the compositions of the invention may employ sound absorptive material (e.g., wood shavings, textile fibers, glass wool, rock wool, polymeric foam, vermiculite, etc.) in addition to a structurally reinforcing framework. In some embodiments, acoustic barriers may be used as noise-reduction barriers in an outdoor environment (e.g., along a highway, near an airport, etc.) and may be employed with structural support components (e.g., columns, posts, beams, etc.). In producing acoustic barriers of the invention, the composition of the invention after combination with water is poured into a mold to form the desired acoustic barrier shape and size. Also the composition may be poured out into a sheet mold or a roller may be used to form sheets of a desired thickness. The shaped composition may be further compacted by roller compaction, hydraulic pressure, vibrational compaction, or resonant shock compaction. The sheets are then cut to the desired dimensions of the acoustic barriers. In some instances, the resultant composition may also be foamed using mechanically or chemically introduced gases prior to being shaped or while the composition is setting in order to form a lightweight acoustic panel structure. The shaped composition is further allowed to set and is cured in an environment with a controlled temperature and humidity. In addition, the acoustic barriers of the invention may include a variety of further components, such as but not limited to, plasticizers, foaming agents, accelerators, retarders and air entrainment additives. Where desired, the further components may include chemical admixtures such that they possess increased resistance to damage by bio-degradation, frost, water, fire and corrosion. In some embodiments, the acoustic barriers of the invention may employ structural support components such as, but not limited to, cables, wires and mesh composed of steel, ductile iron, polymeric fibers, aluminum or plastic.

Another formed building material formed from the compositions of the invention is an insulation material, which refers to a material used to attenuate or inhibit the conduction of heat. Insulation may also include those materials that reduce or inhibit radiant transmission of heat. Insulation material may consist of one or more of the following constituents: a cementitious forming material, a dispersing agent, an air entraining agent, inert densifying particulate, a mixture of ionic and non-ionic surfactants, plasticizers, accelerators, lightweight aggregate, organic and inorganic binding agents and glass particles. In certain embodiments of the invention, an amount of cementitious forming material may be replaced by the above described composition of the invention. Binding compositions for the insulation material of the invention include a component selected from the group consisting of carbides, Gypsum powder, Blakite, nitrides, calcium carbonate, oxides, titanates, sulfides, zinc selenide, zinc telluride, inorganic siloxane compound and their mixtures thereof. In certain embodiments of the invention, an amount of the binding composition may be replaced by the above described composition of the invention. Where desired, insulation material of the invention may also be prepared using a chemical admixture or any other convenient protocol such that they are resistant to damage by termites, insects, bacteria, fungus. Etc. Insulation materials of the invention may be prepared using any convenient protocol such that they are freeze/thaw, rain and fire resistant. Insulation material of the invention may be prepared in accordance with traditional manufacturing protocols for such materials, with the exception that the composition of the invention is employed. In producing the insulation materials of the invention, an amount of the composition of the invention may be combined with water and other components of the insulation material, which may include, but are not limited to a dispersing agent, an air entraining agent, inert densifying particulate, a mixture of ionic and non-ionic surfactants, plasticizers, accelerators, lightweight aggregate, organic and inorganic binding agents and glass particles. The resultant insulation material may then be molded into the desired shape (e.g., wall panel) or poured into the void space of concrete masonry units, flooring units, roof decks or cast around pipes, conduits and basins.

In some embodiments, the other formed building materials such as pre-cast concrete products include, but not limited to, bunker silo; cattle feed bunk; cattle grid; agricultural fencing; H-bunks; J-bunks; livestock slats; livestock watering troughs; architectural panel walls; cladding (brick); building trim; foundation; floors, including slab on grade; walls; double wall precast sandwich panel; aqueducts; mechanically stabilized earth panels; box culverts; 3-sided culverts; bridge systems; RR crossings; RR ties; sound walls/barriers; Jersey barriers; tunnel segments; reinforced concrete box; utillity protection structure; hand holes; hollowcore product; light pole base; meter box; panel vault; pull box; telecom structure; transformer pad; transformer vault; trench; utility vault; utility pole; controlled environment vaults; underground vault; mausoleum; grave stone; coffin; haz mat storage container; detention vaults; catch basins; manholes; aeration system; distribution box; dosing tank; dry well; grease interceptor; leaching pit; sand-oil/oil-water interceptor; septic tank; water/sewage storage tank; wetwells; fire cisterns; floating dock; underwater infrastructure; decking; railing; sea walls; roofing tiles; pavers; community retaining wall; res. retaining wall; modular block systems; and segmental retaining walls.

### Non-Cementitious Compositions

In some embodiments, the methods described herein include making other products from the precipitated material of the invention including, but not limited to, non-cementitious compositions including paper, polymer product, lubricant, adhesive, rubber product, chalk, asphalt product, paint, abrasive for paint removal, personal care product, cosmetic, cleaning product, personal hygiene product, ingestible product, agricultural product, soil amendment product, pesticide, environmental remediation product, and combination thereof. Such compositions have been described in U.S. Pat. No. 7,829,053, issued Nov. 9, 2010, which is incorporated herein by reference in its entirety. The formation of the non-cementitious materials from the reactive vaterite is being described in application with Attorney Docket No. CLRA-082, filed on even date herewith, which is incorporated herein by reference in its entirety.

### Artificial Marine Structures

In some embodiments, the methods described herein include making artificial marine structures from the precipitated material of the invention including, but not limited to, artificial corals and reefs. In some embodiments, the artificial structures can be used in the aquariums or sea. In some embodiments, these products are made from the precipitated material comprising reactive vaterite that transforms to aragonite after setting and hardening. The aragonitic cement provides neutral or close to neutral pH which may be conducive for maintenance and growth of marine life. The aragonitic reefs may provide suitable habitat for marine species. In some embodiments, there is provided an artificial reef comprising aragonite, wherein the aragonite has δ¹³C value between −12% to −35%. In some embodiments, the density of the artificial reef is between 0.4-1.8 g/cm³, wherein the porosity of the artificial reef is between 50-90 vol %. In some embodiments, the compressive strength of the artificial reef is between 200-3000 psi.

### IV. Utility

Compositions of the invention find use in a variety of different applications, as reviewed above. The subject methods and systems find use in CO₂ sequestration, particularly via sequestration in a variety of diverse man-made products. The CO₂ sequestering includes the removal or segregation of CO₂ from a gaseous stream, such as a gaseous waste stream, and fixating it into a stable non-gaseous form so that the CO₂ cannot escape into the atmosphere. The CO₂ sequestration includes the placement of CO₂ into a storage stable form, where the CO₂ is fixed at least during the useful life of the composition. As such, sequestering of CO₂ according to methods of the invention results in prevention of CO₂ gas from entering the atmosphere and long term storage of CO₂ in a manner that CO₂ does not become part of the atmosphere.

### V. Packages

In one aspect, there is provided a package including the composition of the invention. In some embodiments, there is provided a package including a composition formed from the precipitation material of the invention. In some embodiments, there is provided a package including a product, such as but not limited to, building material, a formed building material, an artificial reef, and/or non-cementitious product formed from the precipitation material of the invention. The package further includes a packaging material that is adapted to contain the composition or the products. The package may contain one or more of such packaging materials. The packaging material includes, but is not limited to, metal container; sacks; bags such as, but not limited to, paper bags or plastic bags; boxes; silo such as, but not limited to, tower silo, bunker silo, bag silo, low level mobile silo, or static upright silo; and bins. It is understood that any container that can be used for carrying or storing the composition or the products made from the compositions of the invention is well within the scope of the invention. In some embodiments, these packages are portable. In some embodiments, these packages and/or packaging materials are disposable or recyclable. The packaging material are further adapted to store and/or preserve the composition or the products made from the composition of the invention for longer than few months to few years. In some embodiments, the packaging materials are further adapted to store and/or preserve the composition or the products made from the compositions of the invention for longer than 1 week, or longer than 1 month, or longer than 2 months, or longer than 5 months, or longer than 1 year, or longer than 2 years, or longer than 5 years, or longer than 10 years, or between 1 week to 1 year, or between 1 month to 1 year, or between 1 month to 5 years, or between 1 week to 10 years.

The following examples are put forth so as to provide those of ordinary skill in the art with a complete disclosure and description of how to make and use the invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

In the examples and elsewhere, abbreviations have the following meanings:

| | |
|---|---|
| g = | gram |
| Kg = | kilogram |
| kV = | kilovolt |
| L — | liter |
| M = | molar |
| mA = | milliamps |
| mg = | milligram |
| min. = | minute |
| mm = | millimeter |
| μm = | micrometer |
| MPa = | megapascal |
| Pa = | pascal |
| ppm = | parts per million |
| Psi = | pounds per square inch |
| rpm = | revolutions per minute |
| W/m/K = | Watts/meter/Kelvin |
| w/v = | weight/volume |
| w/w = | weight/weight |

### EXAMPLES

The following analytical instrumentations were used to characterize the precipitation material.

### Materials and Methods

Coulometer: Liquid and solid carbon-containing samples were acidified with 2.0 N perchloric acid (HClO₄) to evolve carbon dioxide gas into a carrier gas stream, and subsequently scrubbed with 3% w/v silver nitrate at pH 3.0 to remove any evolved sulfur gasses prior to analysis by an inorganic carbon coulometer (UIC Inc, model CM5015). For example, samples of cement are heated after addition of percholoric acid with a heated block to aid digestion of the sample.

Brunauer-Emmett-Teller (“BET”) Specific Surface Area: Specific surface area (SSA) measurement was by surface absorption with dinitrogen (BET method). SSA of dry samples was measured with a Micromeritics Tristar™ II 3020 Specific Surface Area and Porosity Analyzer after preparing the sample with a Flowprep™ 060 sample degas system. Briefly, sample preparation involved degassing approximately 1.0 g of dry sample at an elevated temperature while exposed to a stream of dinitrogen gas to remove residual water vapor and other adsorbents from the sample surfaces. The purge gas in the sample holder was subsequently evacuated and the sample cooled before being exposed to dinitrogen gas at a series of increasing pressures (related to adsorption film thickness). After the surface was blanketed, the dinitrogen was released from the surface of the particles by systematic reduction of the pressure in the sample holder. The desorbed gas was measured and translated to a total surface area measurement.

Particle Size Analysis (“PSA”): Particle size analysis and distribution were measured using static light scattering. Dry particles were suspended in isopropyl alcohol and analyzed using a Horiba Particle Size Distribution Analyzer (Model LA-950V2) in dual wavelength/laser configuration. Mie scattering theory was used to calculate the population of particles as a function of size fraction, from 0.1 mm to 1000 mm.

Powder X-ray Diffraction (“XRD”): Powder X-ray diffraction was undertaken with a Rigaku Miniflex™ (Rigaku) to identify crystalline phases and estimate mass fraction of different identifiable sample phases. Dry, solid samples were hand-ground to a fine powder and loaded on sample holders. The X-ray source was a copper anode (Cu kα), powered at 30 kV and 15 mA. The X-ray scan was run over 5-90 °2θ, at a scan rate of 2 °2θ per min, and a step size of 0.01 °2θ per step. The X-ray diffraction profile was analyzed by Rietveld refinement using the X-ray diffraction pattern analysis software Jade™ (version 9, Materials Data Inc. (MDI)).

Fourier Transform Infrared (“FT-IR”) Spectroscopy: FT-IR analyses were performed on a Nicolet 380 equipped with the Smart Diffuse Reflectance module. All samples were weighed to 3.5±0.5 mg and hand ground with 0.5 g KBr and subsequently pressed and leveled before being inserted into the FT-IR for a 5-minute nitrogen purge. Spectra were recorded in the range 400-4000 cm⁻¹.

Scanning Electron Microscopy (“SEM”): SEM was performed using a Hitachi TM-1000 tungsten filament tabletop microscope using a fixed acceleration voltage of 15 kV at a working pressure of 30-65 Pa, and a single BSE semiconductor detector. Solid samples were fixed to the stage using a carbon-based adhesive; wet samples were vacuum dried to a graphite stage prior to analysis.

Chloride Concentration: Chloride concentrations were determined with Chloride QuanTab® Test Strips (Product No. 2751340), having a testing range between 300-6000 mg chloride per liter solution measured in 100-200 ppm increments.

### Example 1

### Purification of Carbide Lime, Formation and Transformation of the Precipitation Material

1.88 kg of NH₄Cl was dissolved into 20.0 L of tap water. 1.18 kg of carbide lime (˜85% Ca(OH)₂) was added to the solution, and mixed for 2 hours. The resultant mixture was vacuum filtered to remove the insoluble impurities. The clear filtrate was transferred to an airtight, collapsible bag. The bag was submersed in a water bath, which preheated the solution to 35° C. The carbonation reactor was an acrylic cylinder, equipped with baffles, gas diffuser, pH electrode, thermocouple, turbine impeller, and inlet and outlet ports for liquid, gases and slurry. Mass flow controllers proportioned a N₂—CO₂ inlet gas blend. During startup, 1 L of the solution in the bag was pumped into the reactor. The mixer was stirred while a CO₂ and N₂ gas blend was introduced through the gas diffuser. A computer automated control loop controlled the continuous inlet flow of fresh reactant solution maintaining the pH at 7.5. The resultant reactive vaterite slurry was continuously collected into a holding container. The slurry was vacuum filtered in batches every 20 minutes, rinsing with water per batch. The reactive vaterite filter cake was oven dried at 100° C. The cake showed 100% vaterite with a PSA Mean (STDV): 19.21 μm (7.81 μm). The clear filtrate containing regenerated NH₄Cl was recycled in subsequent experiments.

The dried reactive vaterite solid was mixed into a paste at 0.38 water to solids ratio using a solution containing 2% MgCl₂ and 2% SrCl₂ (percent by weight of Mg²⁺ and Sr²⁺). The XRD of the paste after 1 day showed 99.9% aragonite (vaterite fully converted to aragonite). The pastes were cast into 2″×2″×2″ cubes, which set and hardened in a humidity chamber set to 60° C. and 80% of relative humidity for 7 days. The cemented cubes were dried in a 100° C. oven. Destructive testing determined the compressive strength of the cubes to be 4600 psi (˜31 MPa).

### Example 2

### Purification of the Carbide Lime and Formation of the Precipitation Material

35.05 g of glycine (NH₂CH₃COOH) was dissolved into 1000 g of deionized water. 17.30 g calcium hydroxide (Ca(OH)₂) was added to the solution. The mixture was stirred for 30 minutes. The mixture was vacuum filtered through Whatman 1 filter paper. The pH of the resulting filtrate was 10.87 at a temperature of 21.5° C. The filtrate was transferred to a 1 liter (4.5″ inner diameter), baffled batch reactor vessel. The filtrate was mixed with a 1.5″ diameter rushton impleller at 2500 rpm, while a gas mixture comprised of 1 slpm carbon dioxide (CO₂) and 2 slpm nitrogent (N₂) was bubbled through the reactor. Mixing and gas bubbling was stopped when the pH reached 7.5, which occurred after 11 minutes and 25 seconds. The resulting slurry was vacuum filtered through Whatman 1 filter paper. The solid filter cake was oven dried at 100° C. overnight. 15.52 g of dried solids were recovered. The solids showed following analytical results: XRD: 97.6 wt % vaterite, 2.4% calcite.

### Example 3

### Effect of Admixtures to Make Aragonitic Precipitation Material with Low Density and High Porosity

In this experiment, admixtures were added to the precipitation material comprising reactive vaterite to form low density and high porosity aragonitic microstructure suitable for lightweight and insulation applications such as drywall and ceiling tile etc.

The calcium carbonate cement was produced by capturing CO₂ from flue gas. In the process, raw flue gas from a natural gas power plant containing CO₂ was contacted with an aqueous alkaline solution in an absorber, forming a carbonated solution. The carbonated solution was then contacted with an aqueous CaCl₂ solution with NaSO₄ added as a stabilizer, resulting in the precipitation of metastable CaCO₃ in the form of vaterite, which was subsequently dewatered and dried yielding the final carbonate precipitation material powder. The carbonate precipitation material showed 83% by weight vaterite and 17% by weight calcite. The mean particle size of the powder was 21.4 microns and standard deviation was 7.4 microns. Characterization of the powder in terms of composition is shown in Table 1 below.

TABLE 1

| | Amount in Sample |
|---|---|
| Oxide | (weight %) |
| SiO₂ | 0.2 |
| CaO | 54.5 |
| MgO | 0.4 |
| SrO | 0.1 |
| SO₃ | 0.5 |
| LOI* | 44.3 |
| Moisture | 0.9 |

*LOI is mass lost on ignition to 950° C.

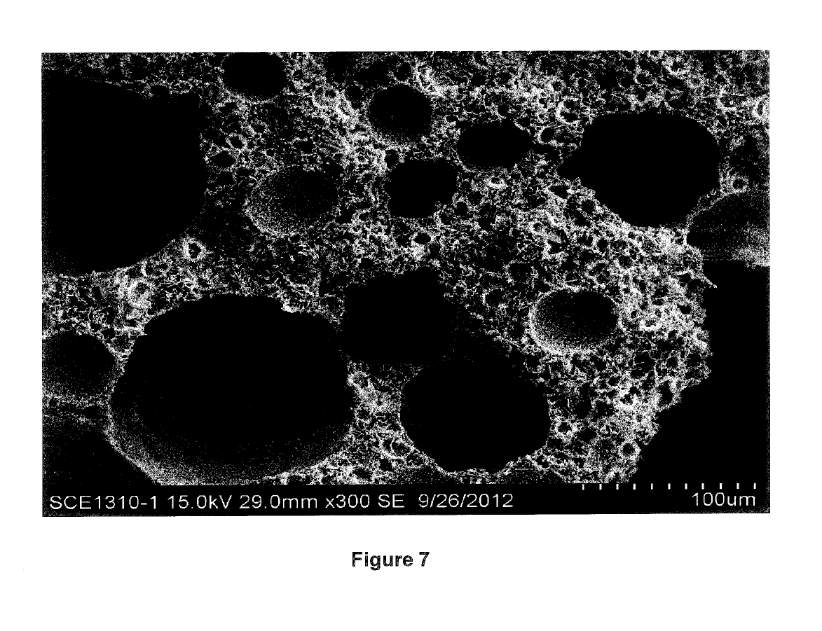

The calcium carbonate cement paste formulations were prepared as listed in Table 2. Lightweight formulations (<1 g/cm³) were achieved with the addition of (i) mineral extender (MA) (sepiolite clay) to increase the paste viscosity for allowing the use of higher water-to-cement ratios or (ii) foaming agent (FA) and starch to entrain large quantity of air in the matrix. The formulations with mineral extender were mixed with 0.5% MgCl₂ solution in a Hobart mixer for 5 mins while the formulations with foaming agent and starch were mixed with 0.5% MgCl₂ in a Hobart mixer until the required volume of entrained air was achieved. The mixed materials were then cast into 2×2×2 cubes and then cured in a 60° C., 100% RH chamber for 1 day. At 1 day of reaction, the test cubes had set with about 30% of the vaterite contained in the cement transformed to aragonite and were demolded and cured in MgCl₂ solution bath at 60° C. for 6 days. At 7 day of reaction, the majority of the vaterite contained in the cement had transformed to aragonite and the test cubes were dried in a 100° C. oven for 24 hours and stored at a 40° C. oven until testing. Results are listed in Table 2. FIG. 7 illustrates solidified calcium carbonate cement microstructure achieved by adding foaming agent (resulting density 0.4 g/cm³), which shows three ranges of porosity (86vol % porosity): macro porosity from air created by the foaming agent, micro porosity from the dissolved/transformed vaterite, and nano porosity from the voids between aragonite crystals.

The mineral extender prevented the calcium carbonate cement from segregation at high water-to-cement ratios (lower final density). The sepiolite clay significantly increased the viscosity of the mixed cement slurry at high water-to-cement ratios, thereby preventing segregation of the cement and water. The foaming agent (Cedapal 406) entrained significant amount of air in the system to lower the overall density. The porosity or density of the final product has an impact on its strength and thermal conductivity. For example, in a drywall application, a lightweight (e.g., <0.8 g/cm³) and low thermal conductivity product may be preferred which may require incorporating large vol % of porosity in the product while maintain satisfactory strength (such as >200 psi).

Table 2 illustrates density of the calcium carbonate precipitation material after cementation (i.e. after vaterite transformation to aragonite). Following is a description of how each property was measured. Density and porosity were calculated with the dried test cubes weight and dimensions. Compressive strength of the dried test cubes was measured through a compression loading device at a controlled loading rate (200-400 lbs/sec) following ASTM C 109. Thermal conductivity was measured using a range of equipments with different mechanisms including: laser flash calorimeter (L; NETZSCH LFA457), guarded heat flow meter (G; TA DTC-300; ASTM 1530), transient plane source (T; ThermTest TPS 2500S), and modified transient plane source (M; C-THERM TCI). Flammability was measured using a cone calorimeter following ASTM E 1354.

TABLE 2

| | | | | | | | Gypsum |
|---|---|---|---|---|---|---|---|
| | Baseline | | | | | | Drywall |
| | (1.25 | 1.0 | 0.75 | 0.6 | 0.6 | 0.4 | (0.6-0.8 |
| | g/cm³) | g/cm³ | g/cm³ | g/cm³ | g/cm³ | g/cm³ | g/cm³) |
| CaCO₃ | 100 | 97 | 91 | 81 | 97 | 97 | ~95 |
| cement (wt %) | | | | | | | (CaSO₄ |
| | | | | | | | 2H₂O) |
| Additive types | N/A | MA | MA | MA | FA | FA | Starch and |
| | | | | | and Starch | and Starch | Chemical |
| | | | | | | | Admixtures |
| Additives | 0 | 3 | 9 | 19 | 3 | 3 | ~5 |
| dosage (wt %) | | | | | | | |
| Water/cement | 0.4 | 0.61 | 1.0 | 1.6 | 0.55 | 0.55 | ~0.95 |
| Porosity | 57 | 65 | 73 | 78 | 78 | 86 | 65-75 |
| (vol. %) | | | | | | | |
| Thermal | 0.33 (L) | 0.35 (M) | 0.18 (L) | 0.13 (L) | 0.25 (T) | 0.14 (T) | ~0.150 |
| Conductivity | 0.57 (T) | | 0.25 (M) | | 0.17 (M) | 0.11 (M) | |
| (W/m/K) | 0.52 (M) | | | | 0.22 (G) | 0.12 (G) | |
| | 0.48 (G) | | | | | | |
| Compressive | 4600 | 2500 | 1 200 | 600 | 600 | 200 | ~400 |
| strength (psi) | | | | | | | |

### Example 4

### Formation of Artificial Reef

The calcium carbonate cement was produced by capturing CO₂ from flue gas. In the process, raw flue gas from a natural gas power plant containing CO₂ was contacted with an aqueous alkaline solution in an absorber, forming a carbonated solution. The carbonated solution was then contacted with an aqueous CaCl₂ solution with NaSO₄ added as a stabilizer, resulting in the precipitation of metastable CaCO₃ in the form of vaterite, which was subsequently dewatered and dried yielding the final cement powder. The powder showed 83% vaterite and 17% calcite in the powder. The dried powder was then mixed with 0.5 wt % MgCl₂ solution at a water-to-cement ratios of 0.4 in a Hobart mixer for 5 mins. The mixed slurry was then cast into 2×2×2 cubes and then cured in a 60° C., 100% RH chamber for 7 days. After 7 days of reaction, all the vaterite contained in the cement had transformed to aragonite and the test cubes were dried in a 100° C. oven for 24 hours then cut into 2×2×0.5 triangular plates. The triangular plates were taken to a local aquarium store for coral transplantation. After the coral became stable, the triangular plates with corals were placed in a fish tank for display. The plates have been in the aquarium for about four months and show signs of growing corals on the plates.

### Example 5

### Formation and Transformation of the Precipitation Material

The precipitation material was formed by the process described in Example 1 at 50° C. precipitation temperature. The solids showed following analytical results: XRD: 76.7 wt % vaterite, 23.3% aragonite. The dried reactive vaterite solid was mixed into a paste at 1:1 water to solids ratio using a solution containing 0.5% and 1% MgCl₂ (percent by weight of Mg²⁺). The XRD of the paste after 1 day showed 100% aragonite (vaterite fully converted to aragonite). It is contemplated that the aragonite acts as a seed for the transformation of the reactive vaterite to the aragonite.

### Example 6

### Measurement of δ¹³C Value for Precipitation Material

In this experiment, carbonate precipitation material is prepared using a mixture of bottled sulfur dioxide (SO₂) and bottled carbon dioxide (CO₂) gases and carbide lime as a waste source of metal hydroxide. The procedure is conducted in a closed container. The starting materials are a mixture of commercially available bottled SO₂ and CO₂ gas (SO₂/CO₂ gas or “simulated flue gas”), de-ionized water, and carbide lime as the waste source of metal hydroxide.

A container is filled with de-ionized water. Carbide lime is added to the de-ionized water after slaking, providing a pH (alkaline) and divalent cation concentration suitable for precipitation of carbonate-containing precipitation material containing vaterite without releasing CO₂ into the atmosphere. SO₂/CO₂ gas is sparged at a rate and time suitable to precipitate precipitation material from the alkaline solution. Sufficient time is allowed for interaction of the components of the reaction, after which the precipitation material is separated from the remaining solution (“precipitation reaction mixture”), resulting in wet precipitation material and supernatant.

δ¹³C values for the process starting materials, precipitation material, and supernatant are measured. The analytical system used is manufactured by Los Gatos Research and uses direct absorption spectroscopy to provide δ¹³C and concentration data for dry gases ranging from 2% to 20% CO₂. The instrument is calibrated using standard 5% CO₂ gases with known isotopic composition, and measurements of CO₂ evolved from samples of travertine and IAEA marble #20 digested in 2M perchloric acid yield values that are within acceptable measurement error of the values found in literature. The CO₂ source gas is sampled using a syringe. The CO₂ gas is passed through a gas dryer (Perma Pure MD Gas Dryer, Model MD-110-48F-4 made of Nafion® polymer), then into the bench-top commercially available carbon isotope analytical system. Solid samples are first digested with heated perchloric acid (2M HClO₄). CO₂ gas is evolved from the closed digestion system, and then passed into the gas dryer. From there, the gas is collected and injected into the analysis system, resulting in δ¹³C data. Similarly, the supernatant is digested to evolve CO₂ gas that is then dried and passed to the analysis instrument resulting in δ¹³C data.

The δ¹³C values for the precipitation material are found to be less than −12%. This Example illustrates that δ¹³C values can be used to confirm the primary source of carbon in a carbonate-containing precipitation material.

### Example 7

### Preparation of Aggregate from Dried Precipitation Material

The steel molds of a Wabash hydraulic press (Model No.: 75-24-2TRM; ca. 1974) are cleaned and the platens are preheated such that the platen surfaces (including mold cavity and punch) are at 90° C. for a minimum of 1 hour.

Some of the precipitation material filter cake from Example 1 is oven-dried in sheet pans at 40° C. for 48 hours and subsequently crushed and ground in a blender such that the ground material passed a No. 8 sieve. The ground material is then mixed with water resulting in a mixture that is 90-95% solids with the remainder being the added water (5-10%).

A 4″×8″ mold in the Wabash press is filled with the wet mixture of ground precipitation material and a pressure of 64 tons (4000 psi) is applied to the precipitation material for about 10 seconds. The pressure is then released and the mold is reopened. Precipitation material that stuck to the sides of the mold is scraped and moved toward the center of the mold. The mold is then closed again and a pressure of 64 tons is applied for a total of 5 minutes. The pressure is subsequently released, the mold is reopened, and the pressed precipitation material (now aggregate) is removed from the mold and cooled under ambient conditions. Optionally, the aggregate may be transferred from the mold to a drying rack in a 110° C. oven and dried for 16 hours before cooling under ambient conditions.

### Example 8

### Purification of Carbide Lime with Polyhydroxyl

To produce a purified solution of calcium ions from carbide lime, an amount of carbide lime is extracted providing 3 to 12, or 3 to 7 and or about 5 parts by weight calcium hydroxide with 100 parts by weight of the aqueous solution of the polyhydroxyl compound. Dry carbide lime from an acetylene generator may be extracted without further processing. In the case of wet carbide lime, it may be allowed to settle and subsequently dewatered prior to the extraction step. This can be done by filtration. The admixture of the carbide lime and aqueous solution of the hydroxy compound may be agitated to ensure maximum extraction of calcium ions into the aqueous liquor. Treatment times to obtain a desired degree of extraction may depend on factors such as the temperature at which the extraction is performed, degree of agitation, and concentration of the polyhydroxy compound. Subsequent to the extraction step, the calcium ion solution is separated from insoluble impurities. Separation is effected by filtration, e.g. using a microfiltration unit, but other methods may be employed. If necessary a flocculating agent may also be used. The resultant product is a purified calcium ion containing solution which may be used, for example, as a feedstock for producing industrially useful calcium containing, solid products of the invention. By bubbling carbon dioxide through the purified calcium ion containing solution, a vaterite containing materials such as a Precipitated Calcium Carbonate, may be obtained. Alternatively or additionally, the supernatant liquor remaining after the precipitation reaction may be recycled for use in extracting calcium from a fresh batch of carbide lime. If the supernatantant is to be recycled then it may be desirable to dewater the carbide lime to prevent too much water entering the recycle stream and undesirably diluting the solution of the polyhydroxyl compound. Alternatively or additionally, the supernatant may be heated to effect a degree of concentration thereof (by evaporation of water). If the supernatant is to be heated then it may be desirable that the polyhydroxy compound is a sugar alcohol as these are resistant to heating and do not “brown” at the temperature required for such concentration. This ensures that the recycled, “concentrated” solution of the polyhydric alcohol is colorless and does not cause discoloration of the precipitated calcium carbonate. This is in contrast to, say, the use of sucrose as the extractant of the calcium ions where the concentrated, recycled sucrose solution may cause discoloration of the precipitated calcium carbonate although this may be tolerated for certain applications. For the production of Precipitated Calcium Carbonate, carbon dioxide may be bubbled through the purified calcium ion solution using a conventional carbonation reactor. This reaction may be conducted at ambient temperature. Additives to coat the PCC, e.g. stearic acid derivatives, may be added at a later stage if required. The PCC may be dewatered, washed and dried using equipment well known in the art. The particle size of the PCC and the vaterite content produced may depend upon parameters such as reaction time, temperature, CO₂ concentration and agitation speed.

Although the foregoing invention has been described in some detail by way of illustration and example for purposes of clarity of understanding, it should be readily apparent to those of ordinary skill in the art in light of the teachings of this invention that certain changes and modifications may be made thereto without departing from the spirit or scope of the appended claims. Accordingly, the preceding merely illustrates the principles of the invention. It will be appreciated that those skilled in the art will be able to devise various arrangements, which, although not explicitly described or shown herein, embody the principles of the invention, and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. It is intended that the following claims define the scope of the invention and that methods and structures within the scope of these claims and their equivalents be covered thereby.

What is claimed is:

1. A method comprising:
a) contacting an aqueous solution comprising carbide lime with carbon dioxide from an industrial process; and
b) producing a precipitation material comprising reactive vaterite.

2. The method of claim 1, further comprising purifying the carbide lime by treatment with weak base before step a) to make the aqueous solution comprising carbide lime.

3. The method of claim 1, further comprising purifying the carbide lime by treatment with weak base selected from borate, N-containing salt, N-containing aliphatic compound, N-containing aromatic compound, and combinations thereof, before step a) to make an aqueous solution comprising carbide lime.

4. The method of claim 3, wherein the N-containing salt is selected from ammonium chloride, ammonium sulfate, ammonium nitrate, and combinations thereof.

5. The method of claim 2, wherein molar ratio of the weak base:carbide lime is between 2:1 to 4:1.

6. The method of claim 1, further comprising subjecting the aqueous solution at step a) to one or more precipitation conditions that favor formation of the reactive vaterite.

7. The method of claim 6, wherein the one or more precipitation conditions are selected from temperature, pH, pressure, ion ratio, precipitation rate, presence of additive, presence of ionic species, concentration of additive and ionic species, stirring, residence time, mixing rate, forms of agitation, presence of seed crystal, catalyst, membrane, or substrate, dewatering, drying, ball milling, and combinations thereof.

8. The method of claim 1, wherein the method produces the precipitation material comprising at least 50% w/w reactive vaterite.

9. The method of claim 1, wherein the method produces the precipitation material comprising reactive vaterite with an average particle size of between 1-20 microns.

10. The method of claim 1, further comprising step c) transforming the reactive vaterite to aragonite.

11. The method of claim 10, further comprising adding one or more additives to the precipitation material during or after step a), during or after step b), and/or before or during step c).

12. The method of claim 11, further comprising adding one or more additives to the precipitation material before step c).

13. The method of claim 11, wherein the one or more additives are alkaline earth metal ions selected from beryllium, magnesium, strontium, barium, and combinations thereof.

14. The method of claim 13, wherein amount of the one or more additives is between 0.5-5% by weight.

15. The method of claim 1, further comprising adding one or more of admixtures to the precipitation material.

16. The method of claim 15, wherein the one or more admixtures are selected from foaming agent, rheology modifying agent, reinforced material, and combinations thereof.

17. The method of claim 1, further comprising setting and hardening the precipitation material by transforming the reactive vaterite to aragonite and making a building material from the precipitation material.

18. The method of claim 1, further comprising setting and hardening the precipitation material by transforming the reactive vaterite to aragonite and forming a formed building material.

19. The method of claim 18, wherein the formed building material is selected from masonry unit, construction panel, conduit, basin, beam, column, slab, acoustic barrier, insulation material, and combinations thereof.

20. The method of claim 19, wherein the construction panel is selected from cement board, drywall, and combinations thereof.

21. The method of claim 20, wherein the construction panel is used for one or more applications selected from fiber-cement siding, roofing panel, soffit board, sheathing panel, cladding plank, decking panel, ceiling panel, shaft liner panel, wall board, backer board, underlayment panel, and combinations thereof.

22. The method of claim 1, further comprising setting and hardening the precipitation material by transforming the reactive vaterite to aragonite and making an artificial reef from the precipitation material.

23. The method of claim 1, further comprising setting and hardening the precipitation material by transforming the reactive vaterite to aragonite and making a non-cementitious composition selected from paper, polymer product, lubricant, adhesive, rubber product, chalk, asphalt product, paint, abrasive for paint removal, personal care product, cosmetic, cleaning product, personal hygiene product, ingestible product, agricultural product, soil amendment product, pesticide, environmental remediation product, and combinations thereof, from the precipitation material.

24. The method of claim 1, wherein the carbide lime is obtained from acetylene production process, metallurgical process, calcium cyanamide production process, landfill, or combinations thereof.

25. A product formed by the method according to claim 1.

26. A method of forming drywall, comprising:
a) contacting an aqueous solution comprising carbide lime with carbon dioxide from an industrial process;
b) producing a precipitation material comprising reactive vaterite;
c) setting and hardening the precipitation material by transforming the reactive vaterite to aragonite; and
d) forming the drywall.

27. The method of claim 26, further comprising forming the drywall using wet process, semi dry process, extrusion process, Wonderboard® process, or combinations thereof.

28. The method of claim 26, further comprising adding one or more admixtures to the precipitation material at step b) or step c) selected from foaming agent, rheology modifying agent, reinforced material, and combinations thereof.

29. The method of claim 26, comprising forming the drywall with a porosity of between 20-90 vol % or between 75-90 vol %.

30. A drywall product, comprising aragonite, wherein the aragonite has δ¹³C value between −12% to −35%, wherein the density of the drywall product is between 0.4-1.8 g/cm³, wherein the porosity of the drywall is between 50-90 vol %, and wherein the compressive strength of the drywall product is between 200-2500 psi.
